(19) United States
(12) Patent Application Publication
(10) Pub. No.: US 2026/0280893 A1
(43) Pub. Date: Sep. 17, 2026

(54) Blockchain-Enabled Digital Transaction Architecture for Incentivizing Trust in Digital Engineering

(71) Applicant: Istari Digital, Inc., Charleston, SC (US)

(72) Inventors: William Roper, JR., Charleston, SC (US); Sriram Krishnan, Cambridge, MA (US)

(21) Appl. No.: 19/680,980

(22) Filed: May 18, 2026

Related U.S. Application Data
(63) Continuation of application No. PCT/US26/18370, filed on Mar. 9, 2026.
(60) Provisional application No. 63/769,490, filed on Mar. 10, 2025.

(51) Int. Cl. H04L 9/32; G06F 11/14; H04L 9/00

(52) U.S. Cl. CPC H04L 9/3236; G06F 11/1407; H04L 9/3247; H04L 9/50; H04L 2209/56

(57) ABSTRACT

Systems and methods for incentivizing trust and collaboration in a digital model platform are provided. Broadly, an Integrated Digital Model Platform (IDMP) offers credentials for trusted sources of data, in addition to performing secure digital threads with auditability. Described are mechanisms for attributing value for trusted digital models that are tracked in a secure ledger. More specifically, the present invention relates to systems and methods for enabling trusted digital collaboration through the IDMP. The IDMP serves as a collaborative environment that provides secure access to trusted digital products, including digital models, digital artifacts, and digital threads, facilitating reliable and verifiable collaboration across digital workflows.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365 (c), and any and all parent, grandparent, great-grandparent, etc., applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
PCT application No. PCT/US26/11743 (Docket No. IST-03.012PCT), filed on Jan. 19, 2026, entitled “Versioning of Digital Artifacts for Collaborative Workflows in Digital Model Platforms,” describes a robust, unified, scalable versioning framework for model-based digital engineering.
PCT application No. PCT/US24/61606 (Docket No. IST-03.008PCT), filed on Dec. 21, 2024, entitled “Alternative Digital Tool Selection and Optimization in Digital Model Platforms,” relates to digital tool selection and usage.
PCT application No. PCT/US24/58547 (Docket No. IST-04.001PCT), filed on Dec. 4, 2024, entitled “Data Sovereignty Assurance for Artificial Intelligence (AI) Models,” relates to data sovereignty assurance during AI model training and evaluation.
PCT application No. PCT/US24/49149 (Docket No. IST-02.006PCT), filed on Sep. 28, 2024, entitled “Artificial Intelligence (AI) Assisted End-to-End Workflow Integration for Software Development in Digital Model Platforms,” describes workflow integration with AI-assistance.
PCT application No. PCT/US24/47434 (Docket No. IST-03.010PCT), filed on Sep. 19, 2024, entitled “Platform-Enabled Orchestration and Optimization of Digital Workflows,” describes digital workflow optimization.
PCT application No. PCT/US24/44938 (Docket No. IST-03.006PCT), filed on Sep. 1, 2024 entitled “Multimodal Digital Document Interfaces for Dynamic and Collaborative Reviews,” describes interface enhancement for digital software platforms.
PCT application No. PCT/US24/42768 (Docket No. IST-02.004PCT), filed on Aug. 16, 2024, entitled “Artificial Intelligence (AI) Assisted Automation of Testing in Software Environments,” describes workflow enhancement for digital software platforms.
PCT application No. PCT/US24/40624 (Docket No. IST-03.003PCT), filed on Aug. 1, 2024, entitled “Machine Learning Engine for Workflow Enhancement in Digital Workflows,” describes workflow enhancement for digital software platforms.
PCT application No. PCT/US24/40468 (Docket No. IST-03.004PCT), filed on Jul. 31, 2024, entitled “Multimodal User Interfaces for Interacting with Digital Model Files,” describes multimodal user interfaces for digital software platforms.
PCT application No. PCT/US24/38878 (Docket No. IST-03.002PCT), filed on Jul. 19, 2024, entitled “Generative Artificial Intelligence (AI) for Digital Workflows,” describes efficient AI-assisted script generation methods that preserve customer data sovereignty.
PCT application No. PCT/US24/35885 (Docket No. IST-02.002PCT), filed on Jun. 27, 2024, entitled “Artificial Intelligence (AI) Assisted Integration of New Digital Model Types and Tools into Integrated Digital Model Platform,” describes the enhancement of model splicer technology through AI-assistance.
PCT application No. PCT/US24/27912 (Docket No. IST-02.003PCT), filed on May 5, 2024, entitled “Secure and Scalable Sharing of Digital Engineering Documents,” describes secure and scalable document splicing technology.
PCT application No. PCT/US24/27898 (Docket No. IST-03.001PCT), filed on May 4, 2024, entitled “Digital Twin Enhancement using External Feedback within Integrated Digital Model Platform,” describes digital and physical twin management and the integration of external feedback within a DE platform.
PCT application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization.
U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P1), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (Docket No. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/721,250 (Docket No. IST-04.001P3), filed on Nov. 15, 2024, entitled “Data Sovereignty Assurance for Artificial Intelligence (AI) Models,” further details data sovereignty assurances during AI model training and evaluation.
U.S. provisional patent application No. 63/650,498 (Docket No. IST-05.001P), filed on May 22, 2024, entitled “Fyber: Distributed Digital Threading Platform for Trusted Data Sources.”
U.S. provisional patent application No. 63/664,676 (Docket No. IST-05.002P), filed on Jun. 26, 2024, entitled “Discontinuous Access to Interconnected Digital Model Platforms.” · U.S. Pat. No. 11,775,707 (Docket No. 54332-0057001) filed on Oct. 25, 2022, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### NOTICE OF COPYRIGHTS AND TRADEDRESS

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This invention relates to digital model platforms, and more specifically to the incentivization of trust within said digital model platforms through smart contracts, incentives management, and blockchain tokens.

### BACKGROUND OF THE INVENTION

The statements in the background of the invention are provided to assist with understanding the invention and its applications and uses, and may not constitute prior art.

Digital modeling, digital tasks, and digital workflows have become indispensable across various fields of human endeavor, revolutionizing how tasks are accomplished. From healthcare and finance to manufacturing and creative industries, automated digital operations streamline complex procedures, enhance collaboration, and boost productivity. For example, within the field of engineering, such digital approaches allow engineers to simulate, test, and optimize designs before physical prototyping, significantly reducing time and costs. Digital engineering is a comprehensive methodology that represents an integrated digital approach to systems engineering.

Furthermore, industries, research institutions, organizations and even individuals increasingly rely on digital products and services such as digital models and data artifacts for simulations, engineering validation, financial forecasting, and operational planning. However, digital collaboration is hindered by a lack of trust in digital products. Users face challenges in determining whether digital products such as digital models and data artifacts are authentic, secure, and suitable for integration into their workflows. Furthermore, exchanging value and transacting with digital artifacts in such environments involves difficult hurdles of trustworthiness of participants, cross-border payment problems, difficulty in integrating with traditional banking systems, especially for micropayments, and related difficulties.

For high-value projects, where decision-making depends on verifiable, high-integrity digital products and digital artifacts, there is a critical need for robust validation, security enforcement, and intelligent discoverability. Interoperability limitations further complicate collaboration, as many digital models remain confined to specific proprietary ecosystems, making it difficult to exchange data securely across organizations.

Despite efforts to improve digital collaboration, current solutions suffer from significant limitations:
1. Lack of digital product provenance and trust
   Users cannot easily verify the origin, modification history, or credibility of digital products, models, and artifacts.
   No standardized system exists for tracking the value and verification status of digital products across different users and organizations.
2. Interoperability challenges
   Many digital collaboration platforms operate in isolated environments, making cross-platform integration difficult.
   Digital models and data artifacts often lack standardized metadata, preventing seamless exchange and use across systems.
3. Scalability and privacy limitations
   While blockchain-based solutions have attempted to address digital trust, they face scalability constraints, as high transaction volumes may exceed blockchain infrastructure capabilities.
   Users require selective privacy control, deciding which attributes of a digital product remain private (while continuing to maintain provenance) and which are published to a public blockchain for external visibility.

Therefore, in view of the aforementioned difficulties, there is an unsolved need to provide a secure, interoperable and scalable digital collaboration system and platform that streamlines digital workflows and enables users to collaborate and exchange verifiable digital products and services.

It would be a further advancement in the state of the art to incentivize users to contribute and share their digital products, artifacts, and services, while protecting their valuable intellectual property.

It would be a further advancement in the state of the art to enable trustworthiness of digital artifacts, digital products, digital workflows, and the like to be transparently verified in a tamper-resistant manner.

It is against this background that various embodiments of the present invention were developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Broadly, an Integrated Digital Model Platform (IDMP) offers credentials for trusted sources of data, in addition to performing secure digital threads with auditability. We describe mechanisms for attributing value for trusted digital models that are tracked in a secure ledger. This value tracking can also be tokenized on an external blockchain offering a utility token such as a trust token, as discussed below.

More specifically, the present invention relates to systems and methods for enabling trusted digital collaboration through the IDMP. The IDMP serves as a collaborative environment that provides secure access to trusted digital products, including digital models, digital artifacts, and digital threads, facilitating reliable and verifiable collaboration across digital workflows. The invention contemplates both fungible and non-fungible tokens (NFTs) for various use cases over a digital model platform.

The invention is built on three core attributes:
1. A secure private database that tracks the history, usage, and value of digital products, ensuring controlled access and transactions through a marketplace for trusted digital products. This database enables provenance tracking, verification, and economic attribution of digital assets.
2. A Trust Token—a novel type of utility token introduced herein—which serves as a credential for trusted digital products, capturing their provenance and verification history. These tokens allow users to assign value to digital assets and facilitate secure transactions within IDMP's internal marketplace.
3. Integration with public distributed ledgers, such as blockchain, on a selective basis, to provide controlled transparency and auditability. Such integration allows the private database to selectively expose digital products for broader public use while maintaining scalability and privacy.

For broader accessibility, trust tokens may also be linked to public payment gateways and external digital product marketplaces, ensuring a secure and traceable exchange of digital products.

In addition to exchanging digital assets, the IDMP can also enable the sharing/selling of operational capabilities, such as compute, storage, bandwidth at the edge, etc. For example, users may share their data freely for the benefits of data sharing, without token incentives. More generally, users within the token ecosystem may be divided into three segments:
a) Government users and users of highly regulated industries such as aerospace/defense: Federal agencies may direct data to be shared among each other or with other user segments. The government may also participate in a commercial token ecosystem to reduce costs and earn revenue from digital products.
b) Commercial users: These users may have financial incentives to share data (e.g., digital products) that have individual value and collective value. Naturally, not every contributor is equal, since some contributors have highly valuable digital twins with higher creation costs, and others may contribute smaller components that may be less valuable.
c) Academic/Individual users: The data being shared here is not expected to be valuable to the individual users. However, the platform-aggregated data may become highly valuable.

Accordingly, and in a first aspect, one embodiment of the present invention, is one or more non-transitory physical storage media storing program code for enabling digital transactions over an Integrated Digital Model Platform (IDMP). The program code is executable by a hardware processor, causing the hardware processor to perform the following steps. The program code may cause the hardware processor to receive a request for a digital thread checkpoint (DTC), where the DTC describes a current state of a target digital thread, where the target digital thread is operated by a user and references at least one digital artifact, and where the target digital thread is an IDMP orchestration script operating on the at least one digital artifact and associated with a digital product. The program code may cause the hardware processor to generate the DTC associated with the target digital thread, where the DTC may include a checkpoint payload (e.g., including a thread identifier, a checkpoint identifier, a scope type, a scope reference identifier, a DTC timestamp, and an authority identifier of an authorized decision-maker, where the scope type defines a category of certification that the DTC represents). The program code may cause the hardware processor to generate a referenced checkpoint hash by hashing the checkpoint payload. Finally, the program code may cause the hardware processor to generate a non-fungible token (NFT) representing a certified state of the target digital thread at the DTC, where the NFT may include the referenced checkpoint hash. (The NFT may also include a token identifier, the scope type, the scope reference identifier, a certification status, an NFT timestamp, and an issuer identifier).

In one embodiment, the checkpoint payload may further include at least one of one or more prior checkpoint hashes, one or more artifact lineage references of the at least one digital artifact, one or more evidence snapshot identifiers, and one or more validation pipeline identifiers and result references.

In one embodiment, the NFT may further include at least one of an economic state reference, a permission state reference, a validity window, a revocation pointer, and a supersession reference.

In one embodiment, the program code may further cause the hardware processor to digitally sign, by the authorized decision-maker, the referenced checkpoint hash, to generate a digital signature, and append the digital signature to the DTC to generate a canonical DTC.

In one embodiment, the NFT may be recorded on a blockchain and assigned to one of the user and the IDMP.

In one embodiment, at least one of the referenced checkpoint hash and a token hash associated with the NFT may be recorded to a private blockchain.

In one embodiment, the program code may further cause the hardware processor to generate a public anchor associated with the DTC, where the public anchor may include a cryptographic commitment based on at least the referenced checkpoint hash and a token hash associated with the NFT, and record the public anchor to a public blockchain.

In one embodiment, the checkpoint payload may further include a checkpoint hash list including one or more previously generated checkpoint hashes, and where the cryptographic commitment is further based on a Merkle root generated from the checkpoint hash list.

In one embodiment, the request for the DTC is received in response to a user-defined invocation of a checkpoint operation.

In one embodiment, the request for the DTC may be received upon completion of a predefined validation workflow.

In one embodiment, the request for the DTC may be received upon execution of a programmable smart contract condition.

In one embodiment, the scope type may be one of requirement-level, milestone-level, artifact-level, and workflow-level.

In one embodiment, the request for the DTC may be associated with a digital product transaction of the digital product between the user and a third party.

In one embodiment, the at least one digital artifact may have been extracted from a digital model file through a model representation, where the digital model file resides within a customer environment of the user, and where the model representation includes model-type-specific locators to digital model data.

In one embodiment, the target digital thread may be written in a computer-executable scripting language, where the target digital thread may include instructions to access the at least one digital artifact through the model representation.

In one embodiment, the model representation may include a model splice connected to the digital model file, where the model splice may include one or more splice data items, one or more splice data structures, and a splice function providing access to the at least one digital artifact, and where the access to the at least one digital artifact is provided through an item selected from the group consisting of an Application Programming Interface (API) and a Software Development Kit (SDK) endpoint.

A second aspect, or another embodiment of the present invention, is a computer-implemented method for performing the steps described herein. Features described with respect to the first aspect apply equally to the second aspect.

In another aspect or embodiment of the present invention, a non-transitory, computer-readable storage medium is provided, the non-transitory, computer-readable storage medium storing executable instructions which when executed by a processor, causes the processor to perform a process including the aforementioned steps.

In yet another aspect or embodiment of the present invention, a computer program product is provided. The computer program may be used for performing the steps described herein and may include a computer-readable storage medium having program instructions, or program code, embodied therewith, the program instructions executable by a processor to cause the processor to perform the aforementioned steps.

In yet another aspect or embodiment of the present invention, a system for performing the steps described herein is provided, the system including a memory that stores computer-executable components, and a hardware processor, operably coupled to the memory, and that executes the computer-executable components stored in the memory, where the computer-executable components may include components communicatively coupled with the processor that execute the aforementioned steps.

In yet another aspect or embodiment of the present invention, a system for performing the steps described herein is provided, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In yet another aspect or embodiment of the present invention, a computerized server is provided, including at least one processor, memory, and a plurality of computer codes embodied on said memory, said plurality of computer codes which when executed causes said processor to execute a process including the steps described herein. Other aspects and embodiments of the present invention include the methods, processes, and algorithms including the steps described herein, and also include the processes and modes of operation of the systems and servers described herein.

In yet another aspect or embodiment of the present invention, an edge computerized system is provided, the edge computerized system running on a physical system or physical twin (PTw) with either access to, or dedicated, processing, memory, computer code stored on a non-transitory computer-readable storage medium of the physical system or PTw, and a plurality of sensor data being measured on said physical system or PTw, the computer code causing the processor to perform the aforementioned steps.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium may have corresponding features definable and/or combinable with respect to a digital documentation system and/or method and/or system, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

### Platform-Enabled Trusted Digital Collaboration Methods and Systems

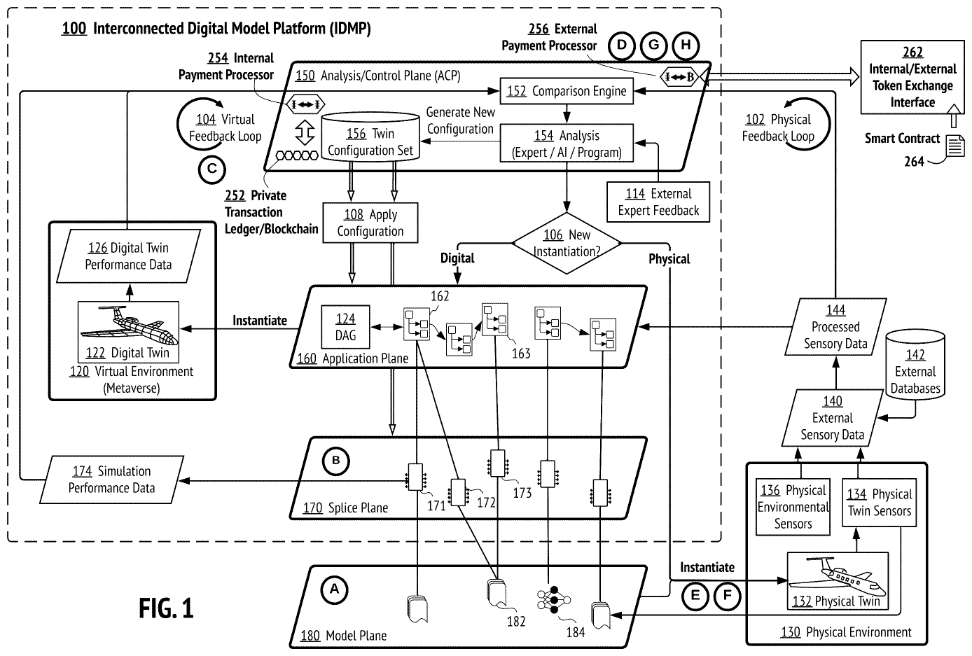

FIG. 1 shows an exemplary interconnected digital model platform (IDMP) architecture, with highlighted parts showing platform-enabled mechanisms for the exchange of digital products between IDMP users, in accordance with some embodiments of the present invention.

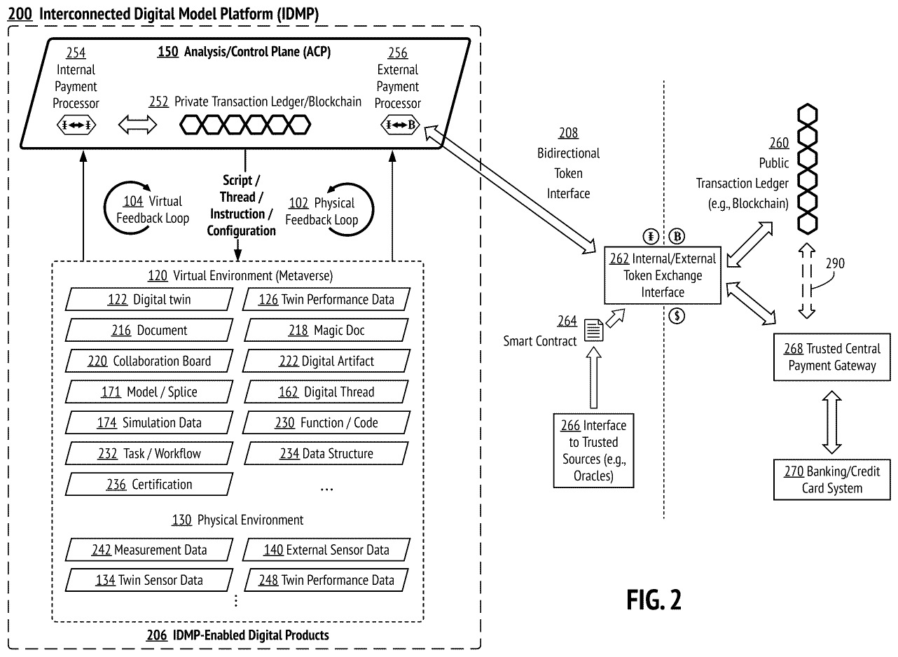

FIG. 2 illustrates the management, verification, and exchange of digital products in a secure and auditable manner, within an IDMP, in accordance with some embodiments of the present invention.

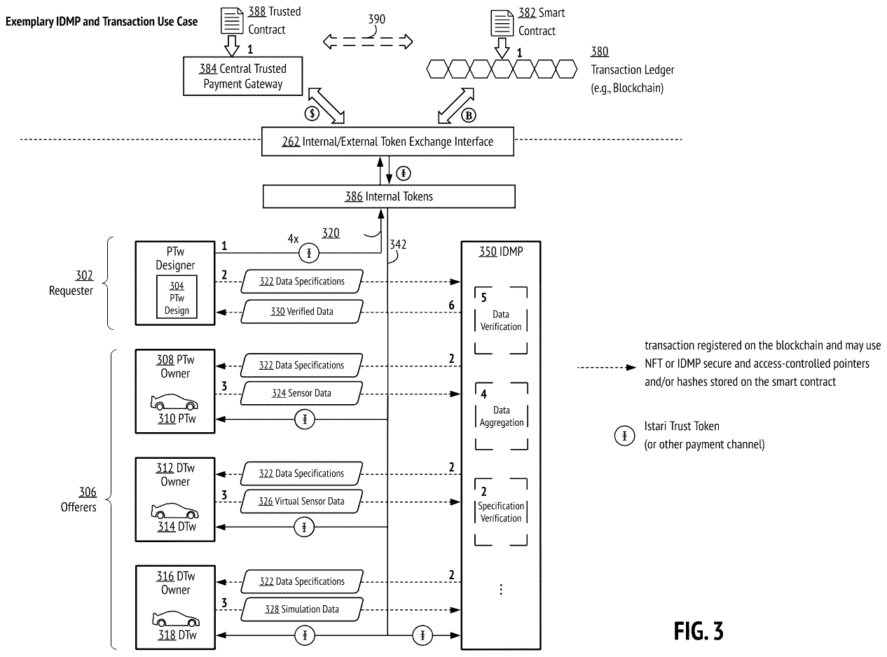

FIG. 3 illustrates an exemplary exchange involving a data request, verification, and payment process, within the IDMP, in accordance with some embodiments of the present invention.

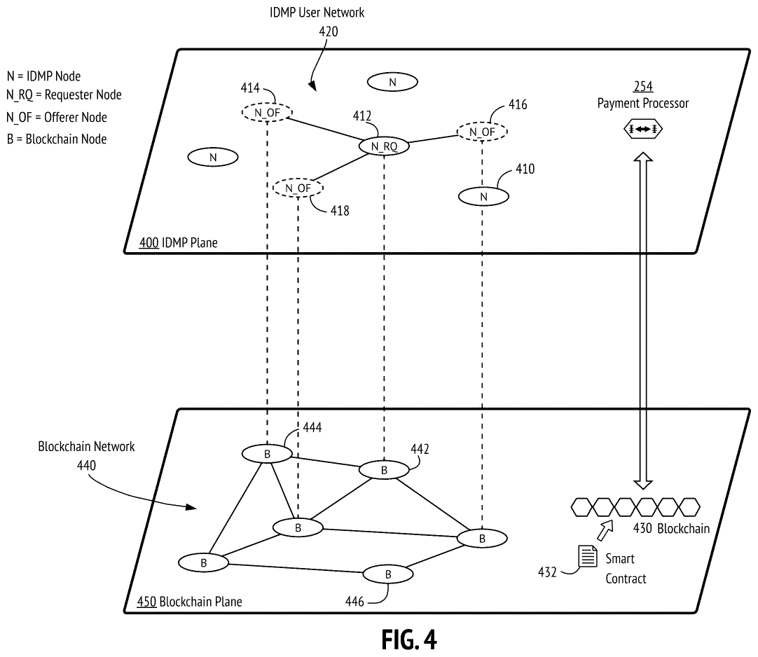

FIG. 4 shows an exemplary network configuration supporting IDMP-enabled mechanisms for the exchange of digital products between IDMP users, in accordance with some embodiments of the present invention.

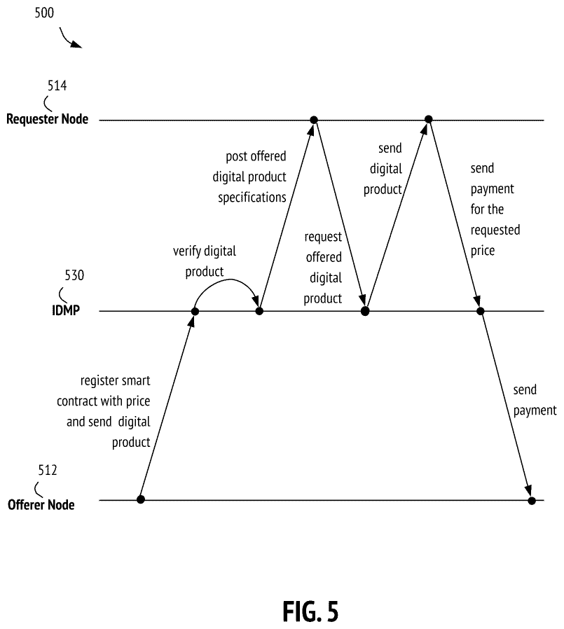

FIG. 5 shows an exemplary platform-enabled three-way exchange leading to the transfer of a digital product between IDMP users, in accordance with some embodiments of the present invention.

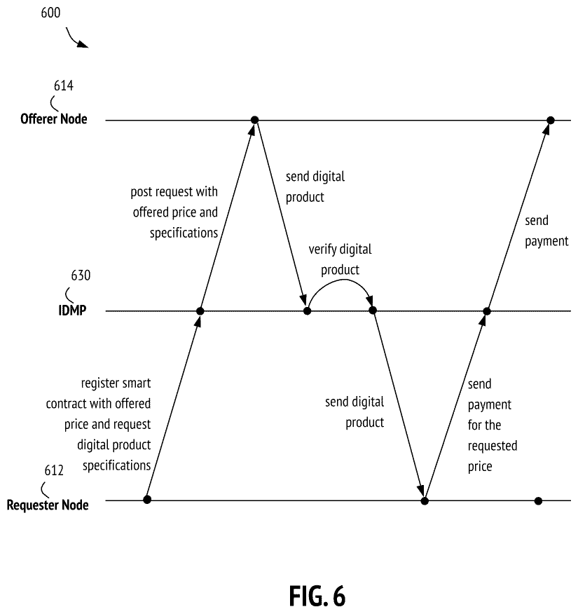

FIG. 6 shows another exemplary platform-enabled three-way exchange leading to the transfer of a digital product between IDMP users, in accordance with some embodiments of the present invention.

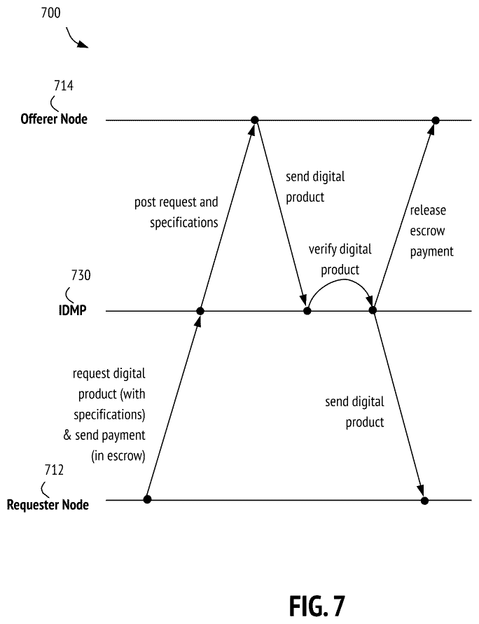

FIG. 7 shows another exemplary platform-enabled three-way exchange leading to the transfer of a digital product between IDMP users, in accordance with some embodiments of the present invention.

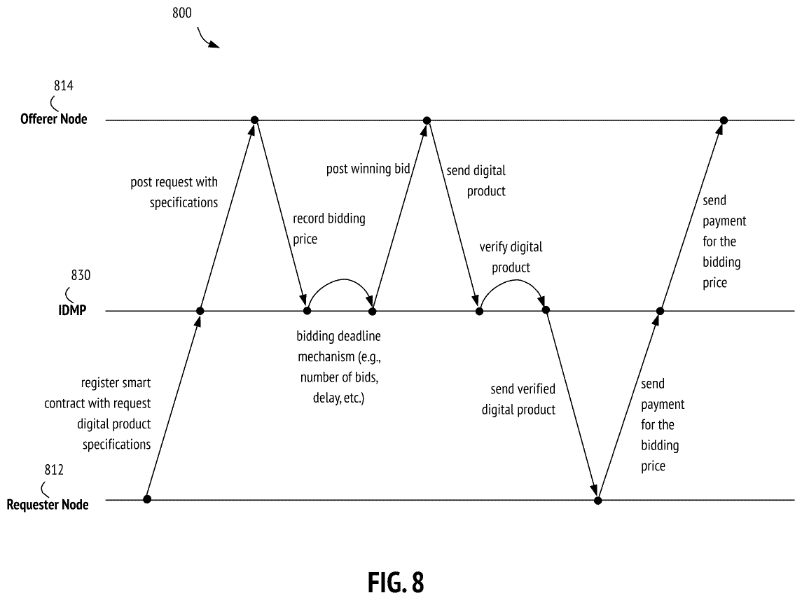

FIG. 8 shows another exemplary platform-enabled three-way exchange leading to the transfer of a digital product between IDMP users, in accordance with some embodiments of the present invention.

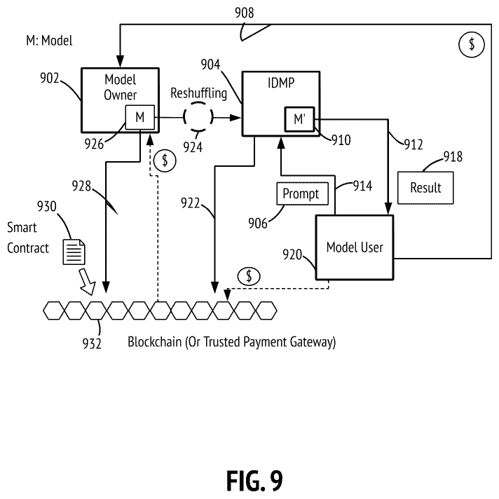

FIG. 9 shows a sample platform-enabled three-way transaction leading to a privacy-enhanced evaluation of a neural network (NN) model, in accordance with some embodiments of the present invention.

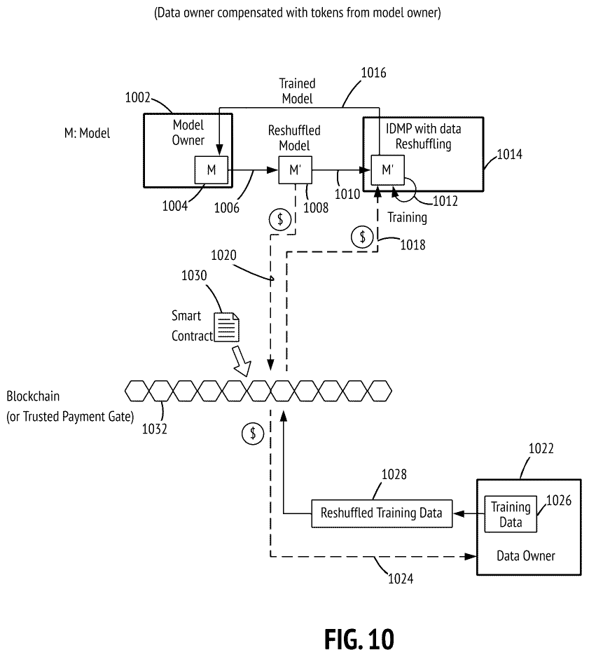

FIG. 10 shows a sample platform-enabled three-way transaction leading to a privacy-enhanced training of a neural network (NN) model, in accordance with some embodiments of the present invention.

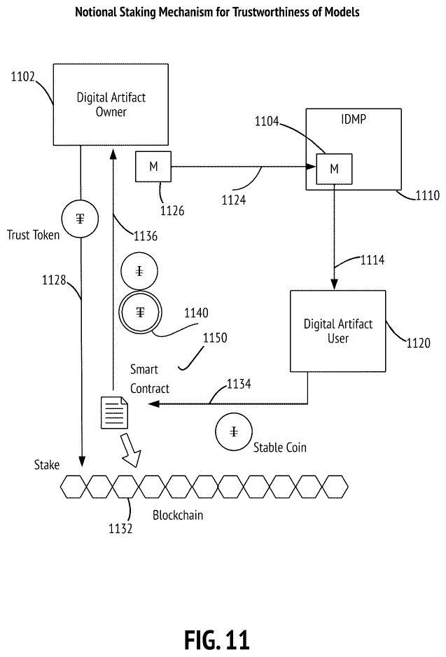

FIG. 11 shows a sample platform-enabled three-way transaction leading to the exchange of a digital artifact through a staking mechanism, in accordance with some embodiments of the present invention.

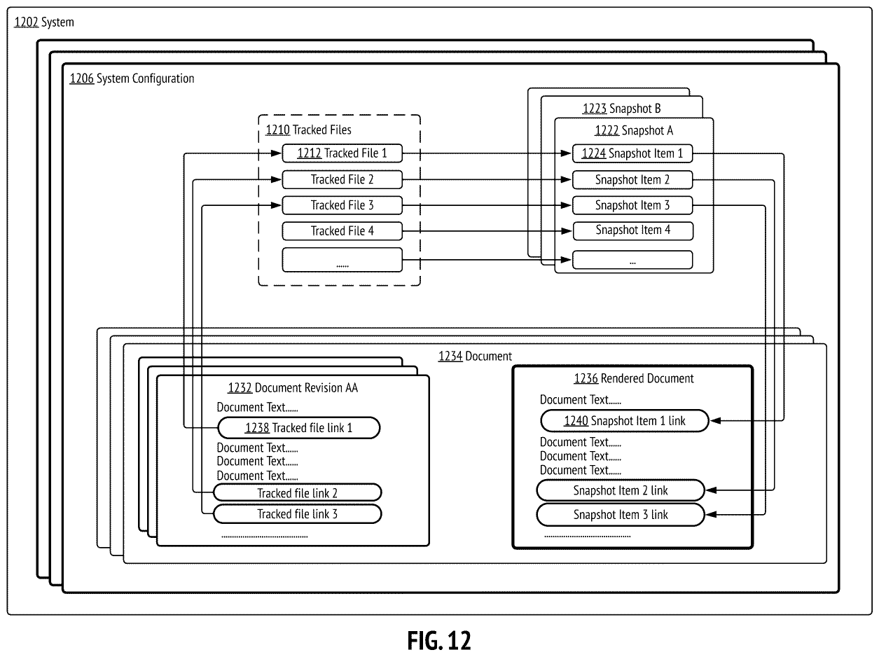

FIG. 12 shows an exemplary system snapshot and document-rendering architecture for managing versioned digital assets in a configuration-scoped manner, in accordance with some embodiments of the present invention.

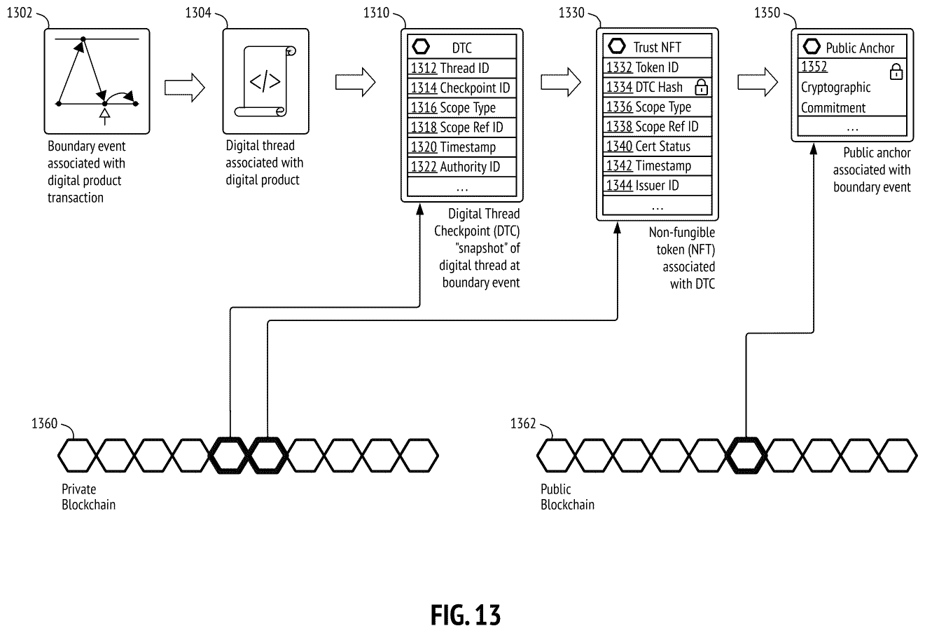

FIG. 13 shows various exemplary stages and data structures that are relevant to the disclosed digital transaction architecture, in accordance with some embodiments of the present invention.

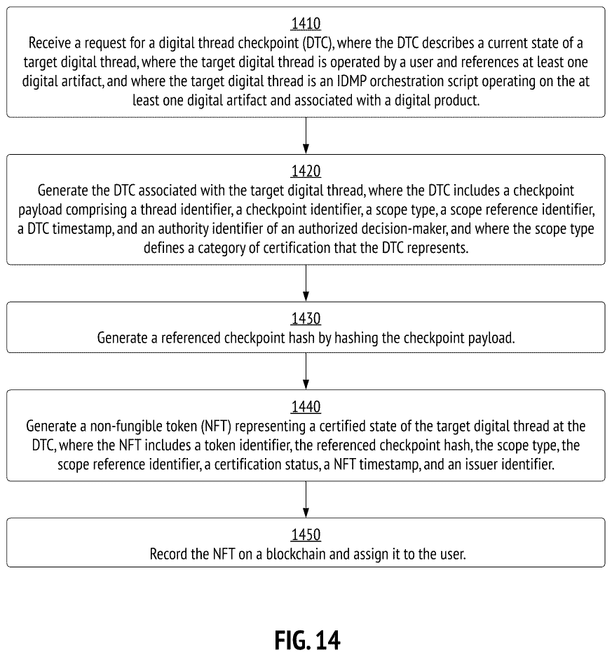

FIG. 14 shows an exemplary flow chart for enabling digital transactions over an Integrated Digital Model Platform (IDMP), in accordance with some embodiments of the present invention.

### Interconnected Digital Model Platform (IDMP)

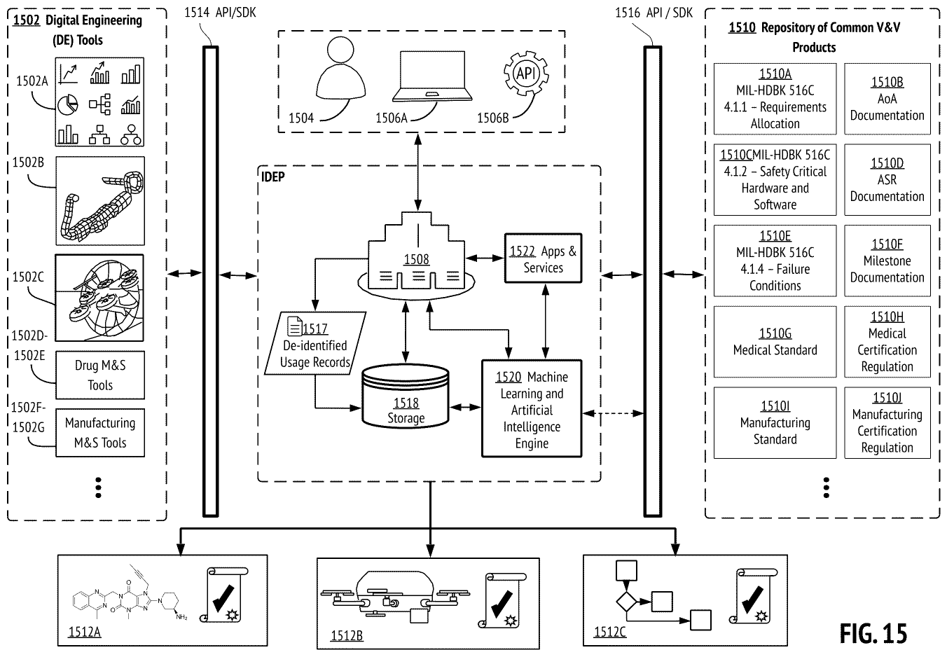

FIG. 15 shows an exemplary implementation of an IDMP as an interconnected digital engineering (DE) and certification ecosystem, and exemplary digitally certified products, in accordance with some embodiments of the present invention.

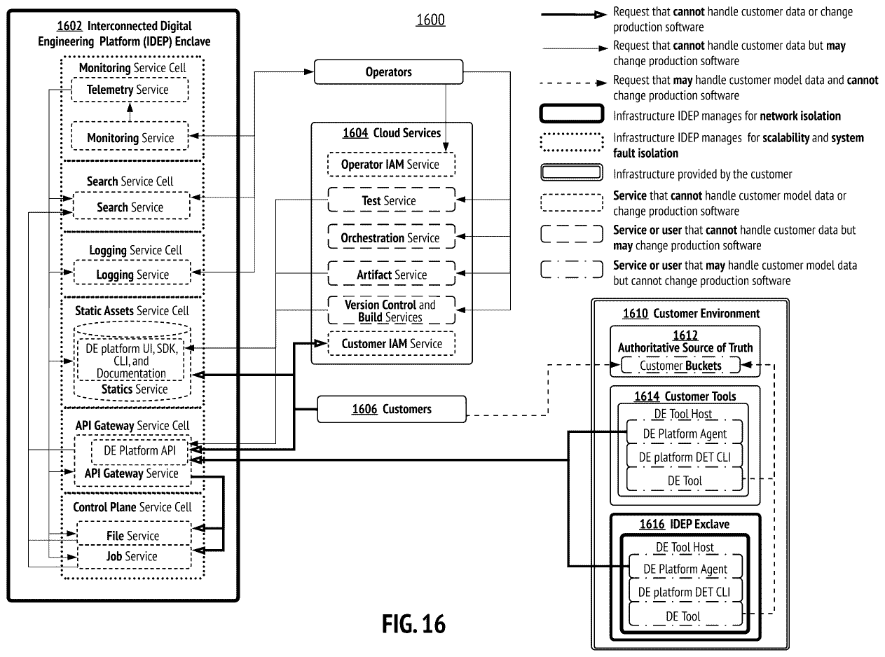

FIG. 16 shows another exemplary implementation of the IDMP illustrating its offered services and features, in accordance with some embodiments of the present invention.

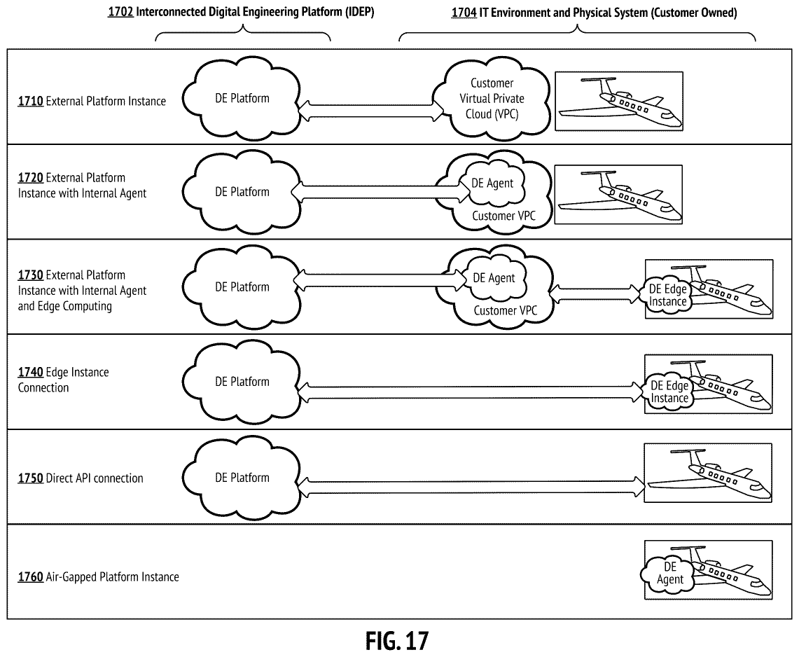

FIG. 17 shows potential scenarios for instantiating an IDMP in connection to a customer's physical system and IT environment, in accordance with some embodiments of the present invention.

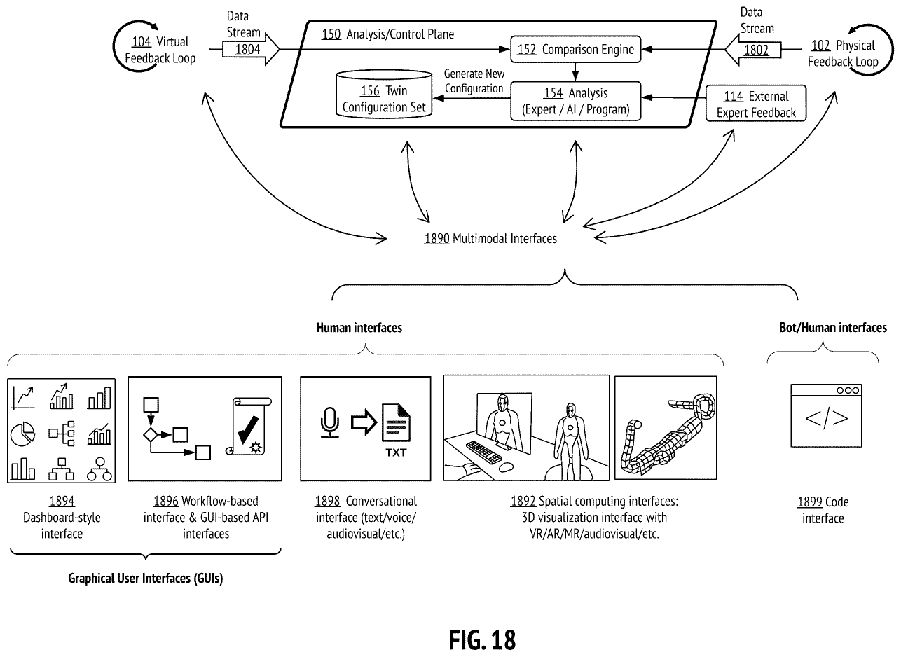

FIG. 18 shows exemplary multimodal interface designs for integration of feedback in an IDMP, in accordance with some embodiments of the present invention.

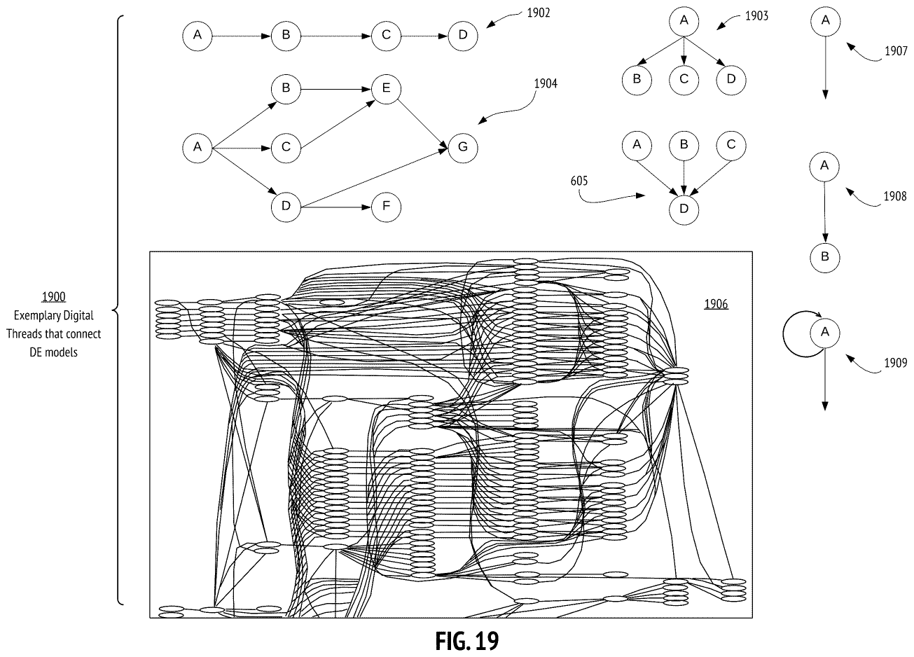

FIG. 19 is a schematic diagram comparing exemplary digital threads that connect DE models, in accordance with some embodiments of the present invention.

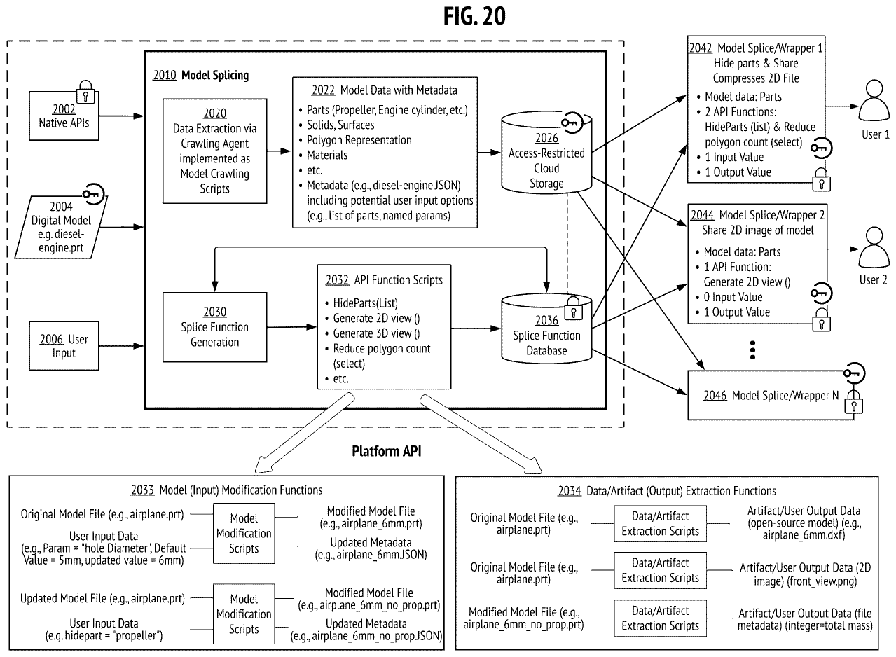

FIG. 20 is a schematic showing an exemplary DE model splicing setup, in accordance with some embodiments of the present invention.

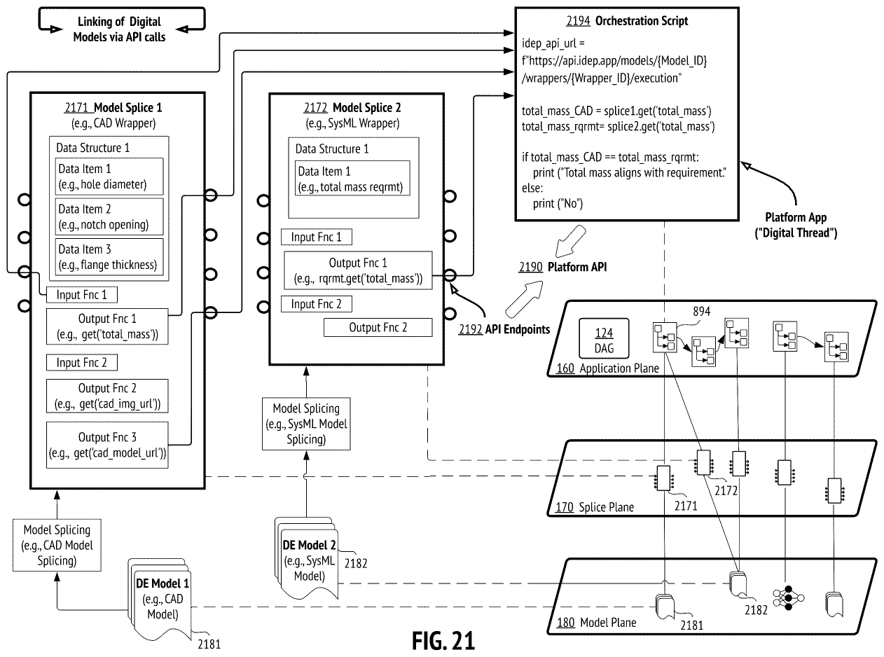

FIG. 21 is a schematic showing digital threading of DE models via model splicing, in accordance with some embodiments of the present invention.

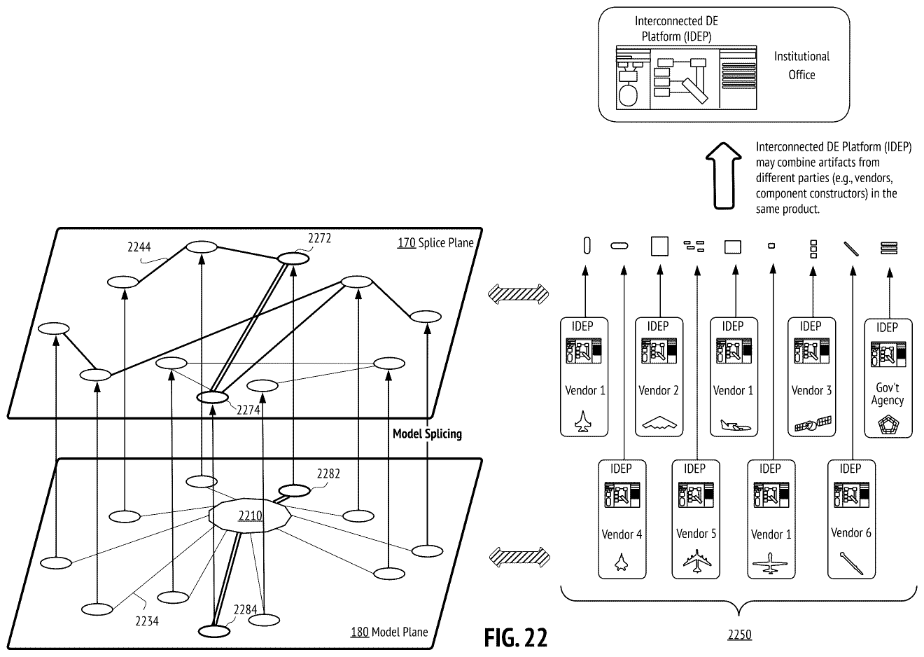

FIG. 22 is a schematic illustrating the linking of DE model splices in a splice plane and comparing digital threading with and without model splicing, in accordance with some embodiments of the present invention.

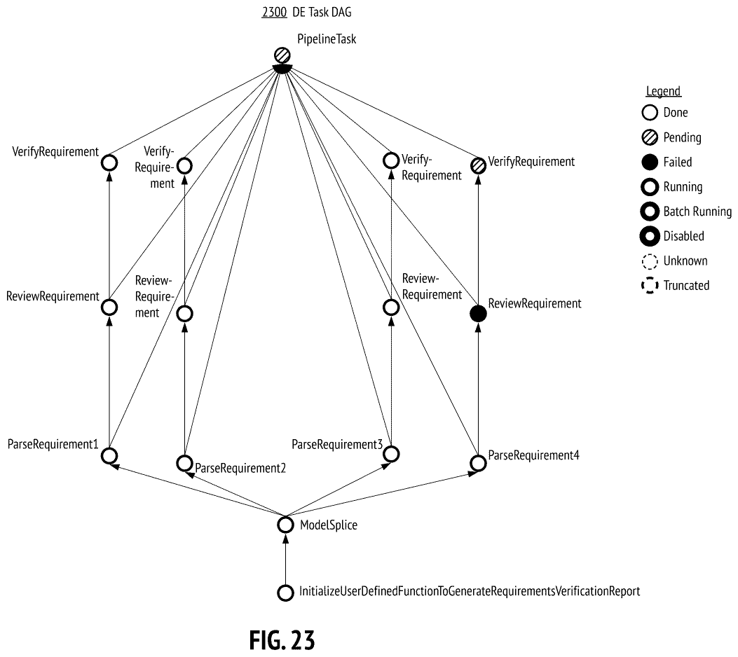

FIG. 23 shows an exemplary directed acyclic graph (DAG) representation of pipelined DE tasks related to digital threads, in accordance with some embodiments of the present invention.

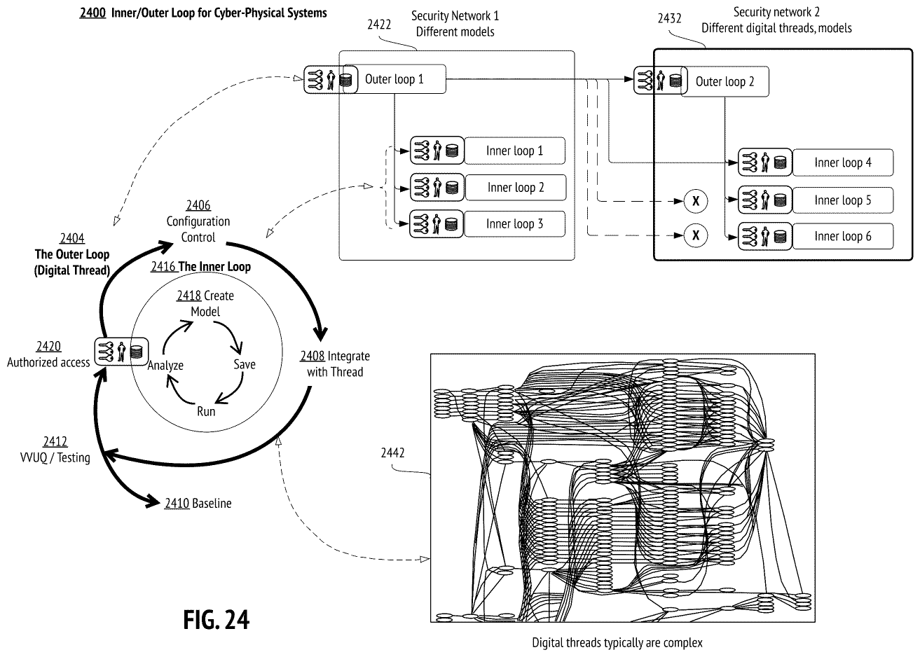

FIG. 24 is an exemplary schematic illustrating the interplay between a digital thread and the individual models or artifacts it uses, defining outer and inner loop processes, in accordance with some embodiments of the present invention.

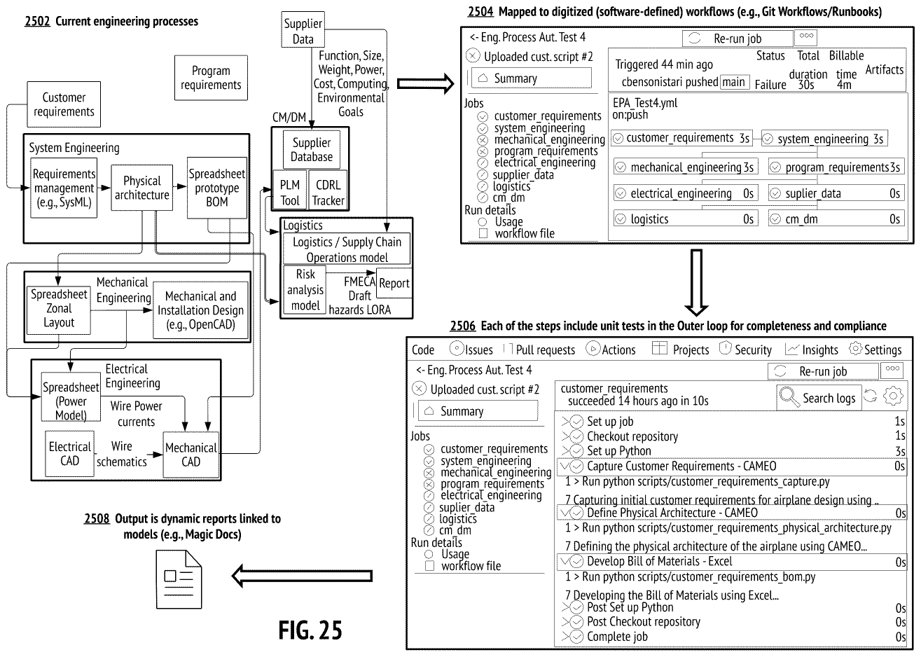

FIG. 25 illustrates an exemplary digital engineering process in the aerospace industry, showing outer loop processes, in accordance with some embodiments of the present invention.

### Machine Learning Implementation Architecture for IDMP Operations

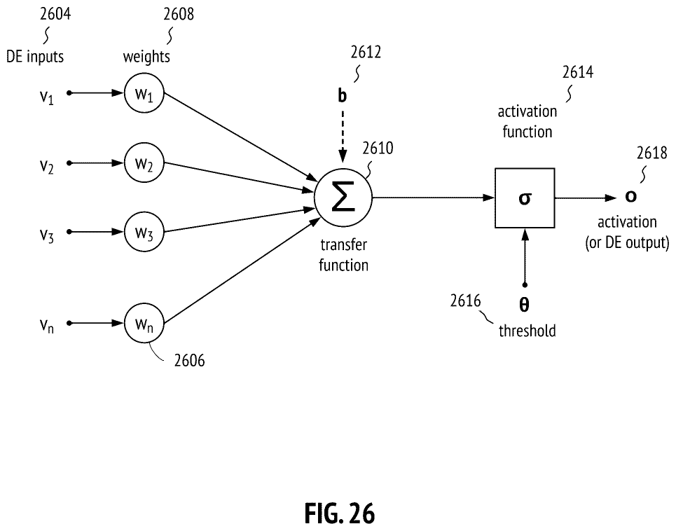

FIG. 26 describes neural network operation fundamentals, in accordance with some embodiments of the present invention.

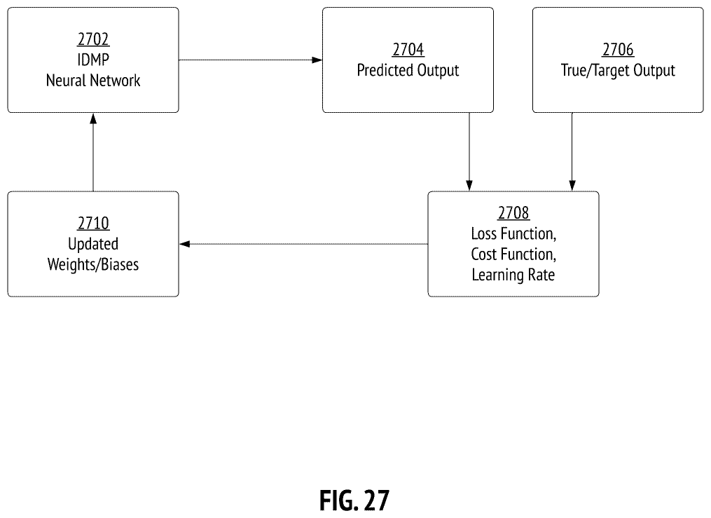

FIG. 27 shows an overview of an IDMP neural network training process, in accordance with some embodiments of the present invention.

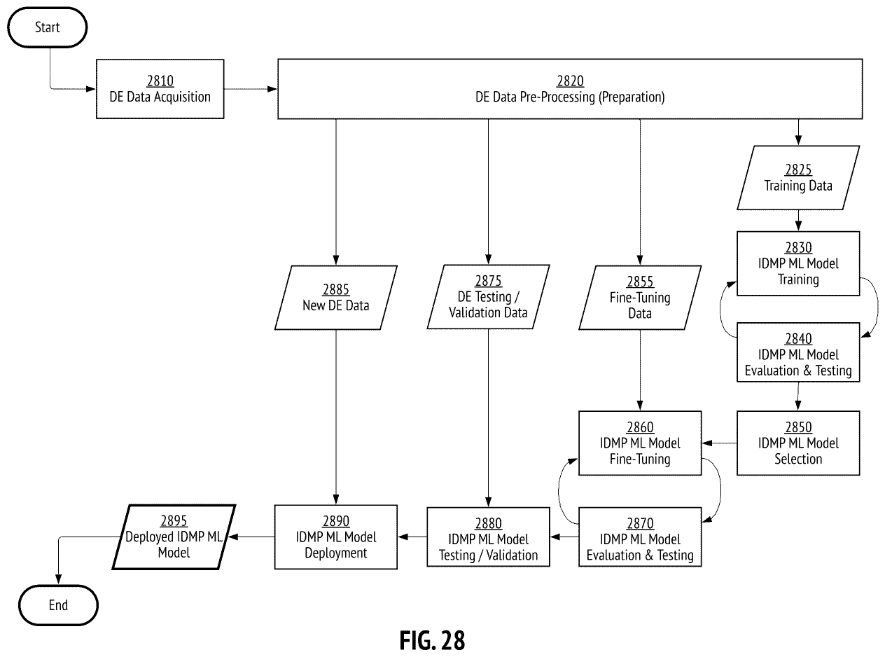

FIG. 28 is an illustrative flow diagram showing the different phases and datasets involved in training an IDMP machine learning model, in accordance with some embodiments of the present invention.

### Hardware and Software Architecture for IDMP Operations

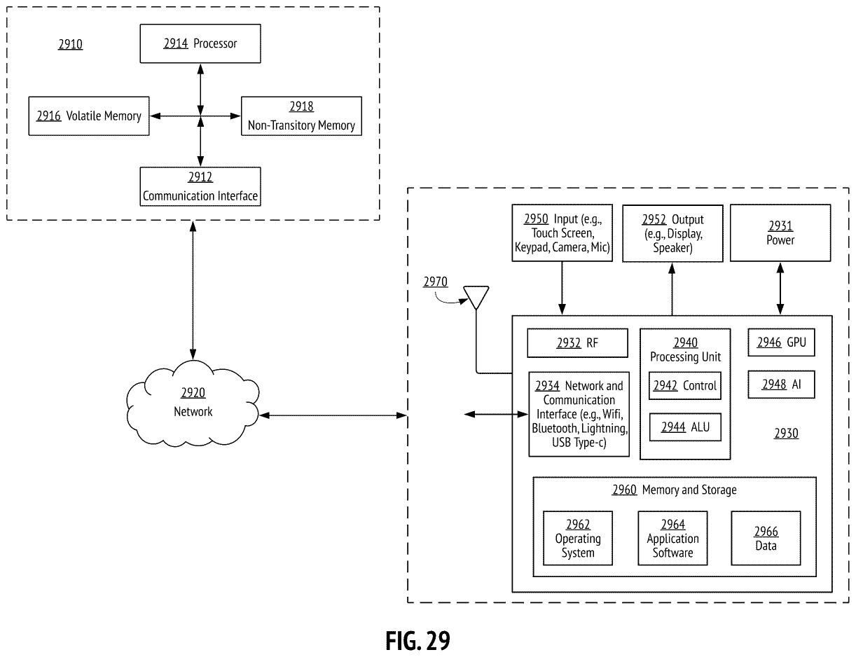

FIG. 29 provides illustrative schematics of a server (management computing entity) and a client (user computing entity) used within an IDMP, in accordance with some embodiments of the present invention.

### DETAILED DESCRIPTION OF THE INVENTION

In the following description, for purposes of explanation, numerous specific details are set forth to provide a thorough understanding of the invention. It will be apparent, however, to one skilled in the art that the invention can be practiced without these specific details. In other instances, structures, devices, activities, methods, and processes are shown using schematics, use cases, and/or diagrams to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, one embodiment of the present invention relates to methods and systems for trusted digital collaboration through the exchange of digital products and services between users.

With reference to the figures, embodiments of the present invention are now described in detail. First, an interconnected digital model platform (IDMP) and its digital engineering embodiment (IDEP) are explained in detail, including platform-enabled mechanisms for trusted digital collaboration through the exchange of digital products and services between users. Next, digital model splicing and threading operations are described in detail. Finally, relevant artificial intelligence (AI), machine learning (ML), hardware, and software concepts are discussed.

### Terminology

Some illustrative terminologies used herein are provided to assist in understanding the present invention, but these are not to be read as restricting the scope of the present invention. The terms may be used in the form of nouns, verbs, or adjectives, within the scope of the definition.
Digital Value: A digital representation of value, for example, internal or external tokens, or private database entries, representing fiat currency (e.g., USD, EUR, etc.), stablecoins (USDC, USDT, etc.), bitcoin (BTC), other public cryptocurrencies (e.g., ETH, SOL, XRP, THETA, etc.), or a native Trust Token, or monetary value equivalent that is recognized and exchangeable internally and/or externally to the IDMP.
Internal Tokens: Internal representations of digital value, for example, private database entries, tokens on a private blockchain, and the like, representing fiat currency (e.g., USD, EUR, etc.), bitcoin (BTC), other public cryptocurrencies (e.g., ETH, SOL, XRP, THETA, etc.), or a native Trust Token, or monetary value equivalent that is recognized and exchangeable internally to the IDMP. Internal exchanges can be made on the IDMP private ledger, e.g., a private database, that records internal balances of users on the IDMP platform. Internal tokens may in some embodiments be convertible 1:1 with external tokens.
External Tokens: External representations of digital value, tokens on a public blockchain, and the like, representing stablecoins (USDC, USDT, etc.), bitcoin (BTC), other public cryptocurrencies (e.g., ETH, SOL, XRP, THETA, etc.), or a native trust token, or monetary value equivalent that is recognized and exchangeable externally to the IDMP. External tokens may in some embodiments be convertible 1:1 with internal tokens.
Fiat Currency (effectively external): USD, EUR, etc. stored in bank accounts run by centralized banks or equivalent organizations, that are regulated by the government of a given state. Fiat currencies are globally recognizable, and are hence inherently external to the IDMP platform.

Additional illustrative terminologies useful to understand the IDMP are provided at the end of this document to assist in understanding the present invention, but these are not to be read as restricting the scope of the present invention. The terms may be used in the form of nouns, verbs, or adjectives, within the scope of the definition.

### Overview

Embodiments of the IDMP as disclosed herein include interconnected infrastructure, environment, and methodology used to store, access, analyze, visualize, and modify data and digital models associated with a product or system. As discussed below, an embodiment of the IDMP is a software platform that interconnects a plurality of spliced model files through one or more software-defined digital threads. In the context of trusted digital collaboration, the IDMP offers credentials for trusted data sources, in addition to performing secure digital threads with auditability. We describe mechanisms for attributing value for trusted digital models that are tracked in a secure ledger. This value tracking can also be tokenized on an external blockchain offering a “Trust Token”—a novel type of utility token introduced herein.

### Examples of Trusted Digital Collaboration in Various Applications

The present invention provides a scalable and flexible solution by leveraging IDMP's hybrid architecture, which integrates:
A secure collaboration environment where users can access, verify, and transact with trusted digital models and artifacts. Various embodiments of the IDMP further include a zero-trust security architecture, ensuring that only authorized entities can access, modify, or distribute digital products within IDMP.
A secure private database that tracks digital product history, ownership, and valuation, ensuring controlled access and marketplace transactions.
Hybrid integration with public distributed ledgers, allowing selective publication of digital products to a blockchain for broader transparency while keeping sensitive attributes private.

This hybrid approach balances scalability, privacy, and transparency, providing a more flexible, secure, and verifiable system for trusted digital collaboration. Examples of trusted digital collaboration in various applications are described below:

Finance-Algorithmic trading & Economic forecasting

Financial institutions rely on quantitative models and economic forecasts to guide investment strategies and regulatory compliance. These models require trusted digital data artifacts, such as GDP projections, central bank policy updates, and trade balance reports, sourced from reputable institutions. Without a trusted collaboration framework, analysts risk using outdated or manipulated financial data, leading to poor decisions and regulatory non-compliance. Today these artifacts are provided by centralized content management systems and increasingly the need for decentralized collaboration becomes apparent across a variety of finance applications.

The present invention, leveraging IDMP's secure collaboration environment, enables financial organizations to access, verify, and transact with validated financial models and data artifacts. The secure private database ensures provenance tracking, while selective blockchain integration allows regulatory transparency. This approach enhances data integrity, compliance with reporting requirements (e.g. Basel III, SEC), and confidence in financial decision-making.

### Supply Chain Operations-Verified Shipping & Trade Compliance

Supply chain operations depend on accurate and trusted shipping records, supplier performance data, and trade compliance documents to ensure efficient logistics and regulatory adherence. However, fragmented data sources and unverifiable information introduce inefficiencies and risks in decision-making.

The present invention, through IDMP's secure verification framework, allows supply chain managers to authenticate and securely exchange shipping records and trade data. The secure private database maintains controlled access, while blockchain integration enables selective transparency for auditability. This ensures trusted decision-making, regulatory compliance, and supply chain security.

### Healthcare-Trusted Clinical Research & Medical Publications

Clinical research and medical decision-making depend on trusted digital data artifacts, such as peer-reviewed journal publications, clinical trial datasets, and regulatory-approved drug efficacy reports. However, lack of provenance tracking and risks of misinformation create barriers to trust in medical research collaboration.

The present invention, leveraging IDMP's secure collaboration platform, enables researchers and healthcare professionals to discover, validate, and share trusted medical research artifacts. The secure private database ensures confidentiality of proprietary clinical findings, while selective blockchain integration supports public transparency of regulatory-approved medical data. This approach enhances trust in medical research, evidence-based decision-making, and regulatory compliance.

### Regulatory Applications-Digital Certification & Ownership Transfer

Regulatory compliance and certification processes often require immutable records of approvals, audits, and ownership transfers. The IDMP provides a secure framework for digital regulatory applications, ensuring traceable, verifiable, and tamper-proof compliance records.

A specific application of blockchain within IDMP involves certification smart contracts, where a certifying authority, such as a DoD or FAA node, triggers the issuance of an NFT once the certification validation is complete. This NFT-based certificate serves as an immutable, verifiable proof of compliance.

Verification applications for smart contracts can also facilitate business transactions involving milestone-based payments, such as “pay-for-success” project demonstrations or at-risk design proposals. In these cases, specific review thresholds trigger payments, allowing companies to recover costs for initial development efforts while ensuring subsequent payments are tied to successful design reviews. For example, one stage of a design review process may unlock reimbursement for development costs, while a later stage may trigger pre-payment for future production or supply contracts.

Another regulatory use case is the transfer of airworthiness certificates or aircraft ownership certificates upon title transfer. By employing IDMP's private database for controlled validation and blockchain for selective transparency, these certificates can be securely transferred while maintaining a comprehensive record of ownership history, compliance validation, and regulatory approvals. This ensures integrity in regulatory processes while reducing administrative burden and fraud risks.

### Introduction to IDMP and Trust Token

The Integrated Digital Model Platform (IDMP) provides a secure, trust-mediated digital marketplace for certified digital models, automation scripts, and validated designs, ensuring compliance, auditability, and transparent transactions. By leveraging trust tokens, smart contracts, and blockchain-based credentials, IDMP eliminates inefficiencies in digital asset validation while incentivizing collaboration and innovation.

Transactions using trust tokens on the IDMP are not limited to individual digital products such as models or artifacts but can extend to several high-value applications that tokenize digital model certification, verification scripts, and compliance-backed digital designs. These secure, verifiable, and automated transactions between providers (offerors) and users (requesters) help establish trust, compliance, and transparency across various industries, including engineering, infrastructure, healthcare, finance, and supply chain management.

Four exemplary embodiments of this transaction model are listed below and discussed in more detail next:
I. Certified digital thread package
II. Scripts-only digital thread with optional tokenized model updates
III. Tokenized certified digital design with immutable credentialing
IV Tokenized contribution-based credentialing (TCC) model

### I. Certified Digital Thread Package

In various embodiments, the IDMP validates a certified digital thread package containing pre-validated digital models, automated scripts, verification artifacts, test results, and documentation. Each component is immutably linked to trust tokens, allowing requesters to verify authenticity, provenance, and compliance upon acquisition. This enables seamless integration of certified digital artifacts into workflows, accelerating regulatory approvals and certification processes.

In traditional engineering and software development, certified components or software libraries are manually validated and exchanged, often requiring compliance audits and third-party verification. The tokenized digital model approach within IDMP eliminates inefficiencies by embedding verification and certification data directly into the asset, enabling real-time validation, automated compliance tracking, and trust-driven transactions. By ensuring verifiable provenance and incentivizing model-sharing through trust token rewards, IDMP fosters collaborative innovation while reducing barriers to adopting pre-validated digital components.

An exemplary process flow includes the following steps:
1. Marketplace listing and certification verification—A provider publishes a certified digital thread package in the IDMP marketplace, embedding verification and validation (V&V) credentials secured through tokenized trust mechanisms.
2. Escrow-backed tokenized acquisition and authentication—A requester initiates a smart contract-based escrow transaction using trust tokens to acquire the digital package. The IDMP validates the request and ensures the model's authenticity and certification status before releasing the asset.
3. Decentralized trust verification and voting—The digital thread package receives decentralized votes from prior users, reinforcing trustworthiness and establishing a reputation score for the model. Users who stake tokens to vouch for a model's reliability may earn rewards or penalties based on subsequent user satisfaction.
4. Integration and compliance acceleration—The certified digital thread integrates into the requester's workflow, facilitating rapid certification and regulatory adherence.

The above embodiment can be related to other examples shown in figures such as FIGS. 2-4, which describe digital thread management, validation, and compliance mechanisms; FIGS. 5-6, which illustrate smart contract transactions for acquiring pre-validated digital assets; and FIG. 11, which covers trust token staking and attribution for digital model certification.

II. Scripts-Only Digital Thread with Optional Tokenized Model Updates

In various embodiments, the IDMP offers pre-validated automation and verification scripts that initially exclude digital models. Requesters attempt to apply these scripts to their own digital models. If compatibility issues arise, they can request provider-verified models via trust tokens. This supports incremental digital model acquisition, reducing upfront costs while enabling dynamic updates based on integration success.

There are various examples across complex engineering, infrastructure, healthcare, finance, and supply chain industries where companies employ implementation plans and playbooks from experts to guide their organizational efforts. The use of the IDMP marketplace offering scripts-only digital threads allows these organizations to use trusted digital workflows, improving process compliance along with efficiency. By providing a modular approach to verification and automation, IDMP enables organizations to integrate verified processes without needing complete digital models upfront, reducing complexity and cost.

An exemplary process flow includes the following steps:
1. Tokenized script acquisition with adaptive pricing—A requester acquires automation/validation scripts through the IDMP marketplace using trust tokens, with pricing dynamically adjusted based on demand and historical validation success.
2. Integration attempt and verification—The requester applies the scripts to their own digital models but encounters compatibility issues.
3. Escrow-backed model request and update—The requester submits a smart contract request via IDMP, initiating a trust-token-based escrow transaction to obtain provider-verified digital models originally used for script validation. The IDMP verifies the model's accuracy before releasing it.
4. Final integration and compliance check—The updated digital models are integrated with the scripts, enabling successful compliance and verification.

The above embodiment can be related to other examples shown in figures such as FIGS. 2-4, which describe digital thread execution and modification tracking; FIGS. 7-8, which illustrate escrow-based and bidding mechanisms for acquiring updated digital assets; and FIG. 11, which covers staking mechanisms for digital asset reputation and updates.

III. Tokenized Certified Digital Design with Immutable Credentialing

In various embodiments, the IDMP validates a certified digital design package consisting of validated digital models, verification artifacts, and immutable blockchain-based credentials. Certification and validation records are tokenized and securely stored, ensuring auditability and regulatory traceability. This enables digital engineering applications to incorporate trust-verified, certification-backed digital assets without additional verification steps.

This embodiment closely resembles ISO standards for physical products, where certified products must meet rigorous quality and regulatory standards before they can be widely used in manufacturing or industrial applications. Traditionally, ISO-certified products undergo standardized testing and documentation to ensure compliance, allowing businesses to trust and integrate these components without needing to revalidate them for every use. Similarly, the IDMP's tokenized approach eliminates the need for repeated certification steps, enabling digital designs to retain immutable proof of compliance, just as ISO-certified physical components can be integrated into supply chains with confidence. By ensuring transparent, verifiable compliance records, this approach accelerates engineering validation workflows and reduces administrative overhead in regulatory processes.

An exemplary process flow includes the following steps:
1. Product listing with blockchain—verified credentials and bidding options-A provider lists a tokenized digital design with embedded immutable trust credentials stored on a blockchain. The requester may acquire the design at a fixed price or through a bidding process.
2. Trust token verification, staking, and governance voting—The requester verifies blockchain-stored credentials, with prior requesters' endorsements influencing trust scores. Users who stake tokens for valid endorsements earn rewards, while misleading endorsements result in penalties.
3. Integration and compliance assurance—The certified digital model integrates into the requester's workflow, immediately enabling trust-based engineering applications and regulatory adherence.
4. Auditability and lifecycle management—The requester utilizes embedded trust tokens to prove long-term compliance, ensuring auditability without requiring re-certification.

These embodiments expand IDMP's tokenized transaction model, ensuring trust-driven collaboration, certification automation, and regulatory compliance for digital workflows in high-value engineering, infrastructure, process engineering, healthcare, and finance industries.

### IV. Tokenized Contribution-Based Credentialing (TCC) Model

In various embodiments, the Tokenized contribution-based credentialing Model enables users to contribute digital products, such as data or models, to the IDMP without direct payments, in exchange for collective credentialed insights generated from aggregated contributions. Instead of a traditional requester-offerer transaction model, participants stake their contributions, which are validated, processed, and transformed into credentialed assessments that can be used for benchmarking, certification, or third-party applications (e.g., insurance, compliance, or risk evaluation).

This model is analogous to Waze or other drive-monitoring smartphone apps, where users contribute their personal location tracking and accelerometer data to receive personalized driving behavior insights without direct financial compensation, but where the insights help users with their drive planning or lower auto insurance premiums. Similarly, in IDMP, individual users share telemetry, sensor outputs, or predictive models and, in return, receive access to a credentialed collective analysis that compares their individual performance against aggregated trends.

The IDMP utilizes smart contract-based processing and decentralized validation mechanisms to ensure that contributed data is weighted, verified, and protected against manipulation. This enables trust-scored participation, where higher-quality contributions receive greater weight in generating collective insights. Additionally, the decentralized proof-of-use credentialing (DPUC) mechanism allows users to receive immutable blockchain-backed attestations that verify their participation and contribution. These credentials may serve as regulatory compliance records, input for AI model training, or industry-recognized benchmarks for operational efficiency.

By ensuring transparent, auditable record-keeping and enabling high-value digital transactions without direct monetary exchange, the TCC Model expands IDMP's applicability across multiple industries, including mobility, healthcare, infrastructure, supply chain, and financial risk assessment.

### Interconnected Digital Model Platform (IDMP) Architecture Enabling Trusted Digital Collaboration

FIG. 1 shows an exemplary interconnected digital model platform (IDMP) architecture, in accordance with some embodiments of the present invention. In the context of digital engineering (DE), IDMP 100 streamlines the process of product development from conception to production, by using a virtual representation or digital twin (DTw) 122 of the product to optimize and refine features before building a physical prototype or physical twin (PTw) 132, and to iteratively update DTw 122 until DTw 122 and PTw 132 are in sync to meet the product's desired performance goals. In what follows, the terms IDMP and IDEP are used interchangeably, as an interconnected digital engineering platform (IDEP) is a representative type of IDMPs.

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDMP platform 100 to develop a new product. The engineering team from the manufacturer may create or instantiate digital twin (DTw) 122 of the product in a virtual environment 120, encompassing detailed computer-aided design (CAD) models and finite element analysis (FEA) or computational fluid dynamics (CFD) simulations of component systems such as fuselage, wings, engines, propellers, tail assembly, and aerodynamics. DTw 122 represents the product's design and performance characteristics virtually, allowing the team to optimize and refine features before building a physical prototype 132 in a physical environment 130. In some embodiments, PTw 132 may be an existing entity, while DTw 122 is a digital instance that replicates individual configurations of PTw 132, as-built or as-maintained. In the present disclosure, for illustrative purposes only, DTw 122 and PTw 132 are discussed in the context of building a new product, but it would be understood by persons of ordinary skill in the art that the instantiation of DTw 122 and PTw 132 may take place in any order, based on the particular use case under consideration.

Digital models (e.g., CAD models, FEA models, CFD models) used for creating DTw 122 are shown within a model plane 180 in FIG. 1. Also shown in model plane 180 is a neural network (NN) model 184, which may provide machine-learning based predictive modeling and simulation for a DE process. A DE model such as 182 may be spliced into one or more model splices, such as 172 and 173 within a splice plane 170. Individual DTws such as 122 are instantiated from splice plane 170 via an application plane 160. A model splice such as 172 may be linked to another model splice such as 171 by a platform script or application 162 on application plane 160 into a digital thread. Multiple digital threads such as 162 and 163 may be further linked across different stages or phases of a product life cycle, from concept, design, testing, to production. Digital threads further enable seamless data exchange and collaboration between departments and stakeholders, ensuring optimized and validated designs.

As model splicing provides input and output splice functions that can access and modify DE model data, design updates and DE tasks associated with the digital threads may be represented by scripted, interconnected, and pipelined tasks arranged in Directed Acyclic Graphs (DAGs) such as 124. A DE task DAG example is discussed in further detail with reference to FIG. 23.

To enhance the design, external sensory data 140 may be collected, processed, and integrated into application plane 160. This process involves linking data from different sources, such as physical sensors 134 on prototype 132, physical environmental sensors 136, and other external data streams such as simulation data from model plane 180. API endpoints provide access to digital artifacts from various environments (e.g., physical twin (PTw) sensor 134 data) and integrate them into the spliced plane 170 for the DTw 122. Model splices on the splice plane 170 enable autonomous data linkages and digital thread generation, ensuring DTw 122 accurately represents the product's real-world performance and characteristics.

To validate DTw 122's accuracy, the engineering team may build or instantiate PTw 132 based on the same twin configuration (i.e., digital design). Physical prototype 132 may be equipped with numerous sensors 134, such as accelerometers and temperature sensors, to gather real-time performance data. This data may be compared with the DTw's simulations to confirm the product's performance and verify its design.

Processed sensory data 144 may be used to estimate parameters difficult to measure directly, such as aerodynamic forces or tire contact patch forces. Such processed sensory data provide additional data for DTw 122, further refining its accuracy and reliability. Processed sensory data 144 may be generated from physical environment sensors 136 with physical environment 130, and may be retrieved from other external databases 142, as discussed below.

During development, feedback from customers and market research may be collected to identify potential improvements or adjustments to the product's design. At an analysis & control plane (ACP) 150, subject matter experts (SMEs) may analyze processed sensory data 144 and external expert feedback 114, to make informed decisions on necessary design changes. Such analysis may be done by an analysis module 154, and may be enhanced or entirely enabled by algorithms (i.e., static program code) or artificial intelligence (AI) modules. Linking of digital threads such as 162, physical sensors 134 and 136, processed sensory data 144, and expert feedback data 114 occurs at ACP 150, where sensor and performance data is compared, analyzed, leading to modifications of the underlying model files through digital threads. Within the ACP 150, the analysis module 154 may carry out testing of the product. Additionally, testing of the twin configuration set 156, which includes feature testing, may occur in the connection between the analysis module 154 and the twin configuration set 156.

In particular, sensory data 144 from physical environment 130 and performance data 126 from virtual environment 120 may be fed into a comparison engine 152. Comparison engine 152 may comprise tools that enable platform users to compare various design iterations with each other and with design requirements, identify performance lapses and trends, and run verification and validation (V&V) tools.

Model splicing is discussed in further detail with reference to FIGS. 20 to 22. Model splicing enables the scripting of any DE operation involving DE model files in model plane 180, where each DE model is associated with disparate and siloed DE tools. Codification of DE models and DE operations with a unified corpus of scripts enable IDMP 100 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 182, 184) associated with a given product within the same interconnected platform or ecosystem 100. As a consequence, the generation and training of AI modules for the purpose of manipulating DE models (e.g., 182), digital threads (e.g., 162), and digital twins (e.g., 122) become possible over the programmable and unified IDMP 100.

### Virtual and Physical Feedback Loops

FIG. 1 uses letter labels “A” to “H” to denote different stages of a product's lifecycle. At each stage, IDMP 100 enables feedback loops whereby data emanating from a PTw or a DTw is analyzed at ACP 150, leading to the generation of a new twin configuration based on design modifications. The new twin configuration may be stored in a twin configuration set and applied through the application and splice planes, yielding modified model files that are registered on the digital thread.

A virtual feedback loop 104 starts with a decision 106 to instantiate new DTw 122. A DAG of hierarchical tasks 124 allows the automated instantiation of DTw 122 within virtual environment 120, based on a twin configuration applied at a process step 108 from a twin configuration set 156. DTw 122 and/or components thereof are then tested in virtual environment 120, leading to the generation of DTw performance data 126. Concurrently, DTw 122 and/or components thereof may be tested and simulated in model plane 180 using DE software tools, giving rise to test and simulation performance data 174. Performance data 126 and 174 may be combined, compared via engine 152, and analyzed at ACP 150, potentially leading to the generation and storage of a new twin configuration. The eventual decision to instantiate a DTw from the new twin configuration completes virtual feedback loop 104.

A physical feedback loop 102 starts with a decision 106 to instantiate a new PTw 132. PTw 132 may be instantiated in a physical environment 130 from the model files of model plane 180 that are associated with an applied twin configuration from the twin configuration set 156. PTw 132 and/or components thereof are then tested in physical environment 132, leading to the generation of sensory data from PTw sensors 134 and environmental sensors 136 located in physical environment 130. This sensory data may be combined with data from external databases to yield processed sensory data 144. In one exemplary embodiment, temperature readings from environmental sensors located within the physical environment are completed, adjusted (e.g., shifted), and/or calibrated using data from external temperature databases.

Data from PTw sensors 134 may be directly added to the model files in model plane 180 by the DE software tools used in the design process of PTw 132. Alternatively, PTw sensor data may be added to digital thread 162 associated with PTw 132 directly via application plane 160. In addition, processed sensory data 144 may be integrated into IDMP 100 directly via application plane 160. For example, processed sensory data 144 may be sent to ACP 150 for analysis, potentially leading to the generation and storage of a new twin configuration. The eventual decision to instantiate a PTw from the new twin configuration completes physical feedback loop 102.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). PCT application No. PCT/US24/27898 (Docket No. IST-03.001PCT) provides a more complete description of authoritative twins and their determination, and is incorporated by reference in its entirety herein.

With faster feedback loops from sensor data and expert recommendations, the system updates DTw 122 to reflect latest design changes. This update process may involve engineering teams analyzing feedback 154 and executing the changes through IDMP 100, or automated changes enabled by IDMP 100 where updates to DTw 122 are generated through programmed algorithms or AI modules. This iterative updating process continues until DTw 122 and PTw 132 are in sync and the product's performance meets desired goals. While IDMP 100 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 122 and PTw 132 have been validated and optimized, the product is ready for production. A digital thread connecting all stages of development can be queried via splice plane 170 to generate documentation as needed to meet validation and verification requirements. The use of model splicing, along with the feedback architecture shown in FIG. 1, improves the efficiency of the overall product innovation process.

### Interconnected DE Platform and Product Lifecycle

In FIG. 1, letter labels “A” to “H” indicate the following major steps of a product lifecycle, according to some embodiments of the current invention:
A. Digital models reside within customer environments: a product may be originally represented by model files that are accessible via software tools located within customer environments. Model plane 180 encompasses all model files (e.g., 182) associated with the product.
B. Preparatory steps for design in the digital realm: splice plane 170 encompasses model splices (e.g., 172) generated from DE model file through model splicing. Model splicing enables the integration and sharing of DE model files within a single platform, as described in detail with reference to FIGS. 20 to 22.
C. Link threads as needed among model splices: to implement a product, model splices are linked through scripts within application plane 160. A digital twin (DTw) 122 englobing as-designed product features may be generated from application plane 160 for running in virtual environment 120. The complete twin configuration of a generated DTw is saved in twin configuration set 156 located at the analysis & control plane (ACP) 150. Features or parts of DTw 122 may be simulated in model plane 180, with performance data 174 accessed through splice plane 170. In one embodiment, features or parts of PTw 132 or DTw 122 configuration may be simulated outside the platform, where performance data is received by the ACP 150 for processing, in a similar way as performance data 126 received from DTw 122.
D. Finalize “As-designed”: performance data 126 from DTw 122 or simulation performance data 174 attained through model plane 180 and accessed through model splicing may be collected and sent to ACP 150 for analysis. Performance data from different iterations of DTw 122 may be compared via engine 152 to design requirements. Analysis of the differences may lead to the generation of new twin configurations that are stored at twin configuration set 156. Each twin configuration in twin configuration set 156 may be applied at application plane 160 and splice plane 170 via process step 108 to instantiate a corresponding DTw. Multiple DTws may be generated and tested, consecutively or simultaneously, against the design requirements, through comparison engine 152 and analysis module 154. Verification and validation tools may be run on the various DTw iterations.
E. Finalize “As-manufactured”: once a DTw 122 satisfies the design requirements, a corresponding PTw 132 prototype may be instantiated from the spliced model files (e.g., 172). Sensor data originating from the PTw 134 or from within the physical environment 136 may be collected, combined with other external data 142 (e.g., sensor data from other physical environments). The resulting processed sensory data 144 may be sent to the analysis & control plane 150 to be compared with performance data 126 from DTws and simulations (e.g., 174), leading to further DTw 122 and PTw 132 iterations populating the twin configuration set 156. Processed sensory data 144 may also be mapped to the digital threads (e.g., 164) and model splices (e.g., 172) governing the tested PTw 132 through the application plane 160.
F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDEP 100 components described above may be used in the assembly process. In its authoritative iteration, DTw 122 ultimately captures the precise details of the physical assembly, enabling comprehensive analysis and control in subsequent stages of the process.
G. Finalize “As-operated”: to assess the performance of the physical assembly or its individual component parts, multiple digital twins 122 may be generated as needed. These digital twins are created based on specific performance metrics and serve as virtual replicas of the physical system. Digital twins 122 are continuously updated and refined in real-time using the operational data (e.g., 144) collected from monitoring the performance of the physical assembly or its components. This data may include, but are not limited to, processed sensory data, performance indicators, and other relevant information. By incorporating this real-time operational data, digital twins 122 stay synchronized with the actual system and provide an accurate representation of its operational performance. Any changes or improvements observed via sensory data 144 during the real-world operation of the assembly are reflected in DE models within the digital twins and recorded in the twin configuration set 156. This ensures that the digital twins remain up-to-date and aligned with the current state of the physical system.
H. Predictive analytics/Future performance: The design process may continue iteratively in virtual environment 120 through new DTw 122 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 182) are continuously updated and refined using the latest sensor data, control policies, and performance metrics to enhance their predictive accuracy. This iterative process ensures that the digital twins (e.g., 122, 156) provide reliable predictions of future performance and assist in making informed decisions.

The hardware components making up IDMP 100 (e.g., servers, computing devices, storage devices, network links) may be centralized or distributed among various entities, including one or more DE service providers and DE clients, as further discussed in the context of FIGS. 16 and 17. FIG. 17 shows an illustration of various potential configurations for instancing a DE platform within a customer's physical system and information technology (IT) environment, usually a virtual private cloud (VPC) protected by a firewall.

### Platform-Enabled Mechanisms for Trusted Digital Collaboration Through the Exchange of Digital Products and Digital Value

Digital products include all digitally definable digital objects (e.g., digital models, files, documents, twins, etc.), defined in more detail in the context of FIG. 2.
In some embodiments, the exchange of digital products may include the following exchange mechanisms:
   254 internal payment processor: payments related to the exchange of digital products between IDMP users may be processed internally within the platform's control plane. An internal payment processor processes such payments using an internally denominated unit of payment (e.g., an internal IDMP token or currency indicated by “I” in FIG. 1)
   252 private transaction ledger/blockchain: A ledger may be used to record exchanges of digital products between IDMP users. In one embodiment, an internal blockchain may be implemented to fulfill this function.
   256 external payment processor: internal exchanges may be supported by external payment units (e.g., currencies or tokens). E.g., user accounts may be filled using external payment units. Alternatively, each exchange of internal payment units may be mapped to an exchange of external payment units. An external payment processor may be used to process the corresponding external exchanges.
   262 internal/external token exchange interface: internal payment unit/token conversion interface to external payment systems (e.g., fiat/blockchain)
   264 smart contract: In one embodiment, a smart contract (self-executing digital agreement with predefined rules and conditions encoded on a blockchain) may be used to record the exchange between users. The smart contract may be encoded on an external blockchain or on an internal blockchain depending on various factors such as the payment unit, the digital product being exchanged, etc.

### Sharing Data and Digital Products Across the IDMP

The Integrated Digital Model Platform (IDMP) employs a multi-tiered trust architecture to facilitate secure, verifiable, and incentivized digital model transactions across different organizational and network environments. By integrating internal transactions, private blockchains, and public blockchains, IDMP enables scalable and trust-mediated digital model exchanges tailored to varying levels of security, transparency, and decentralization.

In one embodiment, the platform supports data sharing and verification across a federated environment, categorized into four levels: local sharing, where transactions occur within the same tenancy; cross-tenancy, where models are exchanged between distinct tenants under the same control plane; cross-organization (cross-org), enabling exchanges between separate entities operating within a shared infrastructure; and cross-domain, where transactions span independent security networks or trust levels, such as public internet to private corporate networks. In this embodiment, described in more detail below, each level demands a tailored trust approach, with IDMP ensuring the integrity, security, and proper attribution of digital models.

### IDMP Transaction and Trust Infrastructure

IDMP employs a tiered transaction system, using internal secure databases, private blockchains, and public blockchains to balance trust, efficiency, and decentralization. Exemplary embodiments of IDMP are presented below:

### 1. IDMP Internal Transactions and Secure Databases

IDMP maintains an internal transaction ledger to log micro-events and action records within its secure database infrastructure. These transactions are critical to all four levels of data sharing, as IDMP functions as the trusted verifier of digital models and actions. Stored in IDMP's private, secure database, these transactions include user authentication, model modifications, version control, and permission changes. Unlike blockchain-based transactions, these do not require decentralization or immutability, as they are governed directly by the IDMP's controlled infrastructure.

### 2. Private Blockchain for Cross-Tenancy, Cross-Org, and Cross-Domain Transactions

For cross-tenancy, cross-org, and cross-domain transactions, IDMP implements a private blockchain to immutably record specific inter-party transactions while maintaining controlled accessibility. A private blockchain operates in a trust-mediated environment, enabling secure verification of digital model exchanges without requiring public visibility. It is particularly useful for federated collaborations where two or more independent entities need a verifiable, shared record of transactions without external exposure.

A private blockchain is employed for transactions such as model verification across different business units (or across collaborators in different organizations that maintain some level of trust), licensing and controlled access management, and smart contract-based trust mechanisms that ensure fair attribution and compensation between participants. It allows efficient, auditable interactions between stakeholders while maintaining security through selective participation.

### 3. Public Blockchain for Cross-Org and Cross-Domain Transactions

When transactions extend to cross-org and cross-domain environments, for use in global collaboration with limited or no trusted central parties, a public blockchain becomes crucial for distributed, immutable, and trustless verification. At this level, trust mechanisms resemble a marketplace model, involving: digital model owners (who provide models), digital model users (who license models), and IDMP as the trust-verifying intermediary.

A public blockchain is essential for trust-token staking, reputation tracking, and cross-network licensing, ensuring transparent attribution and decentralized verification. Use cases include model licensing payments via smart contracts, decentralized validation of reputation metrics, and tokenized rewards for model usage. By anchoring critical trust events to a public blockchain, IDMP ensures that certain high-visibility transactions remain verifiable beyond its internal infrastructure, supporting trust-driven collaboration across independent entities. Table 1 summarizes trust-enabled transactions in IDMP.

TABLE 1
Summary table of trust-enabled transactions in IDMP

| Transaction | Storage | | Best for data |
|---|---|---|---|
| type | medium | Use case | sharing scope |
| IDMP | Secure private | Micro-events, user | All Four , |
| internal | database | authentication, | Levels (Local |
| transactions | | digital model | Cross-Tenancy, |
| | | actions | Cross-Org, |
| | | | Cross-Domain) |
| Private | Permissioned, | Trust-mediated | Cross-Tenancy, |
| blockchain | decentralized | transactions | Cross-Org, |
| | blockchain | between | Cross-Domain |
| | | multiple verified | |
| | | stakeholders | |
| Public | Distributed, | Open verification, | Cross-Org, |
| blockchain | immutable | incentives | Cross-Domain |
| | ledger | management, | |
| | | decentralized trust | |

### Alternative Embodiments

IDMP may integrate hybrid blockchain implementations, where model verification occurs on a private blockchain, but tokenized reputation scores and licensing incentives are tracked on a public blockchain. A sidechain architecture may also optimize transaction costs by offloading computations from the primary public blockchain. Staking models may vary, allowing digital model owners to stake tokens at different trust levels, granting greater artifact visibility based on market demand. Decentralized oracles may provide additional validation, integrating external reputation scoring before records are finalized on-chain.

More generally, three distinct types of transaction ledgers may be employed to cater to different levels of security, transparency, and accessibility requirements.

The first type is the IDMP internal transactions ledger, which may be maintained on a private secure database hosted by the IDMP. This ledger is designed to record micro-events and action logs that are internal to the IDMP's operations and does not necessitate the use of blockchain technology.

The second type is a ‘Private’ Blockchain, which serves as a limited-access ledger shared between two or more stakeholders without central control. This blockchain allows multiple parties to record transactions in a trust-mediated manner, ensuring transparency and immutability among the participating entities. Unlike public blockchains, this private version offers enhanced privacy and control over who can access and validate the recorded information.

The third type is a Public Blockchain, which is distributed, secure, and immutable by nature. This ledger is used for a subset of transactions that require public visibility and verification. It leverages the full potential of blockchain technology, providing a transparent and tamper-resistant record of transactions that can be accessed and validated by anyone on the network, thus ensuring the highest level of trust and accountability for publicly relevant data.

### Digital Documentation Through Live Digital Objects

The methods and systems described herein enable the updating and generation of digital documents using the full functionality of the IDMP shown in FIG. 1. In FIG. 1, the IDMP virtual feedback loop 104 allows the scripting of program code within a digital thread 162 for the generation, storing, and updating of digital twins 122 and twin configurations 156. Similarly, the IDMP virtual feedback loop 104 also allows the scripting of program code within a digital thread 162 for the generation, storing, and updating of digital documents. This enables the creation and maintenance of so-called live digital objects.

Live digital objects are more akin to a DTw than a conventional static document in that they are configured, through a digital thread, to be continuously updated to reflect the most current changes within a particular twin configuration. In particular, an authoritative/trusted live digital object is configured to reflect the latest authoritative/trusted twin configuration. Specifically, live digital objects are digital objects that (1) include a digital artifact extracted from a digital model through a model presentation (e.g., model splice), where (2) a modification of the digital artifact appears in the live digital object within a predetermined delay. In various embodiments, the updates are effectively real-time or near real-time.

Live digital objects may use a document interface, yielding live digital documents, or live documents. Live digital documents may pull data from multiple model files. Preliminary design reviews may thus take the form of a live digital document.

Live digital objects may also use a dashboard interface, yielding live digital boards, or live boards. In some embodiments, a live digital board may display one or more documents and one or more applications on a two-dimensional (2D) screen rendered on a modality of a multimodal interface such as a 2D display, a two-and-a-half-dimensional (2.5D) display, and a three-dimensional (3D) semi-immersive or fully immersive display. Live digital boards may combine multiple documents through a VR/AR and/or conversational interface, into a board/screen 2D, 2.5D format. For example, a live board may combine multiple model files from a CAD software with collaboration chat rooms over a 2D screen rendered on a 2D display (traditional display), a 2.5D display, or a 3D semi immersive or fully immersive display. In one embodiment, the live board combines multiple view screens.

Finally, a live digital object may take the form of a live digital space (or live space), a 3D virtual environment or an augmented environment. In some embodiments, a live digital space displays one or more documents and one or more other applications in a virtual space rendered through a 3D spatial display. Live digital spaces may combine multiple documents through VR/AR and/or conversational interfaces into a 3D spatial representation. For example, a live space may display multiple 3D model files from a CAD software with collaboration chat rooms over a 3D semi immersive or fully immersive display spatial display.

Live digital objects may be stored and accessed through an IDMP. Specifically, live digital objects may be used to provide the background context for a given digital thread, and may specifically be used to display and organize a digital thread's associated artifacts, as described herein.

Live digital objects may hence be known as magic objects (i.e., live documents may be denoted “magic documents”, live boards may be denoted “magic boards”, and live spaces may be denoted “magic spaces”) as changes implemented within a twin configuration (e.g., through a modification of a model file) may appear instantaneously within the relevant data fields of the live digital objects. Similarly, authoritative/trusted live digital objects may also be known as authoritative/trusted magic objects as they continuously reflect data from the authoritative twin, thus always representing the authoritative source of truth.

Given the massive quantities of data and potential modifications that are carried out during a product's lifecycle, the scripts implementing live digital objects may be configured to allow for a predefined maximum delay between the modification of a model file (e.g., the modification of a digital artifact) and the execution of the corresponding changes within a live digital object. Moreover, for similar reasons, the scripts implementing live digital objects may be restricted to operate over a specified subset of model files within a DTw or a system, thus reflecting changes only to key parameters and configurations of the DTw or the system.

The “printing” of a live digital document or board corresponds to the generation of a frozen (i.e., static) time-stamped version of a live digital document or board. Therefore, “printing”—for a live digital document or board—is equivalent to “instantiation” for a digital twin. Similarly, the “printing” of a live digital space may also be envisaged, yielding a frozen 3D representation of a given system or digital thread.

In one embodiment of the present invention, an IDMP script (e.g., an IDEP application) having access to model data via one or more model splices and digital document templates to create and/or update a live digital object may dynamically update the live digital object using software-defined digital threads over an IDMP platform. In such an embodiment, the IDMP script may receive user interactions dynamically. In response to the user updating data for a model and/or a specific parameter setting, the IDMP script may dynamically propagate the user's updates into the digital object through a corresponding digital thread.

In another embodiment of the present invention, an IDMP script may instantiate a digital object with sufficient specification to generate a physical twin (PTw). In such an embodiment, the IDMP script may receive a digital twin configuration of a physical twin, generate a live digital object associated with the digital twin configuration, receive a predetermined timestamp, and generate a printed digital object (i.e., a static, time-stamped version of the live digital object at the predetermined timestamp). Such an operation may be referred to as the “printing of a digital twin”.

In yet another embodiment of the present invention, an IDMP script may instantiate (i.e., “print”) a digital object specifying an updated digital twin upon detecting the update. In such an embodiment, the IDMP script may detect a modification of a digital model or an associated digital thread. In response to detecting the modification, the IDMP script may update relevant data fields and sections of the live digital object based on the detected modification, and generate an updated printed digital object with the updated relevant data fields and sections based on the always-updated live digital object.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, in one embodiment, a companion magic doc for a given digital thread may include key data points and key orchestration script examples illustrating a user's intent (e.g., “increase a drone's wing span by 1%”). In one embodiment, a script-generating ML model receiving as input pseudocode or detailed user instructions derived from a user's intent, is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Payment Architecture

FIG. 2 illustrates an exemplary embodiment of the management, verification, and exchange of digital products 206 in a secure and auditable manner, within an Integrated Digital Model Platform (IDMP) 200.

In some embodiments, IDMP-enabled digital products 206 may be generated within either a virtual environment 210 or a physical environment 240 and may include, but are not limited to:
Digital models, splices, and digital threads (212-248)
Digital documents and workflows
Digital twins and simulations
Simulation data, including physical twin (PTw), digital twin (DTw), simulation (sim), and sensor performance data
Any verifiable digital object

### Digital Product Processing and Transactions

As shown in FIG. 2, various IDMP-enabled digital products 206 may be accessed and modified via an analysis and control plane 150. The analysis and control plane 150 may interface with digital products 206 through the IDMP's virtual control loop 104 and physical control loop 102, where customer instructions, scripts, digital threads, and/or configurations may generate new or updated digital products 206.

In some embodiments, digital products 206 may be exchanged over one or more transaction ledgers, which may include:
1. Private Transaction Ledger 252, facilitating internal transactions within IDMP, accessible via an internal payment processor 254.
2. Public Transaction Ledger 260, which may include a public blockchain, accessible via an external payment processor 256.

The private transaction ledger 252 and the public transaction ledger 260 may enable transactions wherein digital products 206 are exchanged for local or global token rewards.

### Smart Contracts and Blockchain Integration

In some embodiments, a bidirectional interface 208 may allow the IDMP 200 to:
Trigger public smart contracts 264, enabling decentralized execution of predefined contractual agreements.
Retrieve public data, such as certifications, from trusted third-party sources.

Further, a smart contract interface 266 is intended to serve as a trusted interface that enables interaction between IDMP 200 and trusted external sources. These sources may include regulatory entities, certification authorities, or other credentialing institutions.

To facilitate transactions, internal tokens within IDMP 200 may be funded from external sources via:
A central payment gateway 268, or
The public transaction ledger 260.

In one embodiment, internal tokens may have a 1:1 correspondence to external value, for example 1:1 to USD, or 1:1 to external tokens on the public blockchain.

To fund the internal tokens, a central payment gateway or a public transaction ledger may be used. For example, an internal/external token exchange interface 262 may facilitate seamless exchange between IDMP's internal reward system and external financial systems, linking:
The external payment interface 256 of IDMP,
Fiat currency systems (e.g., banking and credit card system 270), and
The public transaction ledger 260, which may be a public blockchain maintained by distributed nodes.

Additionally, the trusted central payment gateway 268 may function as an intermediary between the public transaction ledger 260 and the traditional banking system 270, thereby enabling fiat currency-based transactions.

Note that the dashed arrow 290 shows possible conversions between fiat and external tokens, such as the conversion of an external token to the United States dollar (USD), or vice versa.

### Blockchain Use Cases

In some embodiments, transactions, computations, and verifications that require decentralized, trustless computation and external transparency may be recorded on a public blockchain via smart contracts.

Example applications may include, but are not limited to:
1. Certification Publishing via Smart Contracts
   A digital certification may be issued and recorded on a public blockchain via a smart contract.
   The certification process may occur at a trusted IDMP node, such as a Department of Defense (DoD) node or a Federal Aviation Administration (FAA) node.
   Upon successful certification, a certification certificate may be issued and stored on the blockchain.
   In some embodiments, certification records may be issued as non-fungible tokens (NFTs), ensuring authenticity and immutability.
   A smart contract may be triggered by a certifying entity upon meeting predefined conditions.
2. Title and Ownership transfers
   In some embodiments, airworthiness certificates or ownership certificates for aircraft may be managed via smart contracts.
   Upon transfer of ownership, a blockchain-based transaction may update title records via the public transaction ledger 260, ensuring tamper-proof and verifiable documentation.
   The system may integrate with regulatory authorities to validate and enforce ownership transfers in compliance with applicable laws.

While the above examples pertain to financial transactions, certifications, and asset ownership, additional embodiments may leverage smart contracts and public blockchain infrastructure for secure, auditable, and decentralized validation of any digital product within the IDMP 200 ecosystem.

### Digital Product Transactions

A digital product transaction may be defined as an exchange of a digital product between IDMP users, where the IDMP acts as a trusted intermediary facilitating smart contract execution, product verification, and optionally payment processing.

In various embodiments, a “digital product transaction” is a platform-enabled exchange of a digital product between IDMP users, where the process involves three primary entities—the requester node, the IDMP, and the offerer node. As discussed in the context of FIG. 2, digital products may include all digitally definable digital objects (e.g., digital models, files, documents, twins, etc.)

The methods and systems described herein include transactions between at least one offerer and one requester over the IDMP, characterized by requester-platform-offerer exchanges with platform verification, as discussed below in the context of FIGS. 5-8.

### Exemplary Use Case

FIG. 3 illustrates an exemplary exchange involving a data request, verification, and payment process, within the IDMP, in accordance with some embodiments of the present invention. Specifically, FIG. 3 illustrates an exemplary embodiment of a data request and verification process within the Integrated Digital Model Platform (IDMP) 350, where a user requests IDMP-verified data for a digital asset—such as a car design 304—through a smart contract 382 recorded on a transaction ledger 380 (e.g., a blockchain), or through a trusted contract 388 recorded through a Central Trusted Payment Gateway 384.

As an example, a user may intend to build a physical car instrumented with sensors. In this case, they may first confirm the design of the physical car and then request a corresponding physical twin or digital twin model for comparative analysis.

In this embodiment, multiple IDMP users (Offerers 306) respond to the data request by submitting verified digital product data from various sources. Upon verification by the IDMP, payments are released automatically through the smart contract 382.

### Exemplary Process Flow

1. Smart Contract Registration & Escrow Deposit
   At Step 1, the smart contract 382 is registered on the transaction ledger 380.
   The requester 302 places an escrow deposit 320 in local tokens to secure the transaction.
2. Data Specification Broadcast
   At Step 2, the data specifications 322—detailing the required parameters for the requested data—are broadcast to potential offerers 306 via the IDMP 350.
   In some embodiments, the IDMP 350 may verify the data specifications before broadcasting them.
3. Data Submission by Offerers
   At Step 3, offerers 306 submit digital product data relevant to the request. Data submissions may include:
      Sensor data 324 (collected from physical devices)
      Virtual sensor data 326 (modeled or synthetic sensor outputs)
      Simulation data 328 (generated through computational models)
   Offerers 306 may include physical twin owners 308 and/or digital twin owners (312, 316).
4. Data Aggregation
   At Step 4, the IDMP 350 aggregates the received data submissions from offerers 306.
5. Data Verification
   At Step 5, the IDMP 350 performs verification of the aggregated data before further processing.
6. Delivery of Verified Data
   At Step 6, the verified data 30 is transmitted to the requester 302 for use.
7. Payment Release
   At Step 7, payment 342 is automatically released from the smart contract 382 to the relevant offerers 306 upon successful data verification.
      Tokenization and Payment conversion
A Token Conversion Layer 386 interfaces with the transaction ledger 380 through the Internal/External Token Exchange Interface 262 to facilitate the conversion of:
   Local tokens (or internal payment units) within IDMP
   Public blockchain tokens (e.g., cryptocurrencies used in the external transaction ledger)
A Central Trusted Payment Gateway 268 may provide an interface to convert local tokens into fiat currency for seamless external transactions.
Internal Tokens may be utilized within the IDMP ecosystem to:
   Track value within the IDMP (e.g., via a private blockchain or transaction ledger).
   Enable internal transactions without the need for external blockchain interaction.
Externally, IDMP tokens may be:
   Interfaced with a public blockchain for exchanging value with external users.
   Converted into fiat currency via the central payment gateway 384 (e.g., for integration with digital banking).

Note that the dashed arrow 390 shows possible conversions between fiat and external tokens, such as the conversion of an external token to the United States dollar (USD), or vice versa.

### Variations and Alternative Implementations

1. Decentralized Verification by Offerers
   Each offerer 306 may independently verify their data before submitting it to the IDMP 350, ensuring quality control before integration into the smart contract.
2. Third-Party or Independent Verification
   A designated user of the IDMP (e.g., a fourth offerer running a verification thread) may conduct verification.
   Alternatively, an external or independent certification agency connected to the IDMP may perform verification.
3. Issuance of an IDMP-Verified Certificate
   Upon successful verification, the IDMP may issue a certificate (or NFT) that serves as proof of validation for the requested data.
   The smart contract 382 may be configured to require this IDMP-issued certificate before releasing payment.

### Network Configuration

FIG. 4 shows an exemplary network configuration supporting IDMP-enabled mechanisms for the exchange of digital products between IDMP users, in accordance with some embodiments of the present invention.

In FIG. 4, IDMP Nodes (N) (e.g., 410) located within an IDMP plane 400 may be interconnected through an IDMP user network (420). The IDMP user network may be implemented through an IDMP marketplace, where user devices may discover each other and connect through the IDMP. In other embodiments, the IDMP user network may be a P2P network, where user devices connect directly.

A blockchain (430) is run independently over a set of blockchain nodes (B) (e.g., 442, 444, 446) within a blockchain plane 450 that is logically distinct from the IDMP plane 400. The blockchain nodes form a blockchain network (440). Each IDMP node (e.g., 414) may connect to one or more one blockchain node (e.g., 444) in order to access the blockchain (430).

In some embodiments, a blockchain node may be implemented within IDMP nodes and/or by an IDMP user.

A requester IDMP node (N_RQ, 412) is an IDMP node that posts a smart contract (432) on the blockchain (430).

In one embodiment, the smart contract includes a request (e.g., one or more digital tasks) associated with a reward.

One or more offerer IDMP nodes (N_OF, highlighted; 414, 416, 418) may respond by executing the request (e.g., the digital tasks) associated with the smart contract.

Digital tasks may encompass any verifiable work that is achievable via the IDMP, including the generation, modification, testing, and/or licensing of any digital product. Digital products include models, threads, documents, digital twins, etc. In one embodiment, a request is fulfilled by a digital product with predetermined specifications.

In another embodiment, the smart contract includes one or more digital products, each offered to the IDMP user network for licensing, and each associated with a licensing cost.

In this embodiment, the one or more offerer IDMP nodes (N_OF, highlighted; 414, 416, 418) may respond by requesting the digital products associated with the smart contract. In both embodiments, the smart contract enables payment procedures.

Various functions such as digital product generation/modification/verification, or the matching of offered digital products and requested digital tasks, may be carried out via the IDMP.

Through their connection to the IDMP, IDMP Nodes (N) (e.g., 410) may have access to an IDMP payment processor (254) (e.g., an internal payment processor as described in FIG. 2). The payment processor enables IDMP nodes to make payments through the blockchain (430). In some embodiments, the blockchain (430) is an internal blockchain (see FIG. 2).

In one embodiment, the blockchain (430) may be a distributed public blockchain that may provide an IDMP-issued certificate identifying a given node (e.g., 412-416) as an IDMP node for the purposes of the transaction above, hence enabling fully distributed operation.

More specifically, FIG. 4 illustrates an exemplary embodiment of how a network of IDMP users may collaborate through smart contracts registered via an underlying blockchain network. The integrated digital model platform (IDMP) network 420 facilitates secure digital task execution, verification, and exchange of digital products, using smart contracts 432 deployed on a blockchain-based transaction ledger 430. This architecture enables verifiable, auditable, and automated transactions while ensuring trust, security, and compliance through decentralized validation mechanisms.

### IDMP User Network Architecture and Node Connectivity

The IDMP user network 420 comprises multiple IDMP nodes (N, 410), which may be configured as a peer-to-peer (P2P) network or a virtualized digital infrastructure that enables dynamic user discovery and connectivity. The IDMP user network interfaces with an underlying blockchain network 440, which operates across a distributed set of blockchain nodes (B, 442, 444, 446), forming a blockchain ledger 430. Each IDMP node (N, 410) is configured to establish a connection with at least one blockchain node 432, enabling secure distributed ledger transactions, data verification, and contract execution.

In other embodiments, each IDMP node (N, 410) may establish connections with multiple blockchain nodes as applicable for secure distributed ledger transactions, data verification and contract execution.

### Smart Contract Deployment and Execution

A requester IDMP node (N_RQ, 412) initiates collaboration by registering a smart contract 432 on the blockchain ledger 430. The smart contract 432 defines one or more digital tasks, each incorporating:
predefined execution requirements that specify conditions for task completion,
a structured reward system linked to escrowed digital tokens, and
automated verification mechanisms ensuring compliance with execution conditions before releasing rewards.

### Execution of Digital Tasks and Licensing of Digital Products

In one embodiment, offerer IDMP nodes (N_OF, 414, 416, 418) respond to the smart contract 432 by executing digital tasks specified in the contract. Digital tasks may include generation, modification, validation, testing, and licensing of digital products, as well as verification of simulation models, sensor data, and digital threads. Digital products exchanged within the IDMP user network 420 may include models, data artifacts, digital twins, engineering documents, simulation data, and other verified digital assets.

In another embodiment, the smart contract 432 facilitates licensing-based transactions, where offerer IDMP nodes submit digital products to the IDMP user network 420 for licensing. A licensing cost is assigned to each digital product, and the smart contract 432 governs automated verification and payment release upon fulfillment of licensing conditions.

### Smart Contract Enforcement and Payment Transactions

The smart contract 432 ensures automated payment execution upon successful task completion or licensing compliance. Payments may be processed using escrowed digital tokens allocated within the smart contract, secure distributed ledger transactions ensuring transparency and auditability, and a token conversion mechanism enabling interoperability between IDMP's internal token system and external financial networks.

### Automated Digital Product Verification and Matching

Various IDMP functions such as digital product generation, modification, and verification, as well as the automated matching of digital products with smart contract requests, may be executed within the IDMP platform or via decentralized IDMP-enabled nodes. Verification methodologies may include automated compliance validation based on predefined verification logic, third-party verification by trusted regulatory authorities, or on-chain notarization using blockchain-based audit trails.

### Alternative Embodiments and Variations

In an alternative embodiment, each offerer node (N_OF, 414, 416, 418) may independently perform self-verification before sharing digital assets with the IDMP user network to ensure data integrity prior to smart contract execution. In another embodiment, a designated IDMP verification node may perform independent validation of digital tasks or products before contract fulfillment. Additionally, a regulatory authority or external certification entity may interface with the IDMP user network to provide official compliance validations.

Upon successful verification, the IDMP system may generate certification artifacts. In one embodiment, the certification may be recorded as a digital certificate within the IDMP ledger, or an IDMP-issued digital certificate. In another embodiment, the certification may be issued as a blockchain-based non-fungible token (NFT) serving as immutable proof of authenticity and compliance. The smart contract 432 may enforce certificate verification before processing payment or granting licensing rights.

### Exemplary Digital Product Exchange Processes

### I. Store Model

FIG. 5 shows an exemplary platform-enabled three-way exchange leading to the transfer of a digital product between IDMP users, in accordance with some embodiments of the present invention. More specifically, FIG. 5 illustrates an exemplary space-time diagram of a digital product transaction within an integrated digital model platform (IDMP) ecosystem, employing a store model with verification upfront. In this model, a digital product is pre-verified before being made available for exchange, ensuring compliance, security, and integrity of the asset before a transaction occurs.

The process involves three primary entities—the requester node (514), the IDMP (530), and the offerer node (512)—with the IDMP serving as the trusted intermediary platform that facilitates smart contract execution, product verification, and payment processing. An exemplary process flow is outlined below in the following steps:

### Step 1: Smart Contract Registration and Product Submission

In some embodiments, the offerer node (512) registers a smart contract with the IDMP (530), specifying the pricing model, licensing conditions, and verification requirements for the digital product. Along with the contract registration, the offerer node submits the digital product to the IDMP for verification.

### Step 2: Digital Product Verification

The IDMP performs an automated or semi-automated verification process to ensure that the digital product meets predefined quality, security, and compliance standards. This verification may involve automated compliance checks, cryptographic integrity validation, and third-party certification where required. In some embodiments, a private blockchain ledger may maintain an immutable verification record before the product is made available for exchange.

### Step 3: Digital Product Listing and Availability

Following successful verification, the IDMP posts the offered digital product specifications to the requester node (514). These specifications may include metadata, data provenance credentials, compliance certificates, and validation details, allowing requesters to assess the digital product before initiating a transaction.

### Step 4: Digital Product Request Initiation

The requester node (514) submits a formal request for the digital product through the IDMP, triggering a smart contract execution process that records the request on the transaction ledger.

### Step 5: Verified Digital Product Delivery

Upon receiving the request, the IDMP releases the verified digital product to the requester node, ensuring that only the pre-verified version of the digital asset is transmitted. The IDMP may include additional verification logs or smart contract-referenced conditions to guarantee authenticity.

### Step 6: Payment Initiation

Once the digital product is successfully received, the requester node transmits payment to the IDMP, following the terms specified in the smart contract. The payment transaction is registered on the transaction ledger, ensuring traceability and compliance with escrow conditions.

### Step 7: Payment Settlement and Completion

Upon verifying that the transaction terms have been met, the IDMP executes an automated settlement process, releasing payment to the offerer node (512). The smart contract may enforce time-based escrow conditions, staged payments, or additional compliance-based release triggers before finalizing the payment.

### Blockchain Interactions and Smart Contract Automation

In various implementations, the IDMP may utilize a private secure ledger or a private blockchain (not explicitly shown in the figure but similar to 252 in FIG. 2) to maintain transparency and immutability of key verification and transaction processes. A blockchain-based timeline may be integrated to track the following automated smart contract interactions:
Smart contract registration and associated digital product metadata.
Logging of verification status and compliance certification.
Recording the digital product request and fulfillment process.
Automated execution of payment transactions and escrow management.

The smart contract may further be designed to adapt escrow conditions dynamically, allowing automated dispute resolution mechanisms or staged payment processing based on contractual milestones.

### Alternative Embodiments and Variations

In some embodiments, the IDMP may support multiple verification mechanisms, including self-verification by the offerer node, independent verification by the IDMP, or third-party certification from an external entity. This enables flexibility in compliance enforcement, depending on the regulatory and operational requirements of a given transaction.

In an alternative approach, the IDMP may allow hybrid verification models, where a combination of automated and human-in-the-loop verification techniques ensures product authenticity. The smart contract logic may further extend to licensing models, including time-limited access, subscription-based payments, or usage-based licensing.

Upon successful verification, certifications may be issued as digital artifacts. In some embodiments, the IDMP may generate an NFT (non-fungible token) or verifiable credential, recorded on the blockchain as proof of authenticity. The smart contract may require verification certificates before transaction completion, further reinforcing trust and security in the exchange process.

FIG. 5 illustrates a structured transactional workflow where the IDMP ensures digital product integrity before making it available for exchange, manages automated smart contract-based transactions, and facilitates secure payments. The store model with verification upfront establishes a trusted and scalable framework for secure digital asset transactions by integrating blockchain-based verification, escrow mechanisms, and licensing conditions.

II. Request with Fixed Price

FIG. 6 shows another exemplary platform-enabled three-way exchange leading to the transfer of a digital product between IDMP users, in accordance with some embodiments of the present invention.

More specifically, FIG. 6 illustrates a request-based model for digital product exchange and verification within the Integrated Digital Model Platform (IDMP). In this model, a requester node initiates a request for a digital product, and the IDMP acts as an intermediary, ensuring the requested product is verified before transaction completion. The IDMP manages digital product verification, smart contract execution, and payment processing, enabling immutable, secure, automated transactions.

This model differs from the store-based model (FIG. 5), where products are pre-verified before being listed for purchase. Instead, the request-based model follows an on-demand verification process, ensuring that only requested products are validated and exchanged.

The diagram consists of three primary swimlanes, representing:
Requester node (612), which registers a smart contract and requests a digital product.
IDMP (630), which manages verification, transaction execution, and payment facilitation.
Offerer node (614), which submits a digital product in response to a request.

These swimlanes correspond to the swimlanes Requester node (514), IDMP (530) and Offerer node (512) in FIG. 5. An exemplary process flow is outlined below in the following steps:

### Step 1: Smart Contract Registration and Request Submission

The requester node (612) registers a smart contract with the IDMP (630), specifying the offered price and digital product requirements. The smart contract serves as a binding agreement, defining conditions under which payment is released upon successful product verification.

### Step 2: IDMP Posts the Request

Upon receiving the request, the IDMP (630) broadcasts the smart contract terms to eligible offerer nodes (614), ensuring only those capable of fulfilling the request are notified.

### Step 3: Offerer Node Submits the Digital Product

An offerer node (614) that meets the request criteria transmits the digital product to the IDMP.

### Step 4: IDMP Verifies the Digital Product

The IDMP (630) performs verification to ensure that the submitted digital product conforms to the requester's specifications and meets compliance standards. Verification may involve automated compliance checks, cryptographic proof-of-origin validation, or third-party certification as needed. In some embodiments, a private blockchain (not explicitly shown in the figure but similar to 252 in FIG. 2) records verification data to create an immutable compliance history, ensuring long-term product traceability.

### Step 5: Verified Digital Product Delivery

Following successful verification, the IDMP transmits the verified digital product to the requester node (612).

### Step 6: Requester Node Submits Payment

The requester node transmits payment for the agreed-upon price to the IDMP, which ensures compliance with smart contract conditions before releasing funds.

### Step 7: Offerer Node Receives Payment

Upon successful transaction validation, the IDMP executes automated escrow settlement, releasing payment to the offerer node (614). The smart contract may enforce staged payments, escrow conditions, or refund provisions in case of disputes.

### Blockchain Interactions and Smart Contract Automation

In some embodiments, the IDMP may utilize a private blockchain to ensure transaction integrity, auditability, and compliance enforcement. The blockchain ledger may track smart contract execution, including registering the request, logging verification results, recording product handoffs, and managing escrow-based payments. Smart contracts may dynamically adjust escrow conditions, enforce compliance rules, and automate refunds in cases of non-conformance. Thus the request based approach ensures transparency, mitigates disputes, and enhances trust among participants.

### Alternative Embodiments and Variations

The IDMP may support multiple verification mechanisms, such as pre-verified submissions by offerer nodes, third-party certification before product delivery, or multi-offerer competitive selection, where multiple offerers submit products, and the IDMP selects the best match based on predefined ranking criteria. In some embodiments, the IDMP may issue digital certificates (e.g., NFTs or verifiable credentials) for successfully verified digital products, allowing requesters to rely on previous validations rather than requiring redundant verification. These alternative implementations enhance flexibility, security, and efficiency in digital product exchanges.

In an alternative embodiment, the IDMP may implement an offerer/product pipelining system that enables multi-part product creation through contributions from multiple offerers. This system may be particularly useful when a requester seeks a complex digital product that can be divided into subtasks or components.

For example, a requester may submit a request for a comprehensive aircraft design digital product that includes aerodynamics modeling, structural analysis, and propulsion system design. The IDMP, utilizing an AI-powered recommender trained on past user actions and outcomes, may analyze the request and recommend a combination of offerers to provide the various components of the requested digital product.

In this scenario, the IDMP may break down the aircraft design request into a pipeline or a tree of tasks, where the output of upstream tasks impacts downstream results. The AI recommender may suggest different offerers for each task based on their expertise, historical performance, and the specific requirements of the project, taking into account an overall cost or objective function for the digital product design process.

For the aerodynamics modeling task, the IDMP may recommend an offerer known for high-precision computational fluid dynamics (CFD) simulations, as this upstream task significantly impacts the overall design accuracy. For the structural analysis, the system may suggest an offerer capable of parallel processing to speed up computations while maintaining acceptable accuracy. Finally, for the propulsion system design, the IDMP may recommend an offerer with a balance of speed and accuracy, as this downstream task may have more flexibility in its execution.

The AI-powered recommender may optimize the selection or combination of offerers based on various constraints:
1. Precision/accuracy constraints: Higher accuracy may be prioritized for critical upstream tasks like aerodynamics modeling, while allowing for slightly lower precision in downstream tasks where the impact on final results is less significant.
2. Speed constraints: The recommender may identify tasks that can be completed in parallel, such as certain aspects of structural analysis, to reduce overall completion time. Parallelism may be implemented using multiple offerers, or certain offerers may comprise parallel processing capabilities.
3. Total cost constraints: The AI may balance the use of high-precision, potentially more expensive offerers for critical tasks with more cost-effective options for less sensitive components of the project.
4. Time-delay constraints: The system may consider the interdependencies between tasks and recommend offerers who can deliver results within the required timeframes to maintain the project schedule.
5. Pricing constraints: The AI may optimize the selection of offerers to meet the requester's budget while ensuring the quality of the final digital product.
6. Offerer characteristics: The recommender may consider factors such as an offerer's reputation, specialization, and past performance in similar projects.

By leveraging this AI-powered recommendation system, the IDMP can efficiently match complex, multi-part requests with the most suitable combination of offerers. This approach may lead to improved overall quality of the final digital product, reduced costs, and faster completion times.

The IDMP may also implement a commission or reward system for successful recommendations, incentivizing the platform to continually improve its AI-powered matching capabilities. This commission may be based on factors such as the accuracy of the recommendation, the satisfaction of both the requester and offerers, and the overall efficiency gains achieved through the optimized task distribution.

In some embodiments, the IDMP may implement the commission or reward system for successful recommendations using a smart contract on a blockchain. This approach ensures transparency, immutability, and automated execution of the reward distribution. The smart contract may be programmed to evaluate aforementioned factors such as the accuracy of the recommendation, the satisfaction of both the requester and offerers, and the overall efficiency gains achieved through the optimized task distribution. Upon successful completion of the multi-part digital product, the smart contract automatically calculates and distributes the appropriate rewards to the IDMP and participating offerers based on predefined criteria. This blockchain-based reward system not only incentivizes the platform to continually improve its AI-powered matching capabilities but also provides a secure and auditable record of all transactions and performance metrics.

In summary, FIG. 6 demonstrates a request-based digital product exchange model, where the IDMP facilitates smart contract execution, verification, and automated payment processing. Unlike the store-based model (FIG. 5), where products are pre-verified before listing, this approach ensures that verification occurs only after a request is made, improving transaction efficiency. The request based model by the IDMP ensures a secure, scalable, and immutable framework for digital product exchanges by integrating smart contract-based compliance enforcement, automated escrow mechanisms, and blockchain-backed verification.

III. Request with Escrow

FIG. 7 shows another exemplary platform-enabled three-way exchange leading to the transfer of a digital product between IDMP users, in accordance with some embodiments of the present invention.

More specifically, FIG. 7 illustrates an escrow-based model for digital product exchange and verification within the Integrated Digital Model Platform (IDMP). In this model, a requester node initiates a request for a digital product, and the IDMP acts as an intermediary, ensuring that the product is verified before releasing payment from escrow. The IDMP manages smart contract execution, escrow handling, and compliance verification, ensuring that payments are only released upon successful verification of digital products.

Unlike the store-based model (FIG. 5), where products are pre-verified before listing, and the request-based model (FIG. 6), where verification occurs before transaction finalization, the escrow-based model requires that payment be deposited in escrow before product delivery. This mirrors escrow-based freelancer platforms, ensuring that digital products are validated before fund disbursement.

The diagram consists of three primary swimlanes, representing:
Requester node (712), which registers a smart contract, submits a payment into escrow, and requests a digital product.
IDMP (730), which manages verification, escrowed payment release, and product delivery.
Offerer node (714), which submits a digital product for verification and receives payment upon approval.

These swimlanes correspond to the swimlanes Requester node (514, 612), IDMP (530, 630) and Offerer node (512, 614) in FIG. 5 and FIG. 6 respectively. An exemplary process flow is outlined below in the following steps:

### Step 1: Request and Escrow Payment Submission

The requester node (712) registers a smart contract with the IDMP (730), specifying the digital product specifications and submitting payment into escrow. The escrow mechanism ensures that funds are available for disbursement but cannot be accessed by the offerer node until verification is successfully completed.

### Step 2: IDMP Posts the Request to Offerer Nodes

Upon receiving the request, the IDMP (730) broadcasts the request and specifications to eligible offerer nodes (714), ensuring that only qualified providers submit their digital products.

### Step 3: Offerer Node Submits the Digital Product

An offerer node (714) that meets the request criteria transmits the digital product to the IDMP for verification.

### Step 4: IDMP Verifies the Digital Product

The IDMP (730) performs verification to ensure that the submitted digital product meets the requester's requirements and compliance criteria. Verification may involve:
Automated integrity checks to confirm data consistency.
Cryptographic validation to ensure authenticity and version control.
Third-party certification or manual review, where required.

In some embodiments, a private blockchain (not explicitly shown in the figure but similar to 252 in FIG. 2) may be used to record the verification process, ensuring transparency and tamper-proof validation logs.

### Step 5: Escrow Payment Release Upon Verification

Once verification is successfully completed, the IDMP releases the escrowed payment to the offerer node (714). In some embodiments, payment release may be subject to explicit acknowledgment by the requester node, ensuring a secondary approval mechanism before fund disbursement.

### Step 6: IDMP Delivers the Verified Digital Product

Following payment release, the IDMP transmits the verified digital product to the requester node (712), completing the transaction.

### Blockchain Interactions and Smart Contract Automation

In some embodiments, the IDMP may utilize a private blockchain to ensure escrow security, verification tracking, and immutable auditability of transactions. The blockchain ledger may log key smart contract interactions, including escrow deposit registration, verification status updates, requester acknowledgment records, and automated payment execution. In the escrow-based model, the IDMP can dynamically enforce escrow conditions, trigger milestone-based payments, and enable refund mechanisms in case of non-compliance.

### Alternative Embodiments and Variations

The escrow-based model may support multiple payment and verification mechanisms. In some embodiments, multiple offerers may compete for the escrowed payment, with the IDMP selecting the best digital product before fund release. In other implementations, time-based escrow conditions may be enforced, where payment is automatically released after a predefined period unless a dispute is raised. Additionally, decentralized escrow mechanisms may be employed, where a consortium of IDMP nodes collectively validates compliance before fund disbursement.

In another embodiment, the IDMP may issue digital certificates (e.g., NFTs or verifiable credentials) for successfully verified products, enabling requesters to rely on past validation records for future transactions rather than reinitiating the verification process each time.

In summary, FIG. 7 demonstrates an escrow-based digital product exchange model, where the IDMP facilitates smart contract execution, verification, and conditional payment processing. Unlike previous models, this approach ensures that funds are protected until the digital product meets all compliance requirements, preventing disputes and increasing transactional trust. The escrow-based model IDMP ensures a fair, auditable, and immutable, secure digital asset exchange, by integrating blockchain-backed escrow mechanisms, automated smart contract-based verification, and secure payment disbursement.

IV. Request with Bidding

FIG. 8 shows another exemplary platform-enabled three-way exchange leading to the transfer of a digital product between IDMP users, in accordance with some embodiments of the present invention.

More specifically, FIG. 8 illustrates a request-based bidding model, where the Integrated Digital Model Platform (IDMP) manages a competitive bidding process before verifying and finalizing the exchange of a digital product. In this model, a requester node submits a request for a digital product, and multiple offerer nodes place competing bids. The IDMP selects the winning bid based on predefined criteria, after which the winning offerer provides the digital product for verification and transaction completion.

Unlike previous models, this bidding-based approach enables market-driven pricing, allowing offerers to dynamically compete on cost, reputation, or compliance criteria. The IDMP ensures bid transparency, enforces smart contract execution, and secures payment disbursement, providing an immutable, secure, auditable transaction environment.

The diagram consists of three primary swimlanes, representing:
Requester node (812), which submits a digital product request, selects the winning bid, and initiates payment.
IDMP (830), which facilitates bid submission, manages winner selection, verifies the product, and processes payments.
Offerer node (814), which submits a bid and delivers the digital product upon selection.

These swimlanes correspond to the swimlanes Requester node (514, 612, 712), IDMP (530, 630, 730) and Offerer node (512, 614, 714) in FIG. 5, FIG. 6 and FIG. 7 respectively. An exemplary process flow is outlined below in the following steps:

### Step 1: Smart Contract Registration and Request Submission

The requester node (812) registers a smart contract with the IDMP (830), specifying the digital product specifications and initiating the bidding process. The smart contract governs bid acceptance rules, selection conditions, and time limits.

### Step 2: IDMP Posts the Request to Offerer Nodes

Upon receiving the request, the IDMP (830) broadcasts the request and specifications to eligible offerer nodes (814), allowing them to submit competing bids.

Step 3: IDMP Records Bidding Prices from Offerers

The IDMP logs and secures bid submissions, ensuring immutability and bid transparency. This prevents tampering, late bidding manipulation, or unauthorized price adjustments.

### Step 4: IDMP Manages Bidding Process and Selection Criteria

The IDMP handles the bidding process, which may involve:
Fixed-time bidding, where the best bid is selected at a predetermined deadline.
Dynamic bidding conditions, such as selection based on price thresholds or offerer reputation scores.
Multi-criteria evaluation, where factors beyond price (e.g., compliance history, past performance) influence winner selection.

### Step 5: IDMP Posts the Winning Bid

The IDMP announces the winning bid, notifying the winning offerer node (814).

### Step 6: The Winning Offerer Submits the Digital Product

The winning offerer node (814) transmits the digital product to the IDMP for verification.

### Step 7: IDMP Verifies the Digital Product

The IDMP performs verification to ensure the submitted product meets the requester's specifications. This may involve:
Automated integrity checks to confirm model accuracy.
Blockchain-based verification logs to ensure authenticity.
Third-party certification, where applicable.

### Step 8: IDMP Delivers the Verified Digital Product

Upon successful verification, the IDMP transmits the verified digital product to the requester node (812).

### Step 9: Requester Node Submits Payment

The requester node (812) submits payment for the agreed bidding price to the IDMP (830).

### Step 10: Offerer Node Receives Payment

After transaction validation, the IDMP disburses the payment to the winning offerer node (814).

### Blockchain Implementation and Smart Contract Automation

In some embodiments, the IDMP may utilize a private blockchain to ensure bid transparency, selection auditability, and secure escrow management. The blockchain ledger records bid submissions, preventing unauthorized modifications or bid tampering. Smart contracts automate the execution of bidding rules, ensuring compliance with predefined selection criteria, such as the lowest price, fastest delivery, or highest compliance score. Once a bid is accepted, the blockchain securely logs the transaction, enabling immutable verification of the offerer's commitment. Payment processing is also automated through smart contracts, ensuring that funds are only released upon successful verification of the digital product. Additionally, the IDMP may use blockchain-based identity verification to authenticate offerers, enhancing trust within the bidding ecosystem. In some embodiments, smart contracts may enable dispute resolution mechanisms by holding escrowed funds and allowing arbitration in the event of disputes over product quality or compliance.

### Alternative Embodiments and Variations

In some embodiments, the bidding-based model may be adapted to incorporate different auction mechanisms, such as reverse auctions, where prices decrease over time until an offerer accepts the request. Another variation may involve multi-offerer selections, where the IDMP chooses multiple winners based on varying criteria, such as price, speed, or compliance scores. Additionally, weighted bidding criteria may be implemented, where the selection process considers factors beyond price, such as the offerer's reputation, past performance, and product certification history. In cases where recurring transactions occur, the IDMP may introduce NFT-based verification records, allowing requesters to reference previous verifications without requiring repeated bidding cycles. Furthermore, hybrid verification models may involve decentralized validation, where third-party validators or a consortium of IDMP nodes collectively verify the digital product before approving payment release. These variations enhance flexibility in the bidding process, enabling dynamic and adaptive marketplace conditions within the IDMP ecosystem.

In summary, FIG. 8 illustrates a request-based bidding model, where the IDMP facilitates a competitive bidding process, smart contract execution, and secure payment processing. Unlike prior models, this approach introduces market-driven price discovery, ensuring competitive participation and cost efficiency.

### Checkpoints as Digital Thread Snapshots

In various embodiments, each digital product transaction over the IDMP may be mapped to a data structure representing the certified state of the digital thread associated with the digital product at a boundary event of the transaction (e.g., IDMP verification). Such data structures are denoted Digital Thread Checkpoints (DTCs). The boundary events targeted by a DTC may include store model transactions in which a digital product is pre-verified before being made available for exchange (FIG. 5), request-based transactions in which the IDMP verifies the requested product before transaction completion (FIG. 6), escrow-based transactions in which the IDMP verifies the product before releasing payment from escrow (FIG. 7), and bidding-based transactions in which the IDMP manages a competitive bidding process before verifying and finalizing the exchange (FIG. 8). Therefore, in some embodiments, the IDMP may receive a request for a DTC from a requester node or from an offerer node as part of a given digital product transaction between the requester and offerer nodes.

In certain embodiments, the system may employ a dual-ledger architecture comprising a private blockchain for authoritative execution and a public blockchain for attestation. The private blockchain may record various elements associated with the state of the digital thread at the boundary event, such as DTC hashes, Trust non-fungible token (NFT) hashes, certification state transitions, ownership or permission changes, escrow or payment releases, and validator attestations. In embodiments utilizing public blockchain anchoring, a cryptographic commitment derived from the Trust NFT hash and/or the DTC hash may be written to a public ledger, enabling independent third-party verification of authenticity and integrity without disclosure of sensitive artifacts. Sensitive artifact lineage identifiers and snapshot references remain accessible only within the IDMP or controlled storage layers. DTCs, Trust NFTs, and their uses are further discussed below.

More generally, DTCs are snapshots of digital threads certifying that a given boundary event was satisfied. In various embodiments, the boundary event may be a formal certification of a digital product, a formal validation of a digital product, or any phase in a digital product transaction. The following embodiments illustrate example implementations of Digital Thread Checkpoints and associated Trust Tokens within an Integrated Digital Model Platform (IDMP). These embodiments are provided for illustrative purposes and are non-limiting. Variations and additional configurations may be implemented without departing from the scope of the disclosed system.

### Checkpoint Payload Components

In various embodiments, a Digital Thread Checkpoint (DTC) payload may include references that capture the certified state of a digital thread at the time of approval of the certification. These references may bind the certification decision to specific artifacts, validation workflows, and evidence snapshots generated within the IDMP. Artifact lineage references may comprise version identifiers, configuration identifiers, content hashes, or other cryptographic commitments representing artifact states.

In some embodiments, the checkpoint payload may include one or more of the following example elements:
one or more prior checkpoint hashes referencing previously certified states of the digital thread;
one or more artifact lineage references identifying versions or configurations of digital artifacts used in the certified analysis;
one or more evidence snapshot identifiers corresponding to simulation outputs, validation reports, test logs, or analysis documentation; and
one or more validation pipeline identifiers and associated result references corresponding to computational workflows executed within the IDMP.

The foregoing elements are illustrative and non-limiting, and additional checkpoint payload fields may be included without departing from the scope of the disclosed system.

### Example Checkpoint Implementations

Several example certification scenarios are described below to illustrate how Digital Thread Checkpoints (DTCs) may be constructed.

### Digital Engineering Requirement Certification

In a digital engineering verification scenario involving certification of an aircraft structural requirement, a checkpoint payload may reference a prior checkpoint corresponding to a previously approved design state, identify a CAD model version of a structural component (e.g., Wing_Spar_Model_v6), reference evidence snapshots generated from finite element analysis simulations or design review artifacts, and include identifiers for the validation pipeline used to verify structural performance.

### Digital Twin Configuration Certification

In another embodiment involving certification of a digital twin configuration for industrial equipment, the checkpoint payload may include artifact lineage references identifying a particular digital twin configuration version (e.g., Turbine_DT_Config_v4), evidence snapshots derived from telemetry-based performance simulations, and validation pipeline identifiers referencing workflows used to verify operating limits or thermal performance characteristics.

### Autonomous System Software Certification

In a further embodiment involving certification of autonomous system software, the checkpoint payload may reference a flight control software version (e.g., Flight_Control_SW_v2.7), evidence snapshot identifiers corresponding to hardware-in-the-loop testing logs and simulation scenario results, and validation pipeline identifiers referencing an autonomy verification workflow used to evaluate safety performance across predefined operating conditions.

These payload elements enable the Digital Thread Checkpoint (DTC) to cryptographically bind the certification decision to specific artifact states, validation workflows, and evidence snapshots while allowing the underlying artifacts themselves to remain stored within the controlled IDMP environment.

### Additional Trust Token and NFT Components

In certain embodiments, a Trust Token associated with a Digital Thread Checkpoint (DTC) may be implemented as a non-fungible token (NFT) or other cryptographically signed credential. Such a Trust Token (e.g., Trust NFT) may include metadata governing lifecycle management, authorization, or economic conditions associated with the certified credential.

In some embodiments, the token metadata may include one or more of the following example elements:
an economic state reference defining licensing, royalty, or payment conditions associated with reuse of the certified artifact or workflow;
a permission state reference identifying classes of users or organizations authorized to utilize the certified component, digital twin configuration, or workflow;
a validity window specifying a time interval during which the certification remains valid;
a revocation pointer referencing a mechanism by which the certification may be invalidated or withdrawn; and
a supersession reference identifying a subsequent certification that replaces a prior certified state.

The foregoing elements are illustrative and non-limiting, and additional token metadata fields may be included without departing from the scope of the disclosed system.

### Example Trust Token Implementations

### Certified Component Reuse

In one embodiment involving certification of a reusable propulsion module design, the Trust Token may include an economic state reference defining licensing terms associated with reuse of the certified component, a permission state reference identifying classes of manufacturers authorized to use the design, and a validity window specifying the duration of the certification.

### Digital Twin Operational Certification

In another embodiment involving certification of a digital twin used for operational monitoring of industrial equipment, the Trust Token may include a permission state reference authorizing the digital twin configuration for use in regulatory reporting workflows, a validity window corresponding to a regulatory inspection cycle, and a revocation pointer referencing a regulatory authority mechanism capable of invalidating the certification if operational safety conditions are violated.

### Certified Workflow Reuse

In a further embodiment involving certification of a simulation or validation workflow template, the Trust Token may include a permission state reference authorizing reuse of the certified workflow for regulatory submissions or engineering verification activities and a supersession reference indicating that a newer workflow version replaces a prior certified methodology.

### Simplified Architectural Model of DTC and Trust Token

In certain embodiments, the architecture may be simplified by representing the certified digital thread state as a DTC and representing the portable certification credential as a Trust Token (e.g., Trust NFT) that references the checkpoint hash, while a tamper-evident verification infrastructure provides an external verification anchor for the certification event.

Under this simplified model:
The DTC represents the certified state of the digital thread and contains references to artifact lineage identifiers, evidence snapshots, and validation pipeline outputs maintained within the IDMP environment;
the Trust Token represents a portable credential referencing the checkpoint hash, and may include optional lifecycle metadata such as validity windows, permissions, economic references, revocation pointers, or supersession references; and
a verification infrastructure may store a cryptographic commitment derived from the checkpoint hash or Trust Token hash.

In certain embodiments, the cryptographic commitment may be recorded on a blockchain or other distributed ledger. In other embodiments, the commitment may be recorded using alternative tamper-evident verification systems such as trusted timestamping services, distributed audit ledgers, or consortium-managed verification databases.

In these embodiments, the verification infrastructure stores only the cryptographic commitment, while artifact data, evidence snapshots, and validation outputs remain stored within the controlled IDMP environment. This architecture enables independent verification of certification authenticity and integrity while preserving confidentiality of proprietary artifacts and validation data.

FIG. 13, described below, illustrates various exemplary stages and data structures (e.g., DTC, Trust Token) that are relevant to the disclosed digital transaction architecture, from the occurrence of a boundary event to its recording on public and/or private blockchains, in accordance with some embodiments of the present invention.

### Exemplary Platform-Enabled Transactions

### I. Private Neural Network

FIG. 9 shows a sample platform-enabled three-way transaction leading to a privacy-enhanced evaluation of a neural network (NN) model, in accordance with some embodiments of the present invention.

More specifically, FIG. 9 illustrates a mechanism for licensing and executing a model within the Integrated Digital Model Platform (IDMP), enabling a model user to utilize a model owned by another party without obtaining direct access to its parameters. In alternate embodiments, the mechanism can reflect licensing execution of a digital model without paying for its full access. The IDMP acts as an intermediary, ensuring that the model is securely executed, results are transmitted, and payment is handled automatically via a smart contract.

An exemplary approach allows the model owner to receive compensation for the model's use without exposing the model itself, while the model user benefits from access to advanced models without purchasing full rights. A reshuffling technique is optionally applied to ensure that neither the model parameters nor the user's prompt are compromised to the other party or to the IDMP. For more details on the reshuffling technique and other aspects of data sovereignty assurance during AI model training and evaluation, see PCT application No. PCT/US24/58547 with Docket No. IST-04.001PCT, incorporated by reference in its entirety herein.

The transaction is managed through a smart contract on a public blockchain or via a trusted payment gateway, ensuring an immutable, secure, and decentralized licensing mechanism. The exchange of data and value occurs through a secure execution model, ensuring that the model owner retains control while the model user benefits from computational results without direct access to the model. This approach leverages blockchain-enforced licensing and cryptographically assured execution, ensuring an immutable, verifiable, and decentralized licensing mechanism without requiring trust between the parties. An exemplary process flow is outlined below in the following steps:

### Step 1: Model Preparation by the Model Owner

The model owner (902) may optionally reshuffle model M (904) using techniques defined in 04.001, transforming it into model M′ (906). The reshuffling process prevents direct access to the original model while preserving its functionality. In some embodiments, the model owner (902) may offer a model with a defined set of permissions for data artifacts or functions that may be authorized to be performed on the model.

### Step 2: Model Owner Submits Model M′ to IDMP and Registers a Smart Contract

The model owner (902) sends reshuffled model M′ (906) to the IDMP, making it available for execution under predefined conditions. A smart contract is recorded on the public blockchain (or with a trusted third party via a trusted payment gateway 932). This contract specifies pricing terms for using the model, establishing an automated marketplace for licensing.

### Step 3: Model User Selects the Model and Submits a Request

A model user (920) discovers the model M′ (906) within the IDMP ecosystem (marketplace not shown in this figure). Upon selecting the model, the model user agrees to the pricing terms set in the smart contract.

Step 4: Model User Prepares and Submits their Prompt

In some cases, the model user may optionally reshuffle their prompt (not shown, see 04.001) before sending it to the IDMP. The model user then sends payment to the smart contract in escrow and submits the reshuffled prompt (910) to the IDMP for evaluation.

### Step 5: IDMP Evaluates the Prompt on the Licensed Model

The IDMP performs the model evaluation by running the submitted reshuffled prompt (910) on the reshuffled model M′ (906). The IDMP generates the result (914) and attaches data necessary to undo the reshuffling, ensuring that the final output remains usable by the model user while maintaining security.

### Step 6: Smart Contract Triggers Payment Release

Upon successful model execution, the IDMP triggers the smart contract (930), confirming that the result was sent to the model user. This triggers the release of escrowed payment to the model owner (902), ensuring that compensation is only processed after the requested evaluation is completed.

### Step 7: Model User Receives and Reconstructs the Result

The model user (920) receives the reshuffled result (914) from the IDMP and performs an unshuffling process (see PCT application No. PCT/US24/58547, Docket No. IST-04.001PCT) to reconstruct the final output.

### Alternative Embodiments and Variations

In some embodiments, model reshuffling may be omitted, particularly if the licensing conditions permit execution on an unaltered model. In other embodiments, the licensing conditions may restrict execution of specific functions on an unaltered model, or offer different licensing permissions for different function executions. Alternatively, the IDMP may support multiple layers of obfuscation, where both the model owner and the model user apply transformations before exchanging data, further enhancing privacy. Another variation involves multi-party licensing, where multiple model users execute queries on the same model, with smart contracts distributing revenue proportionally among model owners based on usage metrics. Additionally, hybrid verification mechanisms may be introduced, allowing trusted third parties to validate the execution without exposing the original model or prompt.

In summary, FIG. 9 demonstrates a secure, automated licensing model, where the IDMP facilitates model execution, smart contract-based payments, and privacy-preserving interactions between model owners and model users. The exemplary approach with the IDMP enables a decentralized, immutable, and secure framework for licensing without exposing model parameters or user prompts, by immutable reshuffling techniques, blockchain-based smart contracts, and escrowed payments.

### II. Private Training Data

FIG. 10 shows a sample platform-enabled three-way transaction leading to a privacy-enhanced training of a neural network (NN) model, in accordance with some embodiments of the present invention.

More specifically, FIG. 10 illustrates a mechanism for licensing training data owned by a data owner (1022) to a model owner (1002) for model training. The Integrated Digital Model Platform (IDMP) facilitates this transaction, ensuring that training data is used without exposing the raw data to the model owner.

A reshuffling technique (see PCT application No. PCT/US24/58547, Docket No. IST-04.001PCT) is optionally applied to transform the training data before transmission, ensuring privacy is preserved while maintaining the data's training utility. The transaction is governed by a smart contract (1030) recorded on a public blockchain (1032) (or with a trusted payment gateway) to automate licensing terms, payments, and verification.

The approach allows for an exemplary three-way interaction between data owners, model owners and the IDMP as follows:
Data owners to be compensated with tokens for allowing the use of their training data.
Model owners to access reshuffled training data for model training without gaining access to the original dataset. Model owners may optionally share reshuffled models to the IDMP for the sake of training.
The IDMP applies data reshuffling before using the training data to train the model (or reshuffled model) received from the model owner, ensuring security.
Payments to be managed via smart contracts, enforcing secure, transparent transactions.

An exemplary process flow is outlined below in the following steps:

### Step 1: Data Preparation by the Data Owner

The data owner (1022) prepares training data (1026) for licensing. In some embodiments, the data owner may apply reshuffling (1028) before submission to obfuscate sensitive aspects of the training data.

### Step 2: Data Owner Submits Reshuffled Training Data to IDMP and Registers a Smart Contract

The data owner (1022) submits the reshuffled training data (1028) to the IDMP for licensing. Simultaneously, the smart contract (1030) is registered on the blockchain (1032), defining pricing terms, usage conditions, and automated payments.

### Step 3: Model Owner Selects Training Data and Submits a Request

A model owner (1002) selects the reshuffled training data (1028) for training and agrees to the pricing terms specified in the smart contract (1030).

### Step 4: Model Owner Submits Payment to the Smart Contract

The model owner (1002) pays a license fee (1020) through the blockchain (1032) to access the training data. This ensures that the data owner (1022) will be compensated upon successful training data transmission.

### Step 5: IDMP Provides Reshuffled Training Data to Model Owner

The IDMP (1010) transmits the reshuffled training data (1028) to the model owner (1002) for use in training.

### Step 6: Model Owner Trains a Model Using Reshuffled Training Data

The model owner trains a model (1004) using the reshuffled training data (1028) without accessing the original, unmodified dataset. If model reshuffling is also used, the model owner reshuffles their model (1006), generating reshuffled model M′ (1008) before training.

### Step 7: IDMP Trains the Model Using the Reshuffled Training Data

If IDMP performs the training, the reshuffled model (1008) is sent to the IDMP (1010), which then trains model M′ (1012) using the reshuffled training data (1028). Upon completion, the trained model (1016) is sent to the model owner (1002).

### Step 8: Smart Contract Triggers Payment Release

Once the training data has been delivered and/or model training has been completed, the IDMP triggers the smart contract (1030), confirming the execution. The smart contract then releases payment (1024) to the data owner (1022).

### Step 9: Model Owner Compensates IDMP for Performing Training

If the IDMP executes the training step, the model owner (1002) submits additional payments (1018) to the IDMP via the blockchain (1032) for computational costs and licensing fees.

Blockchain Implementation and Smart Contract Automation

The IDMP may utilize a public blockchain (1032) or a trusted payment gateway to facilitate automated, secure, and verifiable licensing transactions. The smart contract (1030) ensures that the data owner is compensated only after successful delivery of training data. Payments and licensing terms are recorded immutably, preventing disputes while maintaining data privacy.

In some embodiments, blockchain-based logging enables tracking of training data usage without revealing the original dataset. The IDMP may also tokenize licensing rights, allowing training data to be sold as a non-fungible token (NFT) or integrated into secondary licensing markets.

### Alternative Embodiments and Variations

In some embodiments, the reshuffling technique may be omitted, particularly if the licensing conditions permit execution on an unaltered dataset. Alternatively, the IDMP may support multiple layers of data protection, where both the data owner and the model owner apply transformations before data exchange, further enhancing privacy.

Another variation involves multi-party licensing, where multiple model owners pay to access the same reshuffled dataset, with smart contracts distributing revenue proportionally among data owners based on usage metrics. Additionally, hybrid verification mechanisms may allow trusted third-party validators to certify dataset integrity before use.

Furthermore, blockchain-based reputation scoring may be integrated, where data owners and model owners build verifiable credibility based on successful transactions, allowing for dynamic pricing models, where high-quality datasets command higher licensing fees.

In summary, FIG. 10 illustrates a secure, automated licensing model, where the IDMP facilitates training data exchange, smart contract-based payments, and privacy-preserving interactions between data owners and model owners. By employing reshuffling techniques, blockchain-based smart contracts, and escrowed payments, this model enables a decentralized, immutable, and secure framework for training data licensing without exposing original data.

The exemplary approaches shown in FIGS. 9 and 10 suggest ways the IDMP ensures a scalable, auditable, and privacy-preserving ecosystem for AI model training and compensation.

### III. Staking Mechanism

FIG. 11 shows a sample platform-enabled three-way transaction leading to the exchange of a digital artifact through a staking mechanism, in accordance with some embodiments of the present invention. More specifically, FIG. 11 illustrates a trust-based staking mechanism within the Integrated Digital Model Platform (IDMP), where digital artifact owners stake trust tokens to increase trustworthiness and gain rewards. This so-called attribution staking system ensures that digital artifact owners are compensated based on both the stake amount and the artifact's usage frequency, providing a robust framework for digital product valuation, licensing, and trust establishment. Attribution staking differs from validator staking, which secures the blockchain itself. Instead, attribution staking focuses on establishing digital artifact reliability and incentivizing contributions within the IDMP. Unlike validator staking, which ensures ledger integrity and transaction validation, attribution staking directly influences the reputation, adoption, and marketplace value of a specific digital artifact.

Smart contracts (1150) govern the staking process and record transactions on the blockchain or a trusted payment gateway (1132), ensuring secure, verifiable, and decentralized transactions. In some embodiments, penalties apply if a staked digital artifact does not meet its intended use, discouraging misleading artifact representations. However, in other embodiments, only positive staking rewards are issued, meaning digital artifact owners are rewarded for verified use without incurring penalties.

The IDMP may increase the staking multiplier (1128) for highly utilized digital artifacts with strong validation, ensuring continued high-quality contributions. This mechanism dynamically adjusts staking parameters in response to artifact adoption, ensuring real-time optimization of staking incentives. If demand for a digital artifact rises, the staking multiplier increases automatically, while low-demand artifacts receive adjusted staking multipliers to maintain equitable staking rewards across the platform. An exemplary process for attribution staking and validator staking may include the following steps:

### Step 1: Digital Artifact Submission and Discovery

The digital artifact owner (1102) submits a digital artifact (1126) to the IDMP (1110) for listing and potential licensing. The IDMP registers the artifact (1124) and makes it discoverable (1104) to prospective users. Artifacts become discoverable through marketplace listings, bidding mechanisms, or escrow-based licensing agreements, ensuring flexible acquisition methods for digital artifact users.

### Step 2: Staking Trust Tokens to Establish Artifact Trustworthiness

To establish trustworthiness and enhance visibility, the digital artifact owner (1102) stakes trust tokens (1128). This stake functions as a collateral mechanism, demonstrating the owner's vested interest in the accuracy and quality of their artifact. A higher stake amount elevates the artifact's ranking within IDMP, increasing discoverability and credibility. IDMP enables adjustable stake levels, allowing artifact owners to increase their stake over time and optimize their positioning in the ecosystem.

### Step 3: Digital Artifact Licensing and Transaction Execution

A digital artifact user (1120) licenses or purchases the artifact (1126) through a payment mechanism (1134-1136). The blockchain (1132) or a trusted payment gateway securely processes payments, ensuring transaction transparency. The IDMP records the exchange transparently and verifiably, guaranteeing transaction integrity and providing an immutable record of digital artifact ownership or licensing agreements.

### Step 4: Staking Rewards are Issued Based on Artifact Usage

Beyond direct licensing revenue, the IDMP issues staking rewards (1140) to the digital artifact owner (1102). Staking rewards, typically a fraction of the original stake (e.g., 1-3% per use/license/purchase), incentivize long-term artifact contributions and platform engagement. The smart contract (1150) automates staking reward issuance, ensuring that rewards are distributed only when the artifact is actively used.

### Step 5: Stake Management and Incentive Design

The attribution staking model relies on effective stake management to balance trust establishment with economic incentives. The stake (1128) is a deposit that remains withdrawable, though higher stakes generate greater staking rewards over time. To prevent excessive stake withdrawals, the IDMP may implement lockup periods that retain staked tokens for a predefined duration. Participants receive disincentives for early stake withdrawals, encouraging long-term commitment and artifact longevity in the ecosystem.

### Step 6: Growth and Increasing Token Value Over Time

As the IDMP ecosystem expands, the trust token (T) appreciates in value, ensuring alignment between token growth and platform adoption. The low-cost entry for staking at early stages encourages high-value contributions, fostering a self-reinforcing cycle of digital artifact trustworthiness and attribution staking rewards. Over time, as more digital artifacts enter circulation, staking economics stabilize, ensuring a scalable and sustainable valuation framework for digital products.

### Blockchain Embodiment and Validator Staking

While FIG. 11 focuses on attribution staking, validator staking operates in parallel to maintain blockchain security and trust enforcement. Validator nodes and guardian nodes validate staking transactions, ensuring network-wide security and protection against fraudulent staking activities. Validator staking differs from attribution staking by focusing on securing the blockchain infrastructure itself, rather than assigning trust scores to individual digital artifacts. The IDMP utilizes validator staking to guarantee transparency and prevent unauthorized staking activities. Although validator staking is not explicitly shown in FIG. 11, it remains a foundational element of the IDMP's trust-backed digital economy.

### Alternative Embodiments and Variations

In some embodiments, the IDMP enforces penalties for misrepresented or low-quality digital artifacts. These penalties may reduce an artifact owner's staked amount or lower the artifact's ranking in the IDMP marketplace. In other embodiments, staking rewards remain exclusively positive, allowing digital artifact owners to earn trust incentives without penalty risks.

The staking multiplier (1128) dynamically adjusts based on artifact reputation and platform-wide demand, similar to market-driven pricing models. If an artifact sees high licensing demand, its staking multiplier increases automatically, while artifacts with lower engagement receive adjusted multipliers to ensure fair staking distribution.

Decentralized voting mechanisms complement IDMP's internal verification process, enabling users to contribute trust-weighted feedback for digital artifacts. The IDMP and decentralized blockchain voting collaboratively define an artifact's final trust ranking, ensuring a hybrid approach to digital product trust evaluation.

A trust pool mechanism also exists in some embodiments, allowing multiple stakeholders to stake trust tokens for a shared digital artifact. In cases where digital threads contain multiple interconnected artifacts, a collective trust pool validates the entire workflow. For single artifacts, trust pools accumulate stakes from multiple requesters or offerers, ensuring continuous artifact reputation building based on validated use cases.

Through these mechanisms, the IDMP fosters a sustainable, trust-driven marketplace where high-quality digital artifacts receive the necessary incentives for adoption. By integrating attribution staking, decentralized voting, and validator oversight, the IDMP secures long-term marketplace stability, artifact credibility, and equitable compensation for digital asset owners.

Document Rendering from System Snapshots

As discussed in PCT application No. PCT/US26/11743 (Docket No. IST-03.012PCT), snapshots provide immutable point-in-time captures of system configurations, and enable the IDMP to deterministically reconstruct prior system states, to compare configurations across time, and to generate consistent views of digital resources for audit and compliant purposes. FIG. 12 illustrates an exemplary system snapshot and document-rendering architecture for managing versioned digital assets in a configuration-scoped manner, in accordance with some embodiments of the present invention.

In particular, FIG. 12 shows the generation or rendering of specific documents (e.g., 1236), each featuring a specific snapshot (e.g., 1222). Documents are a subclass of the file class shown in FIG. 16 of PCT application No. PCT/US26/11743 (Docket No. IST-03.012PCT), inheriting file functionalities. While the operations described in FIG. 12 focus on documents, they may apply more generally to any of the digital objects described in FIG. 2. A system configuration (e.g., 1206) can be used to generate multiple documents (e.g., 1234). Each document (e.g., 1234) can have multiple revisions (e.g., 1232). A document revision (e.g., 1232) contains links (e.g., 1238) to tracked files (e.g., 12 A snapshot (e.g., 1222) contains snapshot items (e.g., 12). A rendered document (e.g., 1236) may be created by swapping each tracked file (e.g., 1212) for the corresponding snapshot item (e.g., 1224) in a selected snapshot (e.g., 1222).

More specifically, in FIG. 12, a system 1202 is a collection of data files which collectively provide a common context for all data involved. A system is defined by a system configuration that indicates all the files contained within, and how these are configured and related. Thus, system 1202 can have one or more system configurations. Each configuration such as 1206 is configured to define and maintain a bounded and stable set of tracked files 1210. Each tracked file such as 1212 represents a reference to a file tracked over time within the scope of the configuration 1206, such as a model, artifact, image, dataset, or other digital resource (e.g., a digital object). Each tracked file may be pinned to a specific file revision (not shown in FIG. 12). The set 1210 of tracked files is configuration-scoped such that modifications to the set of tracked files is effected by the creation of a new configuration 1206, thereby establishing a stable dependency boundary for versioning, auditability, and reproducible system state reconstruction. A dependency boundary established by a system configuration refers to the explicit scope that defines which files are tracked and managed together as a group for versioning, change management, and state capture.

Snapshots represent the system configuration and all tracked files it contains at a particular time instant. Thus, system configuration 1206 may further have a collection of snapshots (e.g., 1222, 1223, etc.), wherein each snapshot such as 1222 captures a point-in-time state of configuration 1206 of system 1202. Each snapshot 1222 comprises multiple snapshot items such 1224, and system 1202 may enforce a one-to-one correspondence between tracked files (e.g., Tracked File 1, Tracked File 2, etc.) and snapshot items (e.g., Snapshot Item 1, Snapshot Item 2, etc.) for a given snapshot 1222. Each snapshot item 1224 may store an immutable binding that associates a respective tracked file 1212 with a specific file revision identifier, thereby locking the tracked file to that revision at the time the snapshot is generated. As a result, each snapshot 1222 provides a deterministic resolution table mapping all tracked files of the configuration to their associated revision identifiers, enabling repeatable reconstruction of system state.

FIG. 12 further shows documents such as 1234 associated with configuration 1206. For example, different types of documents such as requirement specifications, technical drawings and schematics, test plans and results, and bills of materials can be generated from the same set of tracked files 1210, based on corresponding document templates. A document such as 1234 may have one or more document revisions such as 1232. Each document revision such as 1232 may be rendered into a rendered document such as 1236. Each document revision such as 1232 may include document text and one or more tracked file links such as 1238. Each tracked file link may reference a tracked file within the same configuration. In addition, each tracked file link field may be associated with an externally addressable document endpoint, as discussed in the context of document splicing shown in FIG. 14 of PCT application No. PCT/US26/11743 (Docket No. IST-03.012PCT). Such an externally addressable document endpoint may be an API endpoint, and may include an identifier for the document revision, and an identifier to the tracked file link field, so that the link can be directly edited as needed.

Document revisions 1232 are versioned independently of the snapshots, such that a single document revision may be rendered against multiple snapshots without modification.

One example of a document revision (e.g., 1232) that can be rendered against a snapshot is a live document or magic document as discussed in reference to FIG. 1 of the present disclosure, as well as FIG. 15 of PCT application No. PCT/US26/11743 (Docket No. IST-03.012PCT). A magic document contains references or links to versioned digital artifacts, which in FIG. 12 are tracked file links (e.g., 1238). A rendered document (e.g., 1236), such as the one shown in FIG. 15 of PCT application No. PCT/US26/11743 (Docket No. IST-03.012PCT), may be rendered or generated by resolving a document revision (e.g., 1232) against a selected snapshot (e.g., 1222), where snapshot data items in the snapshot are resolved to respective file revisions identified by tracked files linked in the document revision.

During rendering, each tracked file link (e.g., 1238) may be resolved by dereferencing a corresponding snapshot item link (e.g., 1240), which references a snapshot item (e.g., 1224) associated with the selected snapshot (e.g., 1222). Through this resolution process, each embedded reference in the rendered document (e.g., 1236) is bound to the specific file revision identifier recorded in the snapshot, ensuring that the rendered document reflects a consistent and immutable system state corresponding to the selected snapshot.

In operation, selection of a different snapshot (e.g., 1223) causes the system (e.g., 1202) to regenerate the rendered document (e.g., 1236) using the revision bindings recorded in the newly selected snapshot, without requiring modification to the underlying document revision (e.g., 1232). In some embodiments, an initial snapshot (e.g., 1222) is generated automatically upon creation of the configuration (e.g., 1206), thereby ensuring snapshot-consistent rendering is available immediately.

In various embodiments, each snapshot item (e.g., 1224) may be stored and managed as a discrete data object including an item identifier, creation metadata, a reference to the associated snapshot (e.g., 1222), and a reference to the bound file revision identifier. The architecture illustrated in FIG. 12 supports repeatable rendering, historical comparison of system states, and verifiable reconstruction of configuration states for audit, certification, and compliance purposes within the system 1202.

Documents are a subset of the resources managed within a system configuration, such that each system configuration may have an associated set of system documents. A document may also reference two separate systems and may be rendered against two separate snapshots of the two separate systems. In such cases, each sub-portion of the document may correspond to one system versus the other, and the rendered document may compile these portions together. For example, one section of the document may be related to a particular system under a particular system configuration, while another section references a different system configuration. The relationship between a snapshot and a rendered document is not one-to-one either: a rendered document may incorporate artifacts from different snapshots (of the same or different systems), enabling users to compose documents that draw from multiple point-in-time captures across different system configurations.

A system document associated with a system may represent a digital thread that defines a sequence of operations and data relationships across files within the system. In this context, the system document may specify which files serve as inputs, which splice functions or IDMP platform functions are applied, which files are produced as outputs, and dependencies among relevant files. Each document revision may represent a version of the digital thread, enabling users to track how the workflow itself evolved over time.

In one exemplary implementation, a user may first define a system and establish a system configuration to specify tracked files that represent digital artifacts to be managed. With an established dependency boundary, the user may then write or create a digital thread within this configuration, knowing which artifacts are available for inclusion in the workflow. The digital thread may be created in a document fashion, where the user composes the workflow as a document with embedded references to the tracked files, or in a code-first fashion, where sequences of operations and data relationships are defined programmatically. When the digital thread is executed, relevant files in the system are processed through the defined operations, generating new file revisions and a new system configuration recording new derivation relationships.

Once the digital thread is executed, verification may be performed to confirm that the digital thread has executed correctly, and that the resulting system state as defined by the new system configuration maintains compliance with defined requirements. Such a verification result is associated with the resulting system state as captured by the post-execution snapshot, effectively labeling the snapshot as valid or invalid. If the snapshot passes verification, it may be marked as a good (e.g., “valid”) snapshot, and documents may be rendered from it. If the snapshot does not pass verification, thus breaking the integrity of the broader system, the user may be notified of the incorrect result, and document rendering may be prevented by the IDMP. This verification mechanism ensures that only valid or compliant snapshots are used for downstream documentation, audit, and certification purposes.

To verify that a digital thread has executed correctly and that a snapshot is valid, the IDMP checks if the resulting system state passes one or more checks on consistency, functionality, compliance and the like. For example, resource update processes discussed in reference to FIG. 19 and FIG. 20 of PCT application No. PCT/US26/11743 (Docket No. IST-03.012PCT) may be carried out to verify data dependencies among affected digital artifacts, and to confirm that all file revisions are up-to-date or appropriately pinned. In another example, data integrity checks may be performed as part of the verification process to ensure newly generated file revisions have valid content tokens pointing to the raw binary file data (see PCT application No. PCT/US26/11743 (Docket No. IST-03.012PCT)). In yet another example, the resulting system state may be validated against regulatory requirements.

### Digital Thread Checkpoint (DTC)

The IDMP offers credentials for trusted sources of data, in addition to performing secure digital threads with auditability. We describe mechanisms for attributing value for trusted digital models that are tracked in a secure ledger. This value tracking can also be tokenized on an external blockchain offering a trust token and/or a utility token, as discussed below.

In various embodiments, a Digital Thread Checkpoint (DTC) is a deterministic, cryptographically defined state representation of a digital thread within an Integrated Digital Model Platform (IDMP), created at a defined boundary event and constituting a canonical, immutable reference point in the lifecycle of the digital thread.

A digital thread within the IDMP comprises an ordered sequence of digital artifacts and artifact lineage states, model configurations and twin configurations, validation workflows and computational outputs, user interactions and authorized data-plane agent operations, documentation updates including live digital objects (e.g., magic documents, magic boards, or magic spaces), and decision events performed under zero-trust authorization controls. The digital thread evolves dynamically as artifacts are modified, validation pipelines execute, and live digital objects update. The DTC represents a frozen and authoritative state of that evolving thread at a specific boundary condition.

### Checkpoint Creation Event

In preferred embodiments, a DTC is created in response to a digitally signed approval event by an authorized decision-maker, such as a regulatory authority or delegated certifying entity.

In alternate embodiments, a DTC may be created automatically upon completion of a predefined validation workflow, upon satisfaction of predefined computational or compliance criteria, upon execution of a programmable smart contract condition, upon generation of a printed or instantiated version of a live digital object, or upon user-defined invocation of a checkpoint operation.

The boundary event defines the moment at which the digital thread state is frozen and canonically represented.

### Snapshot and Freeze Mechanism

At the time of checkpoint creation, the IDMP performs a snapshot operation that pins relevant state elements of the digital thread. In various embodiments, the snapshot operation includes capturing artifact lineage identifiers (e.g., version IDs or configuration IDs), capturing identifiers of evidence snapshots referenced in a magic document, capturing validation pipeline identifiers and associated result references, capturing model splice outputs used to generate live digital object content, capturing zero-trust authorization context for displayed sections, and capturing timestamps and authority identifiers. FIG. 12, discussed above, illustrates an exemplary system snapshot and document-rendering architecture (see PCT application No. PCT/US26/11743 (Docket No. IST-03.012PCT) for further detailed descriptions).

In certain embodiments, the snapshot operation further includes generating cryptographic commitments such as a hash of a structured checkpoint payload, a Merkle root over artifact content hashes, a Merkle root over evidence snapshot hashes, or combinations thereof.

The snapshot operation prevents subsequent modification of referenced artifacts or evidence from altering the certified state represented by the checkpoint. Although live digital objects may continue to update dynamically after checkpoint creation, the DTC refers to the frozen snapshot state existing at the boundary event.

### Structured Checkpoint Payload

In various embodiments, the DTC comprises a structured payload including a thread identifier, a checkpoint identifier, a scope type (e.g., requirement-level, milestone-level, artifact-level, workflow-level), a scope reference identifier, a prior checkpoint reference (e.g., prior checkpoint hash), artifact lineage references, evidence snapshot identifiers, validation pipeline identifiers and/or result references, a DTC timestamp, an authority identifier, and optionally a validity window, revocation or supersession reference. In various embodiments, the scope type defines the level or category of certification that the checkpoint represents, whereas the scope reference identifier identifies the specific item being certified within the given scope type, as illustrated in the examples below.

A deterministic checkpoint hash is computed over the structured payload. The authorized decision-maker signs either the payload or the checkpoint hash, producing a non-repudiable canonical checkpoint.

### Canonical Nature

The DTC constitutes the authoritative representation of the digital thread state at the boundary event. Intermediate unsigned states, live updates, or draft magic document views do not supersede a signed checkpoint.

In embodiments employing hierarchical certification, milestone-level checkpoints may reference multiple requirement-level checkpoints, forming a composable structure of certified states. In certain embodiments, checkpoints form a hash-linked sequence, each referencing a prior checkpoint, thereby forming a tamper-evident chain of certified thread states.

### Relationship to Magic Documents

Magic documents (live digital documents) may serve as user-facing representations of digital thread data, dynamically updating based on underlying model changes and digital thread execution.

In various embodiments, a magic document is used to assemble and display the evidence and artifact references underlying a decision event. Upon checkpoint creation, the system pins the referenced sections of the magic document via snapshot identifiers. A printed or instantiated version of the magic document may be generated as a human-readable archival representation of the checkpoint state. However, the canonical DTC is defined by the structured payload and cryptographic commitments, not by the rendered document format.

Thus, the magic document facilitates visualization and evidence organization, while the DTC constitutes the cryptographically authoritative state.

### Lifecycle and Revocation

Subsequent DTCs may supersede prior checkpoints, revoke or modify certification scope, update compliance status, or expand permissions. In certain embodiments, explicit revocation references are included in the structured payload, allowing lifecycle management of certified states.

### Relationship to Trust NFT

In token-enabled embodiments, a trust NFT cryptographically references a DTC hash and serves as a portable credential representing that certified state. The checkpoint defines the state; the trust NFT certifies and optionally operationalizes that state.

### Exemplary Blockchain Integration

In certain embodiments, the DTC or its hash is recorded on a private blockchain as part of a state transition. A cryptographic commitment derived from the checkpoint hash may be anchored to a public blockchain to enable independent verification without exposing sensitive artifact data.

### Trust NFT (Non-Fungible Token)

In various embodiments, a Trust NFT is a non-fungible, digitally signed credential generated by the IDMP in response to the creation of a DTC. The Trust NFT cryptographically references the deterministic checkpoint hash corresponding to the certified digital thread state.

Each Trust NFT is uniquely bound to a specific checkpoint and scope definition, including but not limited to requirement-level certification, milestone-level certification, artifact configuration approval, workflow approval, or combinations thereof. Because each Trust NFT references a distinct checkpoint hash and scope, Trust NFTs are non-interchangeable.

The Trust NFT comprises a structured payload that may include a token identifier, referenced checkpoint hash, scope type and scope reference identifier, certification status, NFT timestamp, issuer identifier, and optionally economic state references, permission state references, validity windows, revocation pointers, or supersession references. A deterministic token hash may be computed over the structured payload and digitally signed by the IDMP and/or additional validators.

Whether it is in the context of a DTC or a Trust NFT, a revocation pointer is a reference or identifier stored on a blockchain or distributed ledger that points to the revocation status of its associated DTC or Trust NFT.

The issuer identifier is a unique identifier of the entity that minted or issued the NFT, enabling verification of the NFT's origin and the authority under which it was created. In some embodiments, the issuer identifier is identical to the associated DTC's authorized decision-maker.

The Trust NFT represents the certified state of the digital thread at the checkpoint. It does not constitute a representation of the entire digital thread, but rather a portable credential of the canonical checkpoint state.

In certain embodiments, issuance of the Trust NFT causes execution of programmable state transitions on a private blockchain, including certification status updates, escrow releases, ownership transfers, license activations, or permission grants. In other embodiments, the Trust NFT functions as a portable certification credential without automatic economic enforcement.

In embodiments utilizing public blockchain anchoring, a cryptographic commitment derived from the Trust NFT hash and/or the DTC hash is written to a public ledger, enabling independent third-party verification of authenticity and integrity without disclosure of sensitive artifacts.

The Trust NFT is distinct from payment tokens, stablecoins, governance tokens, or utility tokens, although such economic tokens may interact with or be triggered by issuance of the Trust NFT.

### Trust Over the IDMP

Within the IDMP, “trust” refers to cryptographically verifiable reliance on a certified DTC and its associated Trust NFT.

Trust is not merely confidence in a platform participant; rather, it is the ability of a relying party to independently verify that a certified digital thread state satisfies defined integrity, authority, provenance, process, scope, and lifecycle conditions.

Integrity trust is achieved through deterministic hashing of the structured checkpoint payload and binding of that hash to a verifiable digital signature. For example, the structured checkpoint payload hash may be encrypted using a user's private key through an asymmetric cryptographic algorithm (e.g., RSA, ECDSA). Any modification of the structured payload, such as changes in referenced artifacts, evidence snapshots, or validation references, changes the checkpoint hash and invalidates the certification.

Authority trust arises from digital signatures of recognized regulatory or authorized entities whose credentials are verifiable. The signature cryptographically binds the authority to the defined scope of certification and provides non-repudiation.

Provenance trust is established through pinned artifact lineage references and evidence snapshot identifiers captured at checkpoint creation, ensuring that the certified state can be traced to specific artifact versions and validation outputs existing at the time of approval.

Process trust ensures that validation workflows, computational pipelines, and associated results referenced in the checkpoint are explicitly identified and version-bound, preventing substitution or modification of computational methods after certification.

Scope trust ensures that the checkpoint explicitly defines the boundaries of certification. A requirement-level certification does not imply milestone-level certification unless explicitly referenced in a corresponding checkpoint and Trust NFT.

Lifecycle trust is maintained through hash-linked checkpoints, revocation references, and supersession mechanisms that clearly identify the authoritative certified state over time.

In embodiments employing private and public blockchain integration, decentralized verification trust is achieved by recording checkpoint-related state transitions on a private blockchain and anchoring cryptographic commitments to a public blockchain, thereby enabling independent verification of authenticity and integrity without disclosure of proprietary data.

Accordingly, trust within the IDMP is defined as the cryptographically enforceable and independently verifiable reliability of a certified digital thread state as represented by a DTC and, in certain embodiments, by its associated Trust NFT.

### END-TO-END EXAMPLES

The following examples illustrate non-limiting embodiments of DTC creation, Trust NFT issuance, private blockchain state enforcement, and public blockchain anchoring.

### Example A: Requirement-Level Certification

A supplier submits an updated digital artifact, such as Actuator_Model v7, for evaluation against Requirement R-17.

### Step 1: Validation

An IDMP validation workflow executes a test pipeline (e.g., TP-3 v2.1) and generates simulation outputs and test result artifacts. Evidence snapshots are created and access-controlled under a zero-trust model. Each artifact and snapshot is assigned a lineage identifier and, in certain embodiments, a content hash.

### Step 2: Canonical Checkpoint Formation

At decision time, the IDMP performs a freeze operation that pins:
Artifact lineage reference: Actuator_Model v7
Evidence snapshot identifiers
Validation pipeline identifier and result references

A structured checkpoint payload is constructed including:
Thread_ID
Scope_Type=requirement.
Scope_Reference_ID=R-17.
Prior_Checkpoint_Hash
Evidence and artifact references
Timestamp
Regulatory Authority_ID

A deterministic checkpoint hash is computed, for example using the following pseudo-code, where H( ) denotes the hashing function:

$$Checkpoint\_Hash = H ( Structured\_Payload )$$

The regulatory authority digitally signs the checkpoint hash, thereby creating a canonical DTC by combining the generated cryptographic signature with the checkpoint hash.

### Step 3: Trust NFT Issuance and Private Blockchain Update

A Trust token (which, in certain embodiments, may be implemented as a non-fungible token (NFT)), is generated referencing the Checkpoint_Hash. The Trust NFT payload includes:
Token_ID.
Referenced_Checkpoint_Hash
Scope_Type=requirement
Certification_Status=approved
Issuer_ID
Timestamp

A token hash may be defined as a hash of the Trust NFT payload elements. A deterministic token hash is thus computed and signed. A private blockchain transaction is then submitted containing:
Checkpoint_Hash
token Hash
Certification state update instruction

The private chain records:
Requirement R-17 status=Approved
Optional escrow release
Optional permission update

In blockchain-based escrow, escrow release is typically performed by a smart contract, which automatically releases the funds when the specified conditions are verified on-chain, such as confirmation of delivery, completion of a service, or approval by multiple signatories.

In the context of blockchains, a permission update might involve granting a new user the ability to submit transactions, revoking a user's access to certain data, elevating a node's role to become a validator, or changing the signatories authorized to approve multi-signature transactions. In smart contract systems, permission updates can also refer to modifying which users are allowed to call specific functions or access particular resources.

The transaction is then finalized under the private chain's consensus protocol (e.g., Proof-of-Authority or BFT).

### Step 4: Public Blockchain Anchoring

A cryptographic commitment may be generated, for example using the following pseudo-code, where H( ) is a hash function and Private_Transaction ID is a transaction ID, which is an identifier of the transaction on the private blockchain that recorded the checkpoint and trust token state change:

$$Public\_Anchor = H ( token\_Hash ‖ Checkpoint\_Hash ‖ Private\_Transaction \_ID )$$

This Public_Anchor is written to a public blockchain transaction along with optional non-sensitive metadata:

$$Scope\_Reference \_ID = R - 17$$

Authority reference identifier
Revocation pointer (if applicable)

No artifact content or sensitive evidence is disclosed publicly. A third party may verify:
the regulator's signature on the checkpoint,
the Trust NFT's signature, or
recomputed hash equality with the Public_Anchor.

### Example B: Milestone-Level Certification (Subset of Example A)

A milestone M3 requires satisfaction of requirements R-01 through R-25. Each requirement produces a DTC and optional Trust NFT as described in Example A.

### Step 1: Milestone Checkpoint Formation

Upon completion, a milestone checkpoint payload is constructed including:
Scope_Type=milestone.
Scope_Reference_ID=M3.
Referenced_Checkpoint_Hash_List={C_R01, C_R02, . . . , C_R25}
Thread ID
Timestamp
Authority_ID

A deterministic milestone checkpoint hash may then be computed and signed by the regulatory authority.

### Step 2: Trust NFT Issuance and Private Chain Execution

A milestone-level Trust NFT is issued referencing the milestone Checkpoint_Hash.

A private blockchain transaction records:
Milestone M3 status=Approved
Payment release (if staked on milestone completion)
Workflow reuse permission activation
License or ownership transitions (if applicable)

The private chain may then record finality under consensus.

In a milestone-level certification scenario (e.g., milestone M3), where completion of the milestone is staked on payment, the Trust NFT's optional economic state reference field may indicate the monetary value associated with the digital product transaction—for example, the escrowed payment amount to be released upon milestone approval, or a representative monetary value benchmark for the milestone activity. Upon issuance of the milestone-level Trust NFT, the private blockchain records the milestone status as approved and triggers a payment release, where the smart contract automatically releases the escrowed funds when the certification conditions are verified on-chain. In this scenario, the economic state reference within the Trust NFT serves as a cryptographically bound record of the transaction value, linking the certified digital thread state to the corresponding financial obligation and enabling automated escrow settlement without requiring separate payment verification.

More generally, in embodiments where the DTC is associated with a digital product transaction (e.g., a store model, request-based, escrow-based, or bidding-based transaction), the economic state reference within the NFT may indicate a monetary value associated with the transaction, such as an escrowed payment amount. Upon issuance of the NFT, a smart contract may automatically trigger the release of escrowed funds or execute a payment settlement based on the certified state represented by the DTC.

### Step 3: Public Blockchain Anchoring

A public commitment is computed, for example using the following pseudo-code, where H( ) is a hash function, MerkleRoot( ) is a Merkle Root function:

$$Public\_Anchor = H ( Milestone\_token \_Hash ‖ Milestone\_Checkpoint \_Hash ‖ MerkleRoot ( Referenced\_Checkpoint \_Hash \_List ) )$$

The Merkle Root function is a cryptographic function that recursively hashes pairs of data elements (in this case: referenced checkpoint hashes) in a tree structure until a single hash value—the Merkle Root—is produced, serving as a compact and tamper-evident summary of all the underlying data. The Merkle root allows proof of inclusion of individual requirement checkpoints without disclosing internal details. The public blockchain transaction may include:
Public Anchor
Milestone identifier (M3)
Authority identifier
Optional version or validity reference

External participants may verify milestone completion and reuse the credential in subsequent programs without accessing proprietary artifacts.

### Example C: Workflow Reuse Certification

A workflow template (e.g., Workflow WZ-9) is evaluated as a certification methodology.

### Step 1: Workflow Checkpoint Creation

A checkpoint payload is created including:
Scope_Type=workflow

$$Scope\_Reference \_ID = WZ - 9$$

Checkpoint artifacts (e.g. artifact snapshots, validation logs)·
Timestamp
Authority_ID

A workflow checkpoint hash may then be computed based on the checkpoint payload, and cryptographically signed.

### Step 2: Trust NFT Issuance and Private Chain State Transition

A Trust NFT referencing the workflow checkpoint hash (Checkpoint_Hash) may be issued. A private blockchain transaction may record:
Workflow WZ-9=Approved for reuse
Permission grants to defined user classes
Optional licensing state transitions

### Step 3: Public Anchoring

A public anchor commitment is written, for example using the following pseudo-code, where H( ) is a hash function:

$$Public\_Anchor = H ( token\_Hash ‖ Checkpoint\_Hash )$$

The public transaction may include:
Workflow identifier WZ-9
Authority reference
Revocation pointer

Third parties may verify regulatory acceptance of the workflow without access to internal validation artifacts.

### Private Blockchain and Public Blockchain Interaction

In certain embodiments, the system may employ a dual-ledger architecture comprising a private blockchain for authoritative execution and a public blockchain for attestation.

### Private Blockchain (Execution Ledger)

The private blockchain may record:
DTC hashes
Trust NFT hashes
Certification state transitions
Ownership or permission changes
Escrow or payment releases
Validator attestations

Sensitive artifact lineage identifiers and snapshot references remain accessible only within the IDMP or controlled storage layers.

The private blockchain may function as an enforcement state machine. Consensus mechanisms such as Proof-of-Authority, delegated Byzantine Fault Tolerance, or consortium-based validation, may be used.

### Public Blockchain (Attestation Layer)

The public blockchain may store cryptographic commitments derived from:
Trust NFT hashes
Checkpoint hashes
Merkle roots over referenced checkpoints
Private chain transaction identifiers
Revocation or supersession references

In these embodiments, no proprietary model content, evidence snapshots, or internal lineage identifiers are written to the public ledger.

The public ledger may provide:
Timestamped immutability
Independent verifiability
Credential portability
Tamper detection
Ecosystem-level discoverability of certified requirements, milestones, and workflows

In all examples listed above, a relying party may recompute checkpoint and Trust NFT hashes from disclosed data and confirm equality with the public anchor without requiring access to restricted artifacts.

### From Boundary Event to Blockchain Record

FIG. 13 shows various exemplary stages and data structures that are relevant to the disclosed digital transaction architecture, from the occurrence of a boundary event in a digital product transaction to its recording on public and/or private blockchains, in accordance with some embodiments of the present invention. Specifically, FIG. 13 illustrates an exemplary implementation of a digital thread checkpoint (DTC) and trust NFT within a digital model platform, showing the relationship between boundary events, digital thread checkpoints, trust NFTs, and blockchain integration, in accordance with some embodiments of the present invention.

Examples of boundary events include a digitally signed approval event by an authorized decision-maker such as a regulatory authority or delegated certifying entity, completion of a predefined validation workflow, satisfaction of predefined computational or compliance criteria, execution of a programmable smart contract condition, generation of a printed or instantiated version of a live digital object, or a user-defined invocation of a checkpoint operation.

At a given boundary event 1302 associated with a digital product transaction, various parameters representing the state of a digital thread 1304 associated with a digital product (e.g., artifact lineage states, model configurations and twin configurations, and validation workflows and computational outputs) may need to be recorded to create a so-called “snapshot” of the digital thread (similar to snapshot 1222 in FIG. 12). A DTC 1310, representing the snapshot of the digital thread at the boundary event, may thus be generated.

The DTC's payload 1310 may include several data fields such as a thread identifier 1312, a checkpoint identifier 1314, a scope type 1316, a scope reference identifier 1318, a DTC timestamp 1320, and an authority identifier 1322. The thread identifier 1312 uniquely identifies the digital thread being checkpointed. The checkpoint identifier 1314 uniquely identifies the specific checkpoint within the digital thread's lifecycle. The scope type 1316 defines the level of certification (e.g., requirement-level, milestone-level, artifact-level, workflow-level, etc.). The scope reference identifier 1318 identifies the specific item being certified within the scope (e.g., a particular requirement, milestone, workflow, etc.). The DTC timestamp 1320 records the time at which the checkpoint was created. Finally, the authority identifier 1322 identifies the authorized decision-maker (e.g., a regulatory authority or delegated certifying entity) signing the checkpoint. A non-repudiable canonical checkpoint (not shown in FIG. 13) may also be generated by computing a deterministic checkpoint hash over the DTC payload and digitally signing the checkpoint hash by the authorized decision-maker.

The DTC architecture shown in FIG. 13 builds upon the system snapshot and document-rendering architecture shown in FIG. 12, where snapshots provide immutable point-in-time captures of system configurations. At the time of checkpoint creation, the IDMP may perform a snapshot operation that pins relevant state elements of the digital thread. The snapshot operation prevents subsequent modification of referenced artifacts or evidence from altering the certified state represented by the checkpoint. Although live digital objects may continue to update dynamically after checkpoint creation, the DTC refers to the frozen snapshot state existing at the boundary event.

In various embodiments, the snapshot architecture illustrated in FIG. 12 may be used to generate a deterministic state of the digital thread suitable for checkpoint formation. In particular, a snapshot such as 1222 binds each tracked file 1212 within configuration 1206 to a corresponding snapshot item 1224 containing a specific file revision identifier. Because the snapshot establishes a deterministic resolution of all tracked files within the configuration-scoped set 1210, the snapshot represents a verifiable point-in-time state of the system 1202. When a certification, approval, or validation decision is made with respect to artifacts referenced within the digital thread, identifiers associated with the snapshot 1222 and/or snapshot items 1224 may be incorporated into a Digital Thread Checkpoint (DTC) payload, thereby capturing the artifact states associated with the decision boundary.

In certain embodiments, a rendered document such as 1236 generated from a document revision 1232 and a selected snapshot 1222 may represent a resolved state of the digital thread suitable for checkpointing. During rendering, tracked file links 1238 within the document revision are resolved against snapshot item links 1240 referencing snapshot items 1224, thereby binding each referenced artifact to the file revision identifier recorded in the snapshot. When the resulting resolved state is incorporated into a checkpoint payload and cryptographically signed by an authorized entity, the signed payload constitutes a (canonical) Digital Thread Checkpoint (DTC). In such embodiments, the rendered document 1236 may serve as a human-readable representation of the digital thread state associated with the checkpoint, while the underlying snapshot 1222 and associated snapshot items 1224 provide the machine-verifiable record of the artifact states referenced by the DTC.

A Trust Token (which in certain embodiments may be implemented as an NFT) 1330 serving as a portable credential that enables attestation and independent verification of the boundary event may then be issued from the DTC 1310. The trust NFT 1330 may include a token identifier 1332, a DTC hash 1334 (i.e., a referenced checkpoint hash derived from the DTC payload), a scope type 1336, a scope reference identifier 1338, a certification status 1340, an NFT timestamp 1342, and an issuer ID 1344. The token identifier 1332 uniquely identifies the Trust NFT. The DTC hash 1334 is the referenced checkpoint hash cryptographically linking the Trust NFT to its associated DTC. The scope type 1336 defines the level of certification. The scope reference identifier 1338 identifies the specific item being certified within the scope. The certification status 1340 indicates the certification outcome (e.g., pending, approved, rejected, current, in progress, expired, etc.). The NFT timestamp 1342 records the time at which the Trust NFT was issued. The issuer ID 1344 identifies the entity that issued the Trust NFT.

The DTC 1310 and trust NFT 1330 may be used to generate a public anchor 1350 associated with the boundary event. The public anchor 1350 may include a cryptographic commitment 1352 that is based at least on hashes of the DTC 1310 and the trust NFT 1330. In certain embodiments, the cryptographic commitment 1352 may be computed by applying a cryptographic hash function to a payload comprising the checkpoint hash derived from the DTC 1310 and a token hash derived from the trust NFT 1330, thereby cryptographically binding the public anchor to both the certified digital thread state and the associated trust token credential.

In embodiments where the DTC references multiple previously generated checkpoints (e.g., a milestone-level checkpoint referencing multiple requirement-level checkpoints), the cryptographic commitment 1352 may further comprise a Merkle root computed over the referenced checkpoint hashes, enabling proof of inclusion of individual checkpoints without disclosing internal details.

The exemplary configuration of FIG. 13 shows integration with both a private blockchain 1360 and a public blockchain 1362, where the DTC 1310 and trust NFT 1330 are recorded on the private blockchain 1360, while the public anchor 1350 is anchored to the public blockchain 1362. As discussed above, this dual-ledger approach enables authoritative execution on the private blockchain while providing attestation and independent verification capabilities through the public blockchain without exposing sensitive artifact data.

In certain embodiments, the trust NFT 1330 may also be minted or recorded on the public blockchain 1362 to represent a portable certification credential associated with the Digital Thread Checkpoint (DTC) 1310. For example, a trust NFT may represent certification of a component design or engineering artifact verified through IDMP validation workflows. The NFT may include a reference to the DTC hash and minimal non-sensitive metadata, such as a component identifier, certification status, issuing authority identifier, and timestamp. This publicly minted NFT enables downstream supply chain participants, system integrators, or regulatory bodies to independently verify certification without requiring access to proprietary artifact data, simulation models, or validation evidence maintained within the IDMP environment.

In other embodiments, the publicly recorded trust NFT may represent certification of a digital twin configuration or an approved engineering workflow. For example, a regulatory authority may approve a validation workflow or digital twin configuration for reuse across multiple programs, and a trust NFT referencing the corresponding DTC may be recorded on the public blockchain to serve as a reusable certification credential. The Trust NFT may include identifiers for the certified workflow or twin configuration, the associated checkpoint hash, and optional lifecycle metadata such as validity windows, revocation references, or supersession pointers. In this manner, the public trust NFT provides a verifiable credential discoverable by external systems while detailed artifact lineage, validation results, and evidence snapshots remain securely maintained within the IDMP and recorded on the private blockchain 1360.

FIG. 14 shows an exemplary flow chart for enabling digital transactions over an Integrated Digital Model Platform (IDMP), in accordance with some embodiments of the present invention.

At step 1410, a request for a digital thread checkpoint (DTC) is received, where the DTC describes a current state of a target digital thread, where the target digital thread is operated by a user and references at least one digital artifact, and where the target digital thread is an IDMP orchestration script operating on the at least one digital artifact and associated with a digital product.

At step 1420, the DTC associated with the target digital thread is generated, where the DTC includes a checkpoint payload comprising a thread identifier, a checkpoint identifier, a scope type, a scope reference identifier, a DTC timestamp, and an authority identifier of an authorized decision-maker, and where the scope type defines a category of certification that the DTC represents.

At step 1430, a referenced checkpoint hash is generated by hashing the checkpoint payload.

At step 1440, a non-fungible token (NFT) representing a certified state of the target digital thread at the DTC is generated, where the NFT includes a token identifier, the referenced checkpoint hash, the scope type, the scope reference identifier, a certification status, an NFT timestamp, and an issuer identifier.

At step 1450, the NFT is recorded on a blockchain and assigned to the user.

### Interconnected Digital Engineering and Certification Ecosystem

FIG. 15 shows an exemplary implementation of the IDEP as an interconnected digital engineering (DE) and certification ecosystem 1500, and exemplary digitally certified products, in accordance with some embodiments of the present invention. Interconnected DE and certification ecosystem 1500 may be viewed as a particular instantiation or implementation of IDEP 100 shown in FIG. 1. The IDEP may also be referred to as a “DE Metaverse.”

Interconnected DE and certification ecosystem 1500 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 1500 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 15 shows an example of an interconnected DE and certification ecosystem and examples of digitally certified products 1512A, 1512B, and 1512C (collectively referred to as digitally certified products 1512). For example, in some implementations, digitally certified product 1512A may be an unmanned aerial vehicle (UAV) or other aircraft, digitally certified product 1512B may be a drug or other chemical or biologic compound, and the digitally certified product 1512C may be a process such as a manufacturing process. In general, the digitally certified products 1512 can include any product, process, or solution that can be developed, tested, or certified (partially or entirely) using DE tools such as 1502. In some implementations, digitally certified products 1512 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 1512 in FIG. 15 may be designed and/or certified using interconnected DE and certification ecosystem 1500. Interconnected DE and certification ecosystem 1500 may include a user device 1506A, API 1506B, or other similar human-to-machine, or machine-to-machine communication interfaces operated by a user. A user may be a human 1504 of various skill levels, or artificial users such as algorithms, artificial intelligence, or other software that interface with ecosystem 1500 through API 1506B. Ecosystem 1500 may further comprise a computing and control system 1508 (“computing system 1508” hereinafter) connected to and/or including a data storage unit 1518, an artificial intelligence (AI) engine 1520, and an application and service layer 1522. In some embodiments, the artificial intelligence (AI) engine 1520 is a machine learning (ML) engine. References to “machine learning engine 1520” or “ML engine 1520” may be extended to artificial intelligence (AI) engine 1520 more generally. For the purposes of clarity, any user selected from various potential human or artificial users is referred to herein simply as the user 1504. In some implementations, computing system 1508 may be a centralized computing system; in some implementations, computing system 1508 may be a distributed computing system. In some cases, user 1504 may be considered part of ecosystem 1500, while in other implementations, user 1504 may be considered separately from ecosystem 1500. Ecosystem 1500 may include one or more DE tools 1502, such as data analysis tool 1502A, computer-aided design (CAD) and finite element analysis (FEA) tool 1502B, simulation tool 1502C, drug modeling and simulation (M&S) tools 1502D-1502E, manufacturing M&S tools 1502F-1502G, etc. Ecosystem 1500 may also include a repository of common V&V products 1510, such as regulatory standards 1510A-1510F related to the development and certification of a UAV, medical standard 1510G (e.g., CE marking (Europe), FCC Declaration of Conformity (USA), IECEE CB Scheme (Europe, North America, parts of Asia & Australia), CDSCO (India), FDA (USA), etc.), medical certification regulation 1510H (e.g., ISO 13485, ISO 14971, ISO 9001, ISO 62304, ISO 10993, ISO 15223, ISO 11135, ISO 11137, ISO 11607, IEC 60601, etc.), manufacturing standard 1510I (e.g., ISO 9001, ISO 9013, ISO 10204, EN 1090, ISO 14004, etc.), and manufacturing certification regulation 1510J (e.g., General Certification of Conformity (GCC), etc.), etc.

In FIG. 15, computing system 1508 is centrally disposed within the architecture and is configured to communicate with (e.g., receive data from and transmit data to) user device 1506A or API 1506B such as an API associated with an artificial user, DE tools 1502 via an API or software development kit (SDK) 1514, and repository of common V&V products 1510 via an API/SDK interface 1516. For example, computing system 1508 may be configured to communicate with user device 1506A and/or API 1506B to send or receive data corresponding to a prototype of a design, information about a user (e.g., user credentials), engineering-related inputs/outputs associated with DE tools 1502, digitized common V&V products, an evaluation of a product design, user instructions (e.g., search requests, data processing instructions, etc.), and more. Computing system 1508 may also be configured to communicate with one or more DE tools 1502 to send engineering-related inputs for executing analyses, models, simulations, tests, etc., and to receive engineering-related outputs associated with the results. Computing system 1508 may also be configured to communicate with repository of common V&V products 1510 to retrieve data corresponding to one or more digitized common V&V products 1510 and/or upload new common V&V products, such as those received from user 1504, to repository of common V&V products 1510. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 1508 may process and/or store the data that it receives to perform analysis and control functionalities, and in some implementations, may access machine learning engine 1520 and/or application and service layer 1522, to identify useful insights based on the data, as further described herein. The central disposition of computing system 1508 within the architecture of the ecosystem has many advantages including reducing the technical complexity of integrating the various DE tools; improving the product development experience of user 1504; intelligently connecting common V&V products such as standards 1510A-1510F to DE tools 1502 most useful for satisfying requirements associated with the common V&V products; and enabling the monitoring, storing, and analysis of the various data that flows between the elements of the ecosystem throughout the product development process. In some implementations, the data flowing through and potentially stored by the computing system 1508 can also be auditable to prevent a security breach, to perform data quality control, etc. Similarly, any analysis and control functions performed via computing system 1508 may be tracked for auditability and traceability considerations.

Referring to one particular example shown in FIG. 15, user 1504 may use the DE and certification ecosystem to produce a digitally certified UAV 1512B. For example, user 1504 may be primarily concerned with certifying the UAV as satisfying the requirements of a particular regulatory standard 1510E relating to failure conditions of the UAV (e.g., “MIL-HDBK 516C 4.1.4-Failure Conditions”). In this usage scenario, user 1504 may develop a digital prototype of the UAV on user device 1506A or using API 1506B and may transmit prototype data (e.g., as at least one of a CAD file, a MBSE file, etc.) to computing system 1508. Along with the prototype data, user 1504 can transmit, via user device 1506A, additional data including an indication of the common V&V product that user 1504 is interested in certifying the product for (e.g., regulatory standard 1510E), user credential information for accessing one or more capabilities of computing system 1508, and/or instructions for running one or more digital models, tests, and/or simulations using a subset of DE tools 1502.

Referring to another example shown in FIG. 15, user 1504 can use the DE and certification ecosystem to produce a digitally certified drug, chemical compound, or biologic 1512A. For example, user 1504 may be primarily concerned with certifying drug, chemical compound, or biologic 1512A as satisfying the requirements of a particular medical standard 1510G and medical certification regulation 1510H. In this usage scenario, user 1504 can develop a digital prototype of the drug, chemical compound, or biologic on user device 1506A or using API 1506B and can transmit the prototype data (e.g., as a molecular modeling file) to computing system 1508. Along with the prototype data, user 1504 can transmit, via user device 1506A, additional data including an indication of the common V&V products that user 1504 is interested in certifying the product for (e.g., medical standard 1510G and medical certification regulation 1510H), user credential information for accessing one or more capabilities of computing system 1508, and/or instructions for running one or more digital models, tests, and/or simulations using a subset of DE tools 1502 (e.g., drug M&S tools 1502D-1502E).

Referring to yet another example shown in FIG. 15, user 1504 can use the digital engineering and certification ecosystem to produce a digitally certified manufacturing process 1512C. For example, user 1504 may be primarily concerned with certifying manufacturing process 1512C as satisfying the requirements of a particular manufacturing standard 1510I and manufacturing certification regulation 1510J. In this usage scenario, user 1504 can develop a digital prototype of the manufacturing process on user device 1506A or using API 1506B and can transmit the prototype data to computing system 1508. Along with the prototype data, user 1504 can transmit, via the user device 1506A, additional data including an indication of the common V&V products that user 1504 is interested in certifying the process for (e.g., manufacturing standard 1510I and manufacturing certification regulation 1510J), user credential information for accessing one or more capabilities of computing system 1508, and/or instructions for running one or more digital models, tests, and/or simulations using a subset of DE tools 1502 (e.g., manufacturing M&S tools 1502F-1502G).

In any of the aforementioned examples, computing system 1508 can receive the data transmitted from user device 1506A and/or API 1506B and can process the data to evaluate whether the common V&V product of interest (e.g., regulatory standard 1510E, medical standard 1510G, medical certification regulation 1510H, manufacturing standard 1510I, manufacturing certification regulation 1510J, etc.) is satisfied by the user's digital prototype, in the context of analysis and control plane 150 shown in FIG. 1. For example, this can involve communicating with the repository of common V&V products 1510 via the API/SDK 1516 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 1510 can be hosted by a regulatory and/or certification authority (or another third party), and retrieving the regulatory and/or certification data can involve using API/SDK 1516 to interface with one or more data resources maintained by the regulatory and/or certification authority (or another third party). In some implementations, the regulatory and/or certification data can be provided directly by user 1504 via user device 1506A and/or API 1506B (e.g., along with the prototype data).

Evaluating whether the common V&V product of interest is satisfied by the user's digital prototype can also involve processing the prototype data received from user device 1506A or API 1506B to determine if the one or more identified requirements are actually satisfied. In some implementations, computing system 1508 can include one or more plugins, local applications, etc., to process the prototype data directly at the computing system 1508. For example, model splicing and digital threading applications are discussed in detail later with reference to FIGS. 19 to 22. In some implementations, the computing system can simply pre-process the received prototype data (e.g., to derive inputs for DE tools 1502) and can then transmit instructions and/or input data to a subset of DE tools 1502 via API/SDK 1514 for further processing.

Not all DE tools 1502 are necessarily required for the satisfaction of particular regulatory and/or certification standards. Therefore, in the UAV example provided in FIG. 15, computing system 1508 may determine that only a data analysis tool 1502A and a finite element analysis tool 1502B are required to satisfy regulatory standard 1510E for failure conditions. In the drug, chemical compound, or biologic example provided in FIG. 15, computing system 1508 may determine that only drug M&S tools 1502D-1502E are required to satisfy medical standard 1510G and medical certification regulation 1510H. In the manufacturing process example provided in FIG. 15, computing system 1508 may determine that only manufacturing M&S tools 1502F-1502G are required to satisfy manufacturing standard 1510I and manufacturing certification regulation 1510J. In other implementations, user 1504 may themselves identify the particular subset of DE tools 1502 that should be used to satisfy the common V&V product of interest, provided that user 1504 is a qualified subject matter expert (SME). In other implementations, user 1504 may input to computing system 1508 some suggested DE tools 1502 to satisfy a common V&V product of interest, and computing system 1508 can recommend to user 1504 a modified subset of DE tools 1502 for final approval by user 1504, provided that user 1504 is a qualified SME. After a subset of DE tools 1502 has been identified, computing system 1508 can then transmit instructions and/or input data to the identified subset of DE tools 1502 to run one or more models, tests, and/or simulations. The results (or “engineering-related data outputs” or “digital artifacts”) of these models, tests, and/or simulations can be transmitted back and received at computing system 1508.

In still other implementations, user 1504 may input a required DE tool such as 1502F for meeting a common V&V product 1510I, and the computing system 1508 can determine that another DE tool such as 102G is also required to satisfy common V&V product 1510I. The computing system can then transmit instructions and/or input data to both DE tools (e.g., 1502F and 1502G), and the outputs of these DE tools can be transmitted and received at computing system 1508. In some cases, the input data submitted to one of the DE tools (e.g., 1502G) can be derived (e.g., by computing system 1508) from the output of another of the DE tools (e.g., 1502F).

After receiving engineering-related data outputs or digital artifacts from DE tools 1502, computing system 1508 can then process the received engineering-related data outputs to evaluate whether or not the requirements identified in the common V&V product of interest (e.g., regulatory standard 1510E, medical standard 15110G, medical certification regulation 1510H, manufacturing standard 1510I, manufacturing certification regulation 1510J, etc.) are satisfied. For example, applications and services 1522 may provide instructions for orchestrating validation or verification activities. In some implementations, computing system 1508 can generate a report summarizing the results of the evaluation and can transmit the report to device 1506A or API 1506B for review by user 1504. If all of the requirements are satisfied, then the prototype can be certified, resulting in digitally certified product 1512 (e.g., digitally certified drug, chemical compound, or biologic 1512A; digitally certified UAV 1512B; digitally certified manufacturing process 1512C, etc.). However, if some of the regulatory requirements are not satisfied, then additional steps may need to be taken by user 1504 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 1502, computing systems 1508 may provide user 1504 with a report recommending partial certification, compliance, or fulfillment of a subset of the common V&V products (e.g., digital certification of a subsystem or a sub-process of the prototype). The process of generating recommendations for user 1504 is described in further detail below.

In response to reviewing the report, user 1504 can make design changes to the digital prototype locally and/or can send one or more instructions to computing system 1508 via user device 1506A or API 1506B. These instructions can include, for example, instructions for computing system 1508 to re-evaluate an updated prototype design, use one or more different DE tools 1502 for the evaluation process, and/or modify the inputs to DE tools 1502. Computing system 1508 can, in turn, receive the user instructions, perform one or more additional data manipulations in accordance with these instructions, and provide user 1504 with an updated report. Through this iterative process, user 1504 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 1502, computing system 1508 may provide user 1504 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 1508 within the architecture of the ecosystem enables computing system 1508 to monitor and store the various data flows through the ecosystem. Thus, as an increasing number of users utilize the ecosystem for digital product development, data associated with each use of the ecosystem can be stored (e.g., in storage 1518), traced (e.g., with metadata), and analyzed to yield various insights, which can be used to further automate the digital product development process and to make the digital product development process easier to navigate for non-subject matter experts.

Indeed, in some implementations, user credentials for user 1504 can be indicative of the skill level of user 1504, and can control the amount of automated assistance the user is provided. For example, non-subject matter experts may only be allowed to utilize the ecosystem to browse pre-made designs and/or solutions, to use DE tools 1502 with certain default parameters, and/or to follow a predetermined workflow with automated assistance directing user 1504 through the product development process. Meanwhile, more skilled users may still be provided with automated assistance, but may be provided with more opportunities to override default or suggested workflows and settings.

In some implementations, computing system 1508 can host applications and services 1522 that automate or partially automate components of common V&V products; expected or common data transmissions, including components of data transmissions, from user 1504; expected or common interfaces and/or data exchanges, including components of interfaces, between various DE tools 1502; expected or common interfaces and/or data exchanges, including components of interfaces, with machine learning (ML) models implemented on computing system 1508 (e.g., models trained and/or implemented by the ML engine 1520); and expected or common interfaces and/or data exchanges between the applications and services themselves (e.g., within applications and services layer 1522).

In some implementations, the data from multiple uses of the ecosystem (or a portion of said data) can be aggregated to develop a training dataset. For example, usage records 1517 collected via computing system 1508 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 1502 that should be used to satisfy a common V&V product of interest.

This training dataset can then be used to train ML models (e.g., using ML engine 1520) to learn the steps and actions for certification processes and to perform a variety of tasks including the identification of which of DE tools 1502 to use to satisfy a particular common V&V product; the identification of specific models, tests, and/or simulations (including inputs to them) that should be performed using DE tools 1502; the identification of the common V&V products that need to be considered for a product of a particular type; the identification of one or more recommended actions for user 1504 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 1502) based on previously entered inputs, forecasting time and cost requirements for developing a product, predictively estimating the results of sensitivity analyses, and even suggesting design changes, original designs or design alternatives (e.g., via assistive or generative AI) to a user's prototype to overcome one or more requirements (e.g., regulatory and/or certification requirements) associated with a common V&V product. In some implementations, with enough training data, ML engine 1520 may generate new designs, models, simulations, tests, common V&V products and/or digital threads on its own based on data collected from multiple uses of the ecosystem. Furthermore, such new designs, models, simulations, tests, common V&V products and digital threads generated by ML engine 1520, once approved and adjusted by a user, may be added to the training set for further fine-tuning of ML algorithms in a reinforcement learning setup.

As shall be discussed in the context of FIGS. 20 to 22, the aforementioned collection of training datasets and the training of ML and AI modules including ML engine 1520 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 15, ML engine 1520 may manage or orchestrate the interactions between spliced DE models, DE tools, and common V&V products (e.g., DE requirements), based on digital thread options specific to user's intent and input. Sample DE tasks that may be carried out by ML engine 1520 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 1520 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 1518) to enable users to search for and build upon the work of others. For example, previously designed components, systems, models, simulations and/or other engineering representations thereof can be searched for by user 1504 and/or suggested to user 1504 by computing system 1508 in order to satisfy one or more requirements associated with a common V&V product. The previously designed components, systems, models, simulations and/or other engineering representations thereof can be utilized by user 1504 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 1504 can be checked by computing system 1508 to determine which designs and/or solutions stored in the repository can be accessed by user 1504. In some implementations, usage of the previously designed components, systems, models, simulations and/or other engineering representations thereof may be available only to other users who pay a fee for a usage.

### Exemplary IDEP Implementation Architecture with Services and Features

FIG. 16 shows another exemplary implementation of the IDEP illustrating its offered services and features, in accordance with some embodiments of the present invention. Specifically, an exemplary implementation architecture diagram 1600 is shown in FIG. 16 to include multiple illustrative components: an IDEP enclave 1602, cloud services 1604, and a customer environment 1610 which optionally includes an IDEP exclave 1616. This exemplary architecture 1600 for the IDEP is designed in accordance with zero-trust security principles and is further designed to support scalability as well as robust and resilient operations. IDEP enclave 1602 and IDEP exclave 1616 together instantiate IDEP 100 shown in FIG. 1, with IDEP exclave 1616 implementing model splicing and splice plane 170 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 1602 may serve as a starting point for services rendered by the IDEP, and may be visualized as a central command and control hub responsible for the management and orchestration of all platform operations. For example, enclave 1602 may be implemented using computer system 208 of the interconnected DE and certification ecosystem shown in FIG. 15. DE platform enclave 1602 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 1602 also supports an ML engine such as 1520 for real-time analytics, auto-scaling features for workload adaptability, and API-based interoperability with third-party services. Security and resource optimization are enhanced through multi-tenancy support, role-based access control, and data encryption both at rest and in transit. DE platform enclave 1602 may also include one or more of the features described below.

First, IDEP enclave 1602 may be designed in accordance with zero-trust security principles. In particular, DE platform enclave 1602 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 1602 can also be designed to maintain isolation and independence. A key aspect of the enclave's architecture is its focus on impartiality and isolation. DE enclave 1602 disallows cryptographic dependencies from external enclaves and enforces strong isolation policies. The enclave's design also allows for both single-tenant and multi-tenant configurations, further strengthening data and process isolation between customers 1606 (e.g., users 204). Additionally, DE enclave 1602 is designed with decoupled resource sets, minimizing interdependencies and thereby promoting system efficiency and autonomy.

IDEP enclave 1602 can further be designed for scalability and adaptability, aligning well with varying operational requirements. For example, the enclave 1602 can incorporate hyperscale-like properties in conjunction with zero-trust principles to enable scalable growth and to handle high-performance workloads effectively.

IDEP enclave 1602 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 1600's adaptability makes it highly versatile for a multitude of use-cases, while ensuring consistent performance and robust security.

IDEP enclave 1602 can further be designed to enable analytics for robust platform operations. At the core of the enclave's operational efficiency is a machine learning engine (e.g., machine learning engine 220) capable of performing real-time analytics. This enhances decision-making and operational efficiency across platform 1600. Auto-scaling mechanisms can also be included to enable dynamic resource allocation based on workload demand, further adding to the platform's responsiveness and efficiency.

In the exemplary embodiment shown in FIG. 16, IDEP enclave 1602 includes several components as described in further detail herein.

A “Monitoring Service Cell” may provide “Monitoring Service” and “Telemetry Service.” A cell may refer to a set of microservices, for example, a set of microservices executing within a kubernetes pod. These components focus on maintaining, tracking and analyzing the performance of platform 1600 to ensure good service delivery, including advanced machine learning capabilities for real-time analytics. A “Search Service Cell” provides “Search Service” to aid in the efficient retrieval of information from DE platform 1600, adding to its overall functionality. A “Logging Service Cell” and a “Control Plane Service Cell” provide “Logging Service,” “File Service”, and “Job Service” to record and manage operational events and information flow within platform 1600, and are instrumental in the functioning of platform 1600. A “Static Assets Service Cell,” provides “Statics Service”, and may house user interface, SDKs, command line interface (CLI), and documentation for platform 1600. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 1616 to provide splice functions for model splicing purposes.

As shown in FIG. 16, the architecture of DE platform 1600 may also include a cloud services 1604 that provide services which cannot interact with customer data but can modify the software for the orchestration of DE platform operations. In example implementations, several cloud resources provide support and foundational services to the platform. For example, in the embodiment of the DE platform 1600 shown in FIG. 16, cloud services 1604 includes a “Customer Identity and Access Management (IAM) Service” that ensures secure and controlled access to platform 1600. Cloud services 1604 also includes a “Test Service” that tests tools to validate platform operations. In the context of software testing, the Test Service can be thought of as the execution layer that manages and orchestrates the different types of tests on the platform. The Test Service may utilize the test scripts generated, and additionally has functionality to generate tests for specific UI or API level testing. Cloud services 1604 may also include an “Orchestration Service” that controls and manages the lifecycle of containers on the platform 1600. Cloud services 1604 may also include an “Artifact Service” and “Version Control and Build Services,” which may be used to maintain the evolution of projects, codes, and instances in the system, while also managing artifacts produced during the product development process.

As shown in FIG. 16, the architecture of DE platform 1600 may also include a customer environment 1610 with an “Authoritative Source of Truth” 1612, customer tools 1614, and an optional DE platform exclave 1616. Customer environment 1610 is where customer data resides and is processed in a zero-trust manner by DE platform 1600. As described previously, DE platform enclave 1602, by focusing on both zero-trust principles and hyperscale-like properties, provides a robust and scalable environment for the secure processing of significant workloads, according to the customer's unique needs. In some examples, DE platform exclave 1616 may be situated within customer environment 1610 in order to assist the customer(s) 1606 with their DE tasks and operations, including model splicing and digital threading.

When a customer 1606 (e.g., user 1504) intends to perform a DE task using DE platform 1600 (e.g., IDEP 100), typical operations may include secure data ingestion and controlled data retrieval. Derivative data generated through the DE operations, such as updated digital model files or revisions to digital model parameters, may be stored only within customer environment 1610, and DE platform 1600 may provide tools to access the metadata of the derivative data. Here metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 1610 through a pre-validated secure tunnel, such as Secure Socket Layer (SSL) tunnel. This can enable direct and secure file transfer to a designated cloud storage, such as a simple storage service (S3) bucket, within customer environment 1610. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 1610 while adhering to zero-trust security protocols. Example implementations may also include tokenization utility, in which a specialized DE platform tool referred to as a “tokenizer” is deployed within customer environment 1610 for secure management of derivative metadata, conforming to zero-trust guidelines.

Customer environment 1610 may interact with other elements of secure DE platform 1600 and includes multiple features that handle data storage and secure interactions with platform 1600. For example, one element of the customer environment 1610 is “Authoritative Source of Truth” 1612, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 1610 while providing smooth interactions with other elements of DE platform 1600.

Customer environment 1610 may also include additional software tools such as customer tools 1614 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 1610 and elements of DE platform 1600. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 1610, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 1616 may be employed within customer environment 1610 to assist with customer DE tasks and operations, supervise data processing, and rigorously adhering to zero-trust principles while delivering hyperscale-like platform performance. IDEP exclave 1616 is maintained by the IDEP to run DE tools for customers who need such services. IDEP exclave 1616 may contain a “DE Tool Host” that runs DE tools and a “DE Platform Agent” necessary for the operation. Again, native DE tools are typically access-restricted by proprietary licenses and end-user license agreements paid for by the customer. IDEP exclave 1616 utilities and manages proprietary DE tools hosted with customer environment 1610, for example, to implement model splicing and digital threading functionalities.

In some embodiments, the machine learning (ML) models and artificial intelligence (AI) assistance approaches as described herein adapt to suit different customer instances of the IDEP (see FIG. 17) and the availability of training data. In an example, a pre-trained ML or AI model (e.g., within the IDEP enclave 1602) is deployed in instances where there are restrictions around sharing customer data. In another example, AI models are deployed in a federated manner adjacent to DE agents and DE tools in the customer environment (e.g., within IDEP exclave 1616). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 17 shows potential scenarios for instantiating an IDEP in connection to a customer's physical system and IT environment, in accordance with some embodiments of the present invention. Specifically, FIG. 17 illustrates various potential configurations for instancing or instantiating an IDEP (“DE platform”) 1702 in connection to a customer's IT environment and physical system 1704. The IT environment may be located on a virtual private cloud (VPC) protected by a firewall. The physical system may refer to a physical twin as discussed with reference to FIG. 1. In some embodiments, IDEP 1702 may be instantiated as an enclave such as 1602 shown in FIG. 16. For example, IDEP 1702 may be instanced on the cloud, possibly in a software-as-a-service (SaaS) configuration. The platform instances in these embodiments include software and algorithms, and may be described as follows:
1. External Platform Instance 1710: This option showcases the IDEP as a separate platform instance. The platform interacts with the physical system through the customer's virtual environment, or a Customer Virtual Private Cloud (“Customer VPC”), which is connected to the physical system.
2. External Platform Instance with Internal Agent_1720: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 1730: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 1740: This option shows the DE platform linked directly to an DE edge instance on the physical system. The DE platform and the physical system are depicted separately, connected by an edge computing instance in the middle, indicating the flow of data.
5. Direct API Connection 1750: This deployment scenario shows the DE platform connecting directly to the physical system via API calls. In this depiction, an arrow extends directly from the platform sphere to the physical system sphere, signifying a direct interaction through API.
6. Air-Gapped Platform Instance 1760: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

FIG. 18 illustrates the use of multimodal user interfaces 1890 for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 1802 and 1804 are processed in the Analysis & Control Plane (ACP) 150 of FIG. 1. The user interface may receive data streams from physical and virtual feedback loops 102 and 104, as well as external expert feedback 114, analysis module 154, and twin configuration set 156 of ACP 150.

The multimodal interfaces illustrated in FIG. 18 are configured to carry out all the DE tasks and actions described in the context of FIG. 1, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 1894, a workflow-based interface 1896, conversational interfaces 1898, spatial computer interfaces 1892, and code interfaces 1899.

Dashboard-style interface 1894 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 1896 guides users through the decision-making process, presenting relevant data, options, and contextual information at each stage. It integrates external feedback and is designed as a progressive web app or a mobile app. In the context of alternative tool selection, workflow-based interface 1896 may provide options on individual tools at each stage, or provide combinations of tool selections through various stages to achieve better accuracy or efficiency for the overall workflow.

Conversational interfaces 1898 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

According to the latest prior art, a “conversational interface” or “conversational user interface” refers to a human-computer interaction model that enables users to interact with digital systems through natural language, either via text or voice. These interfaces utilize advanced natural language processing (NLP), machine learning, and artificial intelligence technologies to understand and respond to user inputs in a manner that mimics human conversation. Conversational interfaces can take various forms, including chatbots, voice assistants, and messaging platforms, allowing users to communicate with systems using everyday language rather than traditional graphical user interface elements. The goal of these interfaces is to provide a more intuitive, accessible, and personalized user experience by leveraging the familiar paradigm of conversation, enabling users to accomplish tasks, retrieve information, or control devices through natural dialogue without requiring specialized knowledge of complex commands or navigation structures.

FIG. 18 also illustrates the use of spatial computing interfaces 1892 and code interfaces 1899 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

A “spatial interface” or “spatial user interface” refers to a user interaction paradigm that leverages three-dimensional space and spatial relationships to present and manipulate digital information. This approach goes beyond traditional 2D graphical user interfaces by incorporating depth, volume, and spatial positioning to create more intuitive and immersive user experiences. Spatial interfaces often utilize technologies such as augmented reality (AR), virtual reality (VR), or mixed reality (MR) to overlay digital content onto the physical world or create entirely virtual environments. These interfaces allow users to interact with digital objects and information as if they were physical entities in space, using natural gestures, body movements, direction of audio or eye gaze, and spatial awareness to navigate, manipulate, and organize content in ways that more closely mimic real-world interactions.

Note that in the context of multimodal interfaces, “2.5 dimension” (often referred to as 2.5D) describes a visual representation that falls between traditional 2D and full 3D interfaces. It typically involves adding depth and perspective to 2D elements to create a pseudo-3D effect, without fully rendering a complete 3D environment. The 2.5D approach is typically designed to create the illusion of depth and dimensionality on flat, two-dimensional displays such as computer monitors, smartphone screens, or tablets, although it may be used within a 3D setting (e.g., 2D screens overlaid into 3D). This approach often uses techniques such as layering, parallax scrolling, or isometric projections to give the illusion of depth and volume while maintaining the simplicity and familiarity of 2D interfaces.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 19 describes the architecture and inherent complexity of digital threads, in accordance with the examples disclosed herein. Specifically, FIG. 19 is a schematic diagram comparing exemplary digital threads 1900 of various complexities that manipulate and/or connect DE models, in accordance with some embodiments of the present invention. In the most basic sense, a digital thread may “thread” together DE models into a simple daisy-chain architecture 1902 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 1904 represents a more complex digital thread where a change in one DE model may affect more than one downstream model. In both 1902 and 1904, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 1904, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 1906 is a partial representation of a real-world digital thread, illustrating the complexity of digital threads and its multiplicative growth.

FIG. 19 further shows special cases 1903, 1905, 1907, 1908, and 1909 of exemplary simple digital threads. Diagram 1907 represents a degenerate digital thread where data is shared from a single DE model. Diagram 1908 represents a model-to-document digital thread where data (e.g., system attributes, performance attributes) extracted from a single DE model may be used to generate or update a text-based document (e.g., a Capability Development Document (CDD)). Diagrams 1903 and 1905 are generalized from 1908 to represent cases where data extracted from a single model may be used to update multiple models, or vice versa. Specifically, diagram 1905 may represent the dynamic updates of live or magic documents discussed in the context of FIG. 1. Here, the logic to connect the DE models shown is clear: data are extracted from multiple DE models A, B, and C to update a document model D. There are no interactions between the extracted data. Furthermore, diagram 1909 shows a special case of a digital thread where data is loaded to and extracted from only a single model A. For example, as discussed in the context of FIG. 20 next, input splice functions of the model A shown in 1909 may be executed to update the model, and output splice functions of model A shown in 1909 may be executed to produce digital artifacts for sharing. For these special simple threads, the IDEP may provide a GUI-based interface to the user to connect the models and execute the digital threads. For complex threads such as 1906, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 1. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 20 is a schematic 2000 showing an exemplary model splicing setup, according to some embodiments of the present invention. Specifically, FIG. 20 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable files that can be read without specialized software, as well as machine-readable documents that can be viewed and manipulated by a human with the help of specialized software such as word processor and/or web services. Thus, a document may contain natural language-based text and/or graphics that are directly readable by a human without the need of additional machine compilation, rendering, visualization, or interpretation. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 20, a CAD model file diesel-engine .prt 2004 proceeds through a model splicing process 2010 that comprises a data extraction step 2020 and a splice function generation step 2030. This input DE model 2004 is in a file format .prt native to certain DE tools. Data extraction may be performed via a DE model crawling agent implemented as model crawling scripts within a model splicer to crawl through the input DE model file and to distill model data with metadata 2022. Metadata are data that can be viewed without opening the entire input DE model file, and may include entries such as file name, file size, file version, last modified date and time, and potential user input options as identified from a user input 2006. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 2002 that is being used in splicing the DE model, and establishes a model data schema. This data schema describes the structure and format of the model data, some of which are translated into, or used to create input/output API endpoints with corresponding input/output schemas. In some embodiments, model data with metadata 2022 may be stored in an access-restricted storage 2026, such as the “customer buckets” 1612 within customer environment 1610 in FIG. 16, so that model splices such as 2042, 2044, and 2046 may be generated on-demand once an input DE model 2004 has been crawled through.

The model splicer further generates splice functions (e.g., API function scripts) 2032 from native APIs 2002 associated with the input CAD model. In the present disclosure, “native” and “primal” refer to existing DE model files, functions, and API libraries associated with specific third-party DE tools, including both proprietary and open-source ones. Native API 2002 may be provided by a proprietary or open-source DE tool. For example, the model splicer may generate API function scripts that call upon native APIs of native DE tools to perform functions such as: HideParts (parts list), Generate 2DView( ) etc. These model-type-specific splice functions may be stored in a splice function database 2036, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 2002 of any native DE tool integrated into the IDEP, thus enabling engineers from different disciplines to interact with unfamiliar DE tools, and previously non-interoperable DE tools to interoperate freely.

Next, based on user input or desired user application 2006, one or more model splices or wrappers 2042, 2044, and 2046 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 2022 and the API function scripts such as 2032. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 2033 are model modification scripts that allow updates or modifications to an input DE model. For example, a model update may comprise changes made via an input splice function to model parameters or configurations. “Output” splice functions or “output nodes” 2034 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 2026, or other similar access-restricted customer buckets.

One advantage of model splicing is its inherent minimal privileged access control capabilities for zero-trust implementations of the IDEP as disclosed herein. In various deployment scenarios discussed with reference to FIG. 17, and within the context of IDEP implementation architecture discussed with reference to FIG. 16, original DE input model 2004 and model data storage 2026 may be located within customer buckets 1612 in customer environment 1610 of FIG. 16. Splice functions 2032 stored in database 2036 call upon native APIs 2002. The execution or invocation of splice functions 2032 may rely on job-specific authentication or authorization via proprietary licenses of DE tools (e.g., residing within customer environment 1610 of FIG. 16 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models Via Model Splicing

FIG. 21 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 21, an orchestration script 2194 is written in Python code and designed to interact via API endpoints such as 2192 to determine if a CAD model meets a total mass requirement. API endpoint 2192 is an output splice function and part of a platform API 2190. Platform API 2190 comprises not only splice functions but also platform scripts or orchestration scripts such as 2194 itself.

Orchestration script 2194 is divided into three main steps:
1. Get Data From a CAD Model Splice: A POST request may be sent via the IDEP platform API to execute a computer-aided design (CAD) model splice 2171. This model splice provides a uniform interface to modify and retrieve information about a CAD model 2181. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 2181, and a Uniform Resource Identifier/Locator (URL) for the CAD model. The response may further comprise a URL for an image of the CAD model.
2. Get Data From a SysML Model Splice: Another POST request may be sent via the IDEP platform API to execute a Systems Modeling Language (SysML) model splice 2172. SysML is a general-purpose modeling language used for systems engineering. Output function 2192 of model splice 2172 retrieves the total mass requirements for the system from a SysML model 2182. The response from the platform API includes the total mass requirement for the system.
3. Align the Variables and Check If Requirement Met: The total mass from CAD model 2181 is compared with the total mass requirement from SysML model 2182. If the two values are equal, a message is printed indicating that the CAD model aligns with the requirement. Otherwise, a message is printed indicating that the CAD model does not align with the requirement.

In short, orchestration script 2194, which may be implemented in application plane 160 of IDEP 100 shown in FIG. 1, links digital models 2181 and 2182 via model splice API calls. Orchestration script 2194 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

FIG. 22 is a schematic illustrating the linking of DE model splices in a splice plane and comparing digital threading with and without model splicing, according to some embodiments of the present invention. The bottom model plane 180 demonstrates current digital threading practices, where each small oval represents a DE model, and the linking between any two DE models, such as models 2282 and 2284, requires respective connections to a central platform 2210, and potential additional linkages from every model to every other model. The central platform 2210 comprises program code that is able to interpret and manipulate original DE models of distinct model types. For example, platform 2210 under the control of a subject matter expert may prepare data from digital model 2282 into formats that can be accessed by digital model 2284 via digital model 2284's native APIs, thus allowing modifications of digital model 2282 to be propagated to digital model 2284. Any feedback from digital model 2284 to digital model 2282 would require similar processing via platform 2210 so that data from digital model 2284 are converted into formats that can be accessed by digital model 2282 via digital model 2282's native APIs. This hub-and-spoke architecture 2234 is not scalable to the sheer number (e.g., hundreds or thousands) of digital models involved within typical large-scale DE projects, as model updates and feedback are only possible through central platform 2210.

In contrast, once the DE models are spliced, each original model is represented by a model splice including relevant model data, unified and standardized API endpoints for input/output, as shown in the upper splice plane 170. Splices within splice plane 170 may be connected through scripts (e.g., python scripts) that call upon API endpoints or API function scripts and may follow a DAG architecture, as described with reference to FIG. 1 and FIG. 19. Note that in FIG. 1, only a set of generated splices is shown within splice plane 170, while in FIG. 22, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 170 is shown in FIG. 1 as part of IDEP 100 for illustrative purposes, in some embodiments, splice plane 170 may be implemented behind a customer firewall and be part of an agent of the DE platform, as discussed in various deployment scenarios shown in FIG. 17. That is, individual API function scripts generated via model splicing by a DE platform agent may be tailored to call upon proprietary tools the customer has access to in its private environment. No centralized platform 2210 with proprietary access to all native tools associated with all individual digital models shown in FIG. 22 is needed. Instead, orchestration scripts call upon platform API function scripts that may be implemented differently in different customer environments.

Hence, model splicing allows model splices such as model splice 2272 from digital model 2282 and model splice 2274 from digital model 2284 to access each other's data purposefully and directly, thus enabling the creation of a model-based “digital mesh” 2244 via platform scripts and allowing autonomous linking without input from subject matter experts.

An added advantage of moving from the model plane 180 to the splice plane 170 is that the DE platform enables the creation of multiple splices per native model (e.g., see FIG. 20), each with different subsets of model data and API endpoints tailored to the splice's targeted use. For example, model splices may be used to generate multiple digital twins (DTws) that map a physical product or process or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twinning capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 2250 for the IDEP is shown on the right side of FIG. 22, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 23 shows an exemplary directed acyclic graph (DAG) representation 2300 of pipelined DE tasks related to digital threads, in accordance with some embodiments of the present invention. In diagram 2300, tasks performed through a digital thread orchestration script (e.g., 2194) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 1 and 21, DAGs of threaded tasks are built from digital threads and are part of the DE platform's application plane 160. Different DAGs may target different DE actions. For example, in FIG. 1, building or updating a DTw 122 in the virtual environment 120 has its own DAG 124. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

### Inner/Outer Loop Architecture for Digital Threads in Cyber-Physical Systems

FIG. 24 is an exemplary schematic 2400 illustrating the interplay between a digital thread and the individual digital models or digital artifacts it uses, thus defining outer and inner loop processes, in accordance with some embodiments of the present invention.

In various embodiments of the IDMP, the architecture for managing digital threads and their associated digital models in cyber-physical systems involves an interaction between an Outer Loop (representing the digital thread) and an Inner Loop (representing individual models or artifacts). This structure enables secure, permission-based collaboration across multiple models, ensuring traceability, controlled data flow, and efficient interaction within the digital workflow. Based on software engineering principles, this inner/outer loop design is modular: the Outer Loop manages high-level coordination and communication, while the Inner Loop handles the detailed, iterative operations of each model or system. While the Outer Loop and Inner Loop interactions commonly seen in software packages may involve access to all of the software packages within the same Integrated Development Environment (IDE), the Outer Loop/Inner Loop interactions for cyber-physical systems must manage to link interoperably with different digital models and tools, while also ensuring zero trust security. Various embodiments of the IDMP are well suited to manage such digital threads for cyber-physical systems as the platform is able to interoperably link with various digital models and tools (in different Inner Loops) through the model splicer architecture (see FIGS. 20 and 21). Additionally, the IDMP uses zero trust and zero knowledge security, ensuring that every interaction, whether within the same security network or across different networks, is strictly authorized, while keeping sensitive data private (e.g., through tokenization).

In the embodiment shown in 2410, an Outer Loop 2404 manages the sequence of tasks in a digital workflow, where user actions are authorized for access through a process 2420 in an Inner Loop 2416. Outer Loop 2404 can issue instructions to Inner Loop 2416 to:
Create models by defining structure, behavior, and parameters.
Fetch data artifacts from a model.
Update artifacts with controlled, traceable changes.

For example, when Outer Loop 2404 commands a data artifact retrieval, the IDMP platform may manage it using zero trust principles, as described in FIG. 16. Each user request in Outer Loop 2404 is authorized through an enclave 1602 and its Control Plane service cell, coordinated with platform exclave 1616. Different Inner Loops exist within Customer Tools 1614, each operating in specific Customer Environments 1610 where each request is authorized for access to the necessary data operations.

After retrieving data artifacts from Inner Loop 2416, Outer Loop 2404 handles configuration control 2406, versioning, and integrates the artifacts into the broader digital thread 2408 for testing or validation at a process step 2412.

Inner Loop 2416, by contrast, is responsible for localized operations related to individual digital models, including:
Model creation, where digital models are initialized or updated.
Model execution, through automation, simulations or data analysis.
Saving results, preserving outcomes from model runs.
Analyzing data, providing insights and validation for digital workflow improvements.

Outer Loop 2404 interacts with any step in Inner Loop 2416 to access or update data artifacts. Outer loop computations often compare the current workflow to a baseline 2410.

Outer and Inner Loops 2404 and 2416 work together in an iterative process, integrating localized model adjustments with system-wide digital workflow coordination and validation. The Outer Loop manages tasks like configuration control, system integration, and VVUQ (Verification, Validation, and Uncertainty Quantification), while the Inner Loop handles model-based operations. FIG. 24 shows the Outer Loop performing authorized access 2420, configuration control 2406, digital thread integration 2408, and VVUQ/testing 2412. In various implementations of digital threads in the IDMP, these steps can vary in sequence or iterate as needed. Ultimately, the outer and inner loop architecture enables continuous integration and development (CI/CD) of digital workflows and digital threads across the digital platform. Decentralized Digital Threads in the IDMP

The IDMP enables decentralized management of digital threads across different models, security networks, and user permissions under a zero trust security principle. This architecture enforces strict access controls and permission-based interactions between models, ensuring security across diverse environments. In some embodiments, a zero knowledge approach further secures sensitive data during orchestration, ensuring no unauthorized access (e.g., by using tokenization).

In FIG. 24, two exemplary setups 2422 and 2432 illustrate IDMP embodiments with decentralized digital threads across different security networks. In 2422, Outer Loop 1 operates within Security Network 1, connecting to multiple Inner Loops (e.g., Inner Loop 1, Inner Loop 2, and Inner Loop 3). These Inner Loops manage data operations within the same security framework, allowing collaboration while maintaining security.

In 2432, Outer Loop 2 operates in a separate Security Network 2, linking to additional Inner Loops (e.g., Inner Loop 4, Inner Loop 5, and Inner Loop 6). For links from Outer Loop 1, dotted lines and “X” symbols represent isolated models or components, indicating access restrictions enforced by the zero trust framework. Only authenticated users can access authorized models and artifacts.

In various implementations, 2422 and 2432 can be regarded as different instances of the Customer environment 1610 shown in FIG. 16.

In the IDMP, digital threads handle both simple and complex model connections. FIG. 19 shows simple threads with sequential model links (e.g., 1902, 1904), while the more complex thread 1906 is shown in FIG. 24 as an illustrative element 2442. Simple threads propagate changes in a linear fashion, while complex threads manage branching dependencies, where changes in one model affect multiple downstream models. In complex threads implemented by the IDMP, the Outer Loop coordinates interactions across multiple Outer loops and Inner loops, ensuring secure, scalable execution of the entire digital workflow with appropriate permission controls.

Converting Digital Workflows into Digital Threads with Data Relationships

The IDMP links different types of digital model files in a decentralized fashion with zero-trust security. When a user requests a data operation on a digital model file using a specific digital tool, IDMP executes the request via digital tool-specific and platform agents within the customer's environment. These agents extract data artifacts and, when changes to a digital artifact occur, a newer version of the digital model file is made. During the versioning step, platform agents ensure sensitive data is protected through tokenized version control.

Extracted data artifacts are securely stored in the customer's cloud data storage (e.g., an S3 bucket). If changes are made to the digital model, the agents save the updated version of the model or data artifact, extract the relevant data artifacts, and store it securely.

Using the IDMP, users are able to link data artifacts into a magic doc for documentation and commentary, which can include AI-assistance in various embodiments. A digital thread accompanying the magic doc lists data artifacts in sequence, creating a digital workflow. The IDMP further tracks data relationships between data artifacts (e.g., derivation, grouping, or data flow). This digital workflow of user actions and data relationships is stored in a non-proprietary format within the customer's environment.

Emergent digital workflows and sequence of tasks captured by data relationships of various types:
1. Generational—(Between version 1 and version 2 of a model)
2. Parent/Child—(The Model and Derived information from a model)
3. Sibling—(Different bits of derived data from the same model (e.g., an image view of a CAD model and an associated parameter)
4. Generational (derived)—The same piece of data extracted from version 1 or version 2 of a model
5. Data Context (Connected by how they are used for a mission or business purpose in a Magic Doc)
6. Data Flow (Connected via digital threads-data from one model into another)

Such data relationships can vary from one user to another even for the same overall digital workflow task.

Converting Digital Workflows into Digital Thread Scripts in an API-First Manner

FIG. 25 illustrates an exemplary digital engineering process in the aerospace industry, showing outer loop processes, according to one embodiment of the present invention. The left of FIG. 25 contains a simplified depiction 2502 of current engineering processes related to a digital engineering operation in the aerospace industry. The digital platform is instrumental in mapping those processes 2504 to digitized (software-defined) workflows. Each process step may be connected to software-defined digital threads (outer loop) using Git Workbooks or Runbooks. The generated workflows may belong to the inner or outer loops, as depicted in FIG. 24. For completeness and compliance, the digital platform may further add tests for the key steps and tasks of the digitized workflows in the outer loop 2506. These outer-loop threads incorporate built-in feature tests and unit tests, ensuring the digital thread is validated as it is being created. Finally, the scripts for the digital threads are executed, generating outputs that can be presented as dynamic reports, such as magic docs, linked to digital models or data artifacts. The digital platform may hence generate dynamic reports 2508 (e.g., Magic Docs) linked to the inner-loop models used by the digital workflows. In various implementations, the IDMP adopts an API-first approach, where digital workflows are structured around secure and modular API integrations. In the IDMP, digital threads link to specific data artifacts through authorized API endpoints in a zero-trust framework, ensuring secure access. Process steps are connected to software-defined workflows using tools like Git Workbooks or Runbooks, with user intent driving both platform and tool-specific API calls. This approach enables seamless integration, modularity, and validation, with built-in feature and unit tests ensuring the reliability of each API interaction throughout the system.

### Machine Learning (ML) and Neural Networks

Machine learning (ML) algorithms are characterized by the ability to improve their performance at a task over time without being explicitly programmed with the rules to perform that task (i.e., learn). An ML model is the output generated when a ML algorithm is trained on data. As described herein, embodiments of the present invention use one or more artificial intelligence (AI) and ML algorithms. Various exemplary ML algorithms are within the scope of the present invention. The following description describes illustrative ML techniques for implementing various embodiments of the present invention.

### Neural Networks

A neural network is a computational model including interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 26 describes neural network operation fundamentals, according to exemplary embodiments of the present invention.

FIG. 26 shows a single-layered neural network, also known as a single-layer perceptron. The operation of a single-layered neural network involves the following steps:
1. Input: Receiving a DE input vector v 2604 with elements vⱼ, with j∈[1, n] representing the j^{th} DE input, and where each element of the vector corresponds to an element 2606 in the input layer. A DE input can be a user prompt, a DE document, a DE model, DE program code, system data from the IDMP, and/or any useful form of data in digital engineering.
2. Transfer Function: Multiplying each element of the DE input vector by a corresponding weight wⱼ 2608. These weighted inputs are then summed together as the transfer function, yielding the net input to the activation function

$${Σ}_{j = 1}^{n} {v}_{j} \cdot {w}_{j} 2610.$$

Each neuron in a neural network may have a bias value 2612, which is added to the weighted sum of the inputs to that neuron. Both the weights and bias values are learned during the training process. The purpose of the bias is to provide every neuron with a trainable constant value that can help the model fit the data better. With biases, the net input to the activation function is

$${Σ}_{j = 1}^{n} \{ {v}_{j} \cdot {w}_{j} \} + b .$$

3. Activation Function: Passing the net input through an activation function 2614. The activation function o determines the activation value o 2618, which is the output of the neuron. It is typically a non-linear function such as a sigmoid or ReLU (Rectified Linear Unit) function. The threshold θ 2616 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
4. Output: The activation value o 2618 is the output of the activation function. This value is what gets passed on to the next layer in the network or becomes the final DE output in the case of the last layer. A DE output can also be an updated twin configuration, digital twin, physical twin, DE document, DE model, DE program code, or any useful form of data in digital engineering.

FIG. 27 shows an overview of an IDMP neural network training process, according to exemplary embodiments of the present invention. The training of the IDMP neural network involves repeatedly updating the weights and biases 2710 of the network to minimize the difference between the predicted output 2704 and the true or target output 2706, where the predicted output 2704 is the result produced by the network when a set of inputs from a dataset is passed through it. The predicted output 2704 of an IDMP neural network 2702 corresponds to the DE output 2618 of the final layer of the neural network. The true or target output 2706 is the true desired result. The difference between the predicted output and the true output is calculated using a loss function 2708, which quantifies the error made by the network in its predictions.

The loss function is a part of the cost function 2708, which is a measure of how well the network is performing over the whole dataset. The training goal is to minimize cost function 2708. This is achieved by iteratively adjusting the weights and biases 2710 of the network in the direction that leads to the steepest descent in the cost function. The size of these adjustments is determined by the learning rate 2708, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 2710 of the network based on the error (e.g., cost function) 2708 of the output. After forward propagation through the IDMP neural network 2702, the output 2704 of the network is compared with true output 2706, and the error 2708 is calculated. This error is then propagated back through the network, starting from the output layer and moving towards the input layer. The weights and biases 2710 are adjusted to minimize this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

FIG. 28 provides additional details on the training process or an IDMP machine learning model, according to exemplary embodiments of the present invention.

### Transformer Model Architecture

The transformer architecture is a neural network design that was introduced in the paper “Attention is All You Need” by Vaswani et al. published in June 2017 (available at arxiv (dot) org/abs/1706.03762), and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding”. Therefore, the training of a neural network and its evaluation (i.e., its use upon deployment) both occur within the embeddings space.

In this document, the processes of tokenization, encoding, decoding, and de-tokenization may be assumed. In other words, the processes described below occur in the “embeddings space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 28 is an illustrative flow diagram showing the different phases and datasets involved in training an IDMP ML model, according to exemplary embodiments of the present invention.

The training process starts at step 2810 with DE data acquisition, retrieval, assimilation, or generation. At step 2820, acquired DE data are pre-processed, or prepared. At step 2830, the IDMP ML model is trained using training data 2825. At step 2840, the IDMP ML model is evaluated, validated, and tested, and further refinements to the IDMP ML model are fed back into step 2830 for additional training. Once its performance is acceptable, at step 2850, optimal IDMP ML parameters are selected.

Training data 2825 is a dataset containing multiple instances of system inputs and correct outcomes. It trains the IDMP ML model to optimize the performance for a specific target task, such as the prediction of a specific target output data field within a specific target document. In FIG. 28, training data 2825 may also include subsets for validating and testing the IDMP ML model, as part of the training iterations 2830 and 2840. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 2825 may be expanded via a document database augmentation process.

In some embodiments, an additional fine-tuning 2860 phase including iterative fine-tuning 2860 and evaluation, validation, and testing 2870 steps, is carried out using fine-tuning data 2855. Fine-tuning in machine learning is a process that involves taking a selected 2850 pre-trained model and further adjusting or “tuning” its parameters to better suit a specific task or fine-tuning dataset 2855. This technique is particularly useful when dealing with deep learning models that have been trained on large, general training datasets 2825 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 2825, such as ImageNet (available at image-net (dot) org) for image recognition tasks. The model's existing weights, which have been learned from the original training, serve as the starting point. During fine-tuning, the model is trained further on a new fine-tuning dataset 2855, which may contain different classes or types of data than the original training set. This additional training phase allows the model to adjust its weights to better capture the characteristics of the new fine-tuning dataset 2855, thereby improving its performance on the specific task it is being fine-tuned for.

In some embodiments, additional test and validation 28 using DE test and validation data 2875. Testing and validation of a ML model both refer to the process of evaluating the model's performance on a separate dataset 2875 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDMP ML model is trained 2830, selected 2850, and optionally fine-tuned 2860 and validated/tested 2880, the process ends with the deployment 2890 of the IDMP ML model. Deployed IDMP ML models 2895 usually receive new DE data 2885 that was pre-processed 2880.

In machine learning, data pre-processing 2820 is tailored to the phase of model development. During model training 2830, pre-processing involves cleaning, normalizing, and transforming raw data into a format suitable for learning patterns. For fine-tuning 2860, pre-processing adapts the data to align with the distribution of the specific targeted task, ensuring the pre-trained model can effectively transfer its knowledge. Validation 2880 pre-processing mirrors that of training to accurately assess model generalization without leakage of information from the training set. Finally, in deployment 2890, pre-processing ensures real-world data matches the trained model's expectations, often involving dynamic adjustments to maintain consistency with the training and validation stages.

Unless otherwise stated, the methods and systems disclosed herein regarding training, particularly pertaining to training data collection, generally apply to tuning, fine-tuning, pre-training, and/or post-training.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List”, by S. Raschka (posted Feb. 7, 2023, available at sebastianraschka (dot) com/blog/2023/11m-reading-list.html), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances and output instances, or may be generated synthetically by subject matter experts.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDMP (in various architecture configurations including private cloud), and/or on the public cloud.

FIG. 29 provides illustrative schematics of a server (management computing entity) 2910 connected via a network 2920 to a client (user computing entity) 2930 used within an IDMP, according to some embodiments of the present invention. While FIG. 29 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 29 for a server or management computing entity 2910. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital engineering process.

In one embodiment, management computing entity 2910 may be equipped with one or more communication interfaces 2912 for communicating with various computing entities, such as by exchanging data, content, and/or information (similar terms used herein interchangeably) that can be transmitted, received, operated on, processed, displayed, stored, and/or the like. For instance, management computing entity 2910 may communicate with one or more client computing devices such as 2930 and/or a variety of other computing entities. Network or communications interface 2912 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 2910 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 29, in one embodiment, management computing entity 2910 may include or be in communication with one or more processors 2914 (also referred to as processors and/or processing circuitry, processing elements, and/or similar terms used herein interchangeably) that communicate with other elements within management computing entity 2910, for example, via a bus. As will be understood, processor 2914 may be embodied in a number of different ways. For example, processor 2914 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 2914 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 2914 may be configured for a particular use or configured to execute instructions stored in volatile or non-volatile (or non-transitory) media 2916 and 2918, or otherwise accessible to processor 2914. As such, whether configured by hardware or computer program products, or by a combination thereof, processor 2914 may be capable of performing steps or operations according to embodiments of the present disclosure when configured accordingly.

In one embodiment, management computing entity 2910 may further include or be in communication with non-transitory memory 2918 (also referred to as non-volatile media, non-volatile storage, non-transitory storage, physical storage media, memory, memory storage, and/or memory circuitry—similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 2910 may further include or be in communication with volatile memory 2916 (also referred to as volatile storage, memory, memory storage, memory and/or circuitry-similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 2914. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 2910 with the assistance of processor 2914 and an operating system.

Although not shown, management computing entity 2910 may include or be in communication with one or more input elements, such as a keyboard input, a mouse input, a touch screen/display input, motion input, movement input, audio input, pointing device input, joystick input, keypad input, and/or the like. Management computing entity 2910 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 2910 may be located remotely from other management computing entity components, such as in a distributed system. Furthermore, one or more of the components may be combined and additional components performing functions described herein may be included in management computing entity 2910. Thus, management computing entity 2910 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 29 further provides an illustrative schematic representation of a client user computing entity 2930 that may be used in conjunction with embodiments of the present disclosure. In various embodiments, computing device 2930 may be a general-purpose computing device with dedicated modules for performing digital engineering-related tasks. It may alternatively be implemented in the cloud, with logically and/or physically distributed architectures.

As shown in FIG. 29, user computing entity 2930 may include a power source 2931, an antenna 2970, a radio transceiver 2932, a network and communication interface 2934, and a processor unit 2940 that provides signals to and receives signals from the network and communication interface. The signals provided to and received may include signaling information in accordance with air interface standards of applicable wireless systems. In this regard, user computing entity 2930 may be capable of operating with one or more air interface standards, communication protocols, modulation types, and access types. More particularly, user computing entity 2930 may operate in accordance with any of a number of wireless communication standards and protocols, such as those described above with regard to management computing entity 2910. Similarly, user computing entity 2930 may operate in accordance with multiple wired communication standards and protocols, such as those described above with regard to management computing entity 2910.

Via these communication standards and protocols, user computing entity 2930 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 2930 may also download changes, add-ons, and updates, for instance, to its firmware, software (e.g., including executable instructions, applications, program modules), and operating system.

In some implementations, processing unit 2940 may be embodied in several different ways. For example, processing unit 2940 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 2940 may be embodied as one or more other processing devices or circuitry. The term circuitry may refer to an entirely hardware embodiment or a combination of hardware and computer program products. Thus, processing unit 2940 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 2940 may be configured for a particular use or configured to execute instructions stored in volatile or non-volatile media or otherwise accessible to the processing unit. As such, whether configured by hardware or computer program products, or by a combination thereof, processing unit 2940 may be capable of performing steps or operations according to embodiments of the present invention when configured accordingly.

In some embodiments, processing unit 2940 may comprise a control unit 2942 and a dedicated arithmetic logic unit (ALU) 2944 to perform arithmetic and logic operations. In some embodiments, user computing entity 2930 may comprise a graphics processing unit (GPU) 2946 for specialized parallel processing tasks, and/or an artificial intelligence (AI) module or accelerator 2948, also specialized for applications including artificial neural networks and machine learning. In some embodiments, processing unit 2940 may be coupled with GPU 2946 and/or AI accelerator 2948 to distribute and coordinate digital engineering related tasks.

In some embodiments, computing entity 2930 may include a user interface, including an input interface 2950 and an output interface 2952, each coupled to processing unit 2940. User input interface 2950 may comprise any of a number of devices or interfaces allowing computing entity 2930 to receive data, such as a keypad (hard or soft), a touch display, a mic/speaker for voice/speech/conversation, a camera for motion or posture interfaces, and appropriate sensors for spatial computing interfaces. User output interface 2952 may comprise any of a number of devices or interfaces allowing computing entity 2930 to provide information to a user, such as through the touch display, or a speaker for audio outputs. In some embodiments, output interface 2952 may connect computing entity 2930 to an external loudspeaker or projector, for audio and/or visual output. In some embodiments, user interfaces 2950 and 2952 integrate multimodal data in an interface that caters to human users. Some examples of human interfaces include a dashboard-style interface, a workflow-based interface, conversational interfaces, and spatial-computing interfaces. As shown in FIG. 18, computing entity 2930 may also support bot/algorithmic interfaces such as code interfaces, text-based API interfaces, and the like.

User computing entity 2930 can also include volatile and/or non-volatile storage or memory 2960, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 2960 may store an operating system 2962, application software 2964, data 2966, databases, database instances, database management systems, data, applications, programs, program modules, scripts, source code, object code, byte code, compiled code, interpreted code, machine code, executable instructions, and/or the like to implement functions of user computing entity 2930. As indicated, this may include a user application that is resident on the entity or accessible through a browser or other user interface for communicating with management computing entity 2910 and/or various other computing entities.

In some embodiments, user computing entity 2930 may include one or more components or functionalities that are the same or similar to those of management computing entity 2910, as described in greater detail above. As will be recognized, these architectures and descriptions are provided for exemplary purposes only and are not limited to the various embodiments.

In some embodiments, computing entities 2910 and/or 2930 may communicate to external devices like other computing devices and/or access points to receive information such as software or firmware, or to send information from the memory of the computing entity to external systems or devices such as servers, computers, smartphones, and the like.

In some embodiments, two or more computing entities such as 2910 and/or 2930 may establish connections using a network such as 2920 utilizing any of the networking protocols listed previously. In some embodiments, the computing entities may use network interfaces such as 2912 and 2934 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system may be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and ease of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### Terminology (Continued)

Some illustrative terminologies used with the IDMP are provided below to assist in understanding the present invention, but these are not to be read as restricting the scope of the present invention. The terms may be used in the form of nouns, verbs, or adjectives, within the scope of the definition.

### Digital Engineering

Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data includes project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model: A computer-generated model that represents characteristics or behaviors of a complex product, system, or process. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model. A DE model is a type of digital model, defined below. In general, any reference to a DE model in the specification and drawings may be considered equivalent to a reference to a digital model, and vice versa.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the Interconnected Digital Model Platform (IDMP) as disclosed herein refers to any digital file uploaded onto the platform. All the terms and concepts defined above and included herein, including model splicing, model splices, and software-defined digital threads, apply in the context of the digital model and within the context of the IDMP.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.

### IDMP/IDEP

Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. Specifically, an embodiment of the IDEP is a software platform that interconnects a plurality of spliced DE model files through one or more software-defined digital threads (see FIGS. 1, 13-17). A DE and certification ecosystem performs verification and validation tasks, defined next. An IDEP may be considered a type of Interconnected Digital Model Platform (IDMP) when one or more of the digital models are engineering or science related, the IDMP being defined below. In general, any reference to an IDEP in the specification and drawings can be considered equivalent to a reference to an IDMP, and vice versa, and any feature, embodiment, or description in relation to one applies analogously to the other. The terms “Interconnected” and “Integrated” are used interchangeably herein.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads.
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
AI Agent or Tool Agent: a software entity or module that takes instructions from the enclave and acts on behalf of a user or another program to perform specific tasks or operations related to an AI model or a DE tool. An AI agent or a tool agent may be designed as part of the IDMP but deployed by a customer within a secured customer environment to interface in-between the IDMP, AI models, and/or proprietary tools the customer is licensed for. Inside the customer environment, modular agents interact directly with the domain-specific tools and models to allow for bi-directional data flow across distributed tools.
Resource-capability mapping: A framework for identifying and linking available resources with the capabilities they enable or support. An exemplary resource-capability mapping is the IDMP API, or platform API, where the resource refers to third-party tools and functions integrated into and accessible via the IDMP, and where the exemplary capability refers to IDMP functions written in scripts for completing certain tasks using the available resource. Such resource-capability mappings may be used to identify how tool-specific resources such as tool functions, access and control capabilities, human-machine interfaces, processes, and objects can be allocated, invoked, and utilized efficiently and effectively to achieve specific IDMP platform functions or tasks. Resource capability mapping also assists with zero-knowledge implementations where the capability details are available to a user while the specific digital tool resource or its functions are only mapped within the customer environment. Another example of the resource-capability mapping framework is a variable mapping table.
User intent: The goal, objective, or desired outcome that a user aims to achieve when interacting with the IDMP/IDEP. User intent may be expressed through various forms of input, such as user actions, natural language prompts, commands, or selections within the platform interface.
User actions: Specific interactions, inputs, or operations performed by a user within the IDMP/IDEP. User actions may include, but are not limited to, mouse clicks, keyboard inputs, voice commands, or any other form of interaction with the platform's interface or components.

### Model Splicing on IDMP/IDEP

Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A computer-executable sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or IDMP/IDEP API: A library of API scripts available on the IDEP/IDMP as disclosed herein.
API function scripts, “splice functions,” “splice methods,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice. In some embodiments, as a matter of design choice, a digital artifact is atomic and indivisible in terms of security levels, so that permissions for users to access and/or modify the digital artifact apply to the digital artifact as a whole, and may not apply to segments of the digital artifact. In other embodiments, a digital artifact includes segments that may have different access (e.g., viewing) and modification (e.g., updating) security levels. Consequently, for a given user, an “authorized artifact” for access is an artifact for which all segments fall under an access security level that allows the given user to access (e.g., view) it. Similarly, for a given user, an “authorized artifact” for modification is an artifact for which all segments fall under a modification security level that allows the given user to modify (e.g., update) it.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing, where the DE model being spliced is a human-readable text-based document.
Model splicer: Program code or script (uncompiled) that performs model splicing of DE models. A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.

### Digital Threads

Model splice linking: Generally, model splice linking refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a computer-executable script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices. In various embodiments, a digital thread associated with a digital twin is configured to execute a scripted workflow associated with the digital twin.
Tool linking: Similar to model splice linking, tool linking generally refers to jointly accessing two or more DE tools via model splices, where model splice functions that encapsulate disparate DE tool functions are called upon jointly to perform a DE task.
Workflow: A workflow typically representing an entire process or sequence of operations that achieves a specific goal or outcome. It encompasses the complete set of activities, from initiation to completion, that are required to fulfill a business process or software function. Workflows often involve multiple participants, systems, or departments and can be complex, involving branching paths, decision points, and parallel processes.
Digital Workflow: A digital workflow refers to a series of digital tasks and process steps that are carried out electronically to achieve a specific outcome. Digital workflows involve the use of digital tools, software applications, and technologies to streamline and manage various activities within an organization or project. They often enable full or partial automation, and typically include elements such as data input, information processing, task assignment, approval processes, and document management, all conducted in a digital environment.
Tasks and Process Steps: A task is usually a subset of a workflow and represents a discrete unit of work that needs to be completed as part of the larger process. Tasks are more specific and focused than workflows and are often assigned to individual agents. They have defined inputs, outputs, and objectives. Multiple tasks typically make up a workflow, and each task contributes to the overall goal of the workflow. A process step, or simply “step”, in turn, is the smallest unit of work within this hierarchy. Process steps are the individual actions or operations that, when combined, form a task. They are highly specific, often atomic actions that represent the most granular level of detail in a workflow. Multiple process steps are usually required to complete a single task, and the successful execution of all steps results in the completion of the task. In the context of digital workflows, the terms “digital task”, “digital workflow task”, and “digital engineering task” are used interchangeably herein.
Digital Task Implementation: An orchestration script, or a platform script, may be generated over the IDMP to implement a digital task including one or more process steps, where the “implementation” of the digital task through an orchestration script means that the orchestration script includes instructions carrying out each process step required to complete the digital task.

### Digital Twin

Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity; a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains. In some embodiments, a digital twin is a digital replica configured to run in a virtual environment and instantiated through a scripted digital thread, where the digital thread accesses data (e.g., digital artifacts) from a set of digital models through splicing. A digital twin may be instantiated, run, or executed, through a digital thread. Updating a digital twin may include the actions of modifying, deleting, and/or adding data to its twin configuration, to an associated digital thread, or to an associated digital model associated with the updated digital twin. In one embodiment, digital twins may be ephemeral and may have in-built time and space restrictions (see “twin configuration” definition below). In various embodiments, a physical twin is a physical object instantiated in a physical environment based on a set of model files through an MBSE manufacturing and/or prototyping process. In various embodiments, digital twins can be created for both physical products and physical processes. They are not limited to tangible items like machinery or vehicles; they can also simulate complex physical processes, such as manufacturing workflows or supply chain logistics, to improve efficiency and predict outcomes. This flexibility allows digital twins to be applied across various industries and scenarios.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
External Feedback: In various embodiments, external feedback comprises feedback data from at least one source external to a given digital twin, including digital twin performance data as received, analyzed or processed by the IDMP. External feedback may also include physical twin performance data, data from a virtual sensor, data from a physical sensor, user input (e.g., a user prompt, or a user response over a GUI), data from a simulation, a product certification file, or a product requirements file. In some embodiments, external feedback may also include feedback from control algorithms or processes in the IDMP that track digital twin performance (e.g., tracking error levels and/or tolerance between digital and corresponding physical twin data). External feedback data can also include feedback data that is external to the IDMP.
Twin Configuration: A twin configuration includes data specifying the configuration of a digital or a physical twin. Twin configurations may include a twin version identifier identifying the digital twin, one or more digital thread identifiers identifying the digital threads responsible for instantiating and running a twin, one or more model representation identifiers (e.g., URIs) identifying the model representations that are used by the twin, and an authoritative twin indicator (e.g., a boolean or binary variable) indicating whether the twin is an authoritative twin. The various twin configurations associated with the various physical and digital twins of a given product may be stored in a twin configuration set of the IDMP. In some embodiments, the twin configuration set acts as a specification database for the various digital and physical twins for one or more products or systems. In some embodiments, the twin configuration of a digital twin may include time and space restrictions on the associated digital twin, such as a validity time frame, a validity cutoff time, a validity space, or a validity geographical area (e.g., geofencing, proximity to another twin configuration).

### Security

Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Zero-knowledge approach: A zero-knowledge approach in data operations refers to a method where computational processes and data analyses are conducted such that the underlying data remains completely confidential and undisclosed to the parties performing the operations. This technique enables the validation, aggregation, and processing of data without exposing the actual data content, thereby preserving privacy and confidentiality.
Security Network: Information security networks are security networks that are configured to maintain the confidentiality, integrity, and availability of digital information (e.g., digital model data) through cybersecurity measures such as encryption, firewalls, intrusion detection systems, and access controls. A “security network” is a set of networked resources having identical access control restrictions, where each networked resource provides access to one or more digital model files. In various embodiments, the networked resources of a security network may be determined by one or a combination of the following factors: (1) having a minimum security access level, (2) belonging to a given physical network, (3) belonging to a given customer organization, and (4) belonging to a given business division.
Information Security (Infosec) Levels: Also referred to as “security levels” or “security access levels”, information security (Infosec) levels designate classifications assigned to data and operations based on sensitivity and security requisites, dictating access control and data handling procedures across networks. In some embodiments, an infosec level may define a security network.

### Testing

Testing: The process of evaluating and verifying the functionality, performance, and reliability of software components, digital workflows, or systems within a software platform such as the IDMP/IDEP. Testing may include assessing various aspects such as quality assurance (QA), quality control (QC), usability, and end-to-end functionality of the platform, its components, or the digital tasks executed on it.
Human-readable test scenarios: Descriptions of test cases or testing situations written in natural language that are easily understandable by human users or testers. These scenarios may outline the steps, conditions, and expected outcomes of a particular test. The test scenarios usually include a sequence of human-readable testing steps that are carried out on the software platform. In some embodiments, the testing steps are configured to evaluate the performance of the software platform in accomplishing the user intent. In other embodiments, they are configured to verify the ability of the software platform to accomplish the user intent.
Test script: A set of instructions, typically in the form of computer code or a structured sequence of commands, designed to automate the execution of a specific test scenario within the IDMP/IDEP. Test scripts may be generated based on human-readable test scenarios and may be used to perform automated testing of various platform components, digital workflows, or system functionalities.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes, parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example” or its equivalents is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number+10%, such that “about 10” would include from 9 to 11. In other exemplary embodiments, the term “about” may include the recited number+X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. A non-transitory storage medium for enabling digital transactions over an Integrated Digital Model Platform (IDMP), the non-transitory storage medium comprising program code executable by a hardware processor, the program code, when executed by the hardware processor, causing the hardware processor to:
receive a request for a digital thread checkpoint (DTC), wherein the DTC describes a current state of a target digital thread, wherein the target digital thread is operated by a user and references at least one digital artifact, and wherein the target digital thread is an IDMP orchestration script operating on the at least one digital artifact and associated with a digital product;
generate the DTC associated with the target digital thread, wherein the DTC comprises a checkpoint payload;
generate a referenced checkpoint hash by hashing the checkpoint payload; and
generate a non-fungible token (NFT) representing a certified state of the target digital thread at the DTC, wherein the NFT comprises the referenced checkpoint hash.

2. The non-transitory storage medium of claim 1, wherein the checkpoint payload comprises a thread identifier, a checkpoint identifier, a scope type, a scope reference identifier, and an authority identifier of an authorized decision-maker, and wherein the scope type defines a category of certification that the DTC represents.

3. The non-transitory storage medium of claim 2, wherein the scope type is one of requirement-level, milestone-level, artifact-level, and workflow-level.

4. The non-transitory storage medium of claim 2, wherein the checkpoint payload further comprises at least one of one or more prior checkpoint hashes, one or more artifact lineage references of the at least one digital artifact, one or more evidence snapshot identifiers, and one or more validation pipeline identifiers and result references.

5. The non-transitory storage medium of claim 2, wherein the NFT comprises a token identifier, the scope type, the scope reference identifier, a certification status, and an issuer identifier.

6. The non-transitory storage medium of claim 5, wherein the NFT further comprises at least one of an economic state reference, a permission state reference, a validity window, a revocation pointer, and a supersession reference.

7. The non-transitory storage medium of claim 2, wherein the program code further causes the hardware processor to:
digitally sign, by the authorized decision-maker, the referenced checkpoint hash, to generate a digital signature; and
append the digital signature to the DTC to generate a canonical DTC.

8. The non-transitory storage medium of claim 1, wherein the NFT is recorded on a blockchain and assigned to one of the user and the IDMP.

9. The non-transitory storage medium of claim 1, wherein at least one of the referenced checkpoint hash and a token hash associated with the NFT is recorded to a private blockchain.

10. The non-transitory storage medium of claim 1, wherein the program code further causes the hardware processor to:
generate a public anchor associated with the DTC, wherein the public anchor comprises a cryptographic commitment based on at least the referenced checkpoint hash and a token hash associated with the NFT; and
record the public anchor to a public blockchain.

11. The non-transitory storage medium of claim 10, wherein the checkpoint payload further comprises a checkpoint hash list comprising one or more previously generated checkpoint hashes, and wherein the cryptographic commitment is further based on a Merkle root generated from the checkpoint hash list.

12. The non-transitory storage medium of claim 1, wherein the request for the DTC is received in response to a user-defined invocation of a checkpoint operation.

13. The non-transitory storage medium of claim 1, wherein the request for the DTC is received upon completion of a predefined validation workflow.

14. The non-transitory storage medium of claim 1, wherein the request for the DTC is received upon execution of a programmable smart contract condition.

15. The non-transitory storage medium of claim 1, wherein the request for the DTC is associated with a digital product transaction of the digital product between the user and a third party.

16. The non-transitory storage medium of claim 1, wherein the at least one digital artifact was extracted from a digital model file through a model representation, wherein the digital model file resides within a customer environment of the user, and wherein the model representation comprises model-type-specific locators to digital model data.

17. The non-transitory storage medium of claim 16, wherein the target digital thread is written in a computer-executable scripting language, and wherein the target digital thread comprises instructions to access the at least one digital artifact through the model representation.

18. The non-transitory storage medium of claim 16, wherein the model representation comprises a model splice connected to the digital model file, wherein the model splice comprises one or more splice data items, one or more splice data structures, and a splice function providing access to the at least one digital artifact, and wherein the access to the at least one digital artifact is provided through an item selected from the group consisting of an Application Programming Interface (API) and a Software Development Kit (SDK) endpoint.

19. A computer-implemented method for enabling digital transactions over an Integrated Digital Model Platform (IDMP), the method comprising:
receiving a request for a digital thread checkpoint (DTC), wherein the DTC describes a current state of a target digital thread, wherein the target digital thread is operated by a user and references at least one digital artifact, and wherein the target digital thread is an IDMP orchestration script operating on the at least one digital artifact and associated with a digital product;
generating the DTC associated with the target digital thread, wherein the DTC comprises a checkpoint payload;
generating a referenced checkpoint hash by hashing the checkpoint payload; and
generating a non-fungible token (NFT) representing a certified state of the target digital thread at the DTC.

20. The computer-implemented method of claim 19, wherein the NFT is recorded on a blockchain and assigned to one of the user and the IDMP.
